(19) United States
(12) Patent Application Publication
(10) Pub. No.: US 2024/0048356 A1
(43) Pub. Date: Feb. 8, 2024

(54) LOW VOLTAGE DRIVE CIRCUIT ANALOG OUTBOUND DATA ENCRYPTION WITH FREQUENCY PRESERVATION

(71) Applicant: SigmaSense, LLC., Wilmington, DE (US)

(72) Inventors: Richard Stuart Seger, Jr., Belton, TX (US); Daniel Keith Van Ostrand, Leander, TX (US); Michael Shawn Gray, Dripping Springs, TX (US); Timothy W. Markison, Mesa, AZ (US)

(73) Assignee: SigmaSense, LLC., Wilmington, DE (US)

(21) Appl. No.: 17/815,491

(22) Filed: Jul. 27, 2022

(51) Int. Cl. H04L 9/06; G06F 21/72; H04L 9/08

(52) U.S. Cl. CPC H04L 9/0618; G06F 21/72; H04L 9/0861

(57) ABSTRACT

A method includes generating, by a transmit digital to analog circuit of a low voltage drive circuit (LVDC), analog outbound data. The analog outbound data includes a direct current (DC) component and an oscillating component at a first frequency. The method further includes generating, by an analog transmit encryption signal generator of a transmit encrypt module of the LVDC, an analog transmit encryption signal having at least one frequency component, multiplying, by a mixer of the transmit encrypt module, the analog outbound data with the analog transmit encryption signal to produce an encrypted transmit signal having frequency components that differ from the first frequency. The method further includes generating, by a power source circuit of a drive-sense circuit of the LVDC, the encrypted analog outbound data as an analog transmit signal of a bus signal based on analog inbound data.

### CROSS-REFERENCE TO RELATED APPLICATIONS

Not Applicable.

### STATEMENT REGARDING FEDERALLY SPONSORED RESEARCH OR DEVELOPMENT

Not Applicable.

### INCORPORATION-BY-REFERENCE OF MATERIAL SUBMITTED ON A COMPACT DISC

Not Applicable.

### BACKGROUND OF THE INVENTION

### Technical Field of the Invention

This invention relates generally to data communication systems and more particularly to encrypted data communication in the analog domain.

### Description of Related Art

Data communication involves sending data from one device to another device via a communication medium (e.g., a wire, a trace, a twisted pair, a coaxial cable, air, etc.). The devices range from dies within an integrated circuit (IC), to ICs on a printed circuit board (PCB), to PCBs within a computer, to computers, to networks of computers, and so on.

Data is communicated via a wired and/or a wireless connection and is done so in accordance with a data communication protocol. Data communication protocols dictate how the data is to be formatted, encoded/decoded, transmitted, and received. For example, a wireless data communication protocol such as IEEE 802.11 dictates how wireless communications are to be done via a wireless local area network. As another example, Sony/Philips Digital Interface Format (SPDIF) dictates how digital audio signals are transmitted and received. As yet another example, Inter-Integrated Circuit (FC) is a two-wire serial protocol to connect devices such as microcontrollers, digital to analog converters, analog to digital converters, peripheral devices to a computer, and so on.

In addition, data communication protocols dictate how transmission errors are to be handled. For example, wireless communications often experience data errors, so the protocol dictates a form of forward error correction (e.g., Reed Solomon encoding, Turbo encoded, etc.) be used. As another example, wired communications experience much less data errors than wireless communications so the protocol dictates a form of feedback error correction (e.g., resend request, etc.) be used.

For some data communications, digital data is modulated with an analog carrier signal and transmitted/received via a modulated radio frequency (RF) signal. For other data communications, the digital data is transmitted “as is” via a wire or metal trace on a PCB. Regardless of the data communication protocol, digital data is in binary form where a logic “1” value is represented by a voltage that is at least 90% of the positive rail voltage and a logic “0” is represented by a voltage it is at most 10% of the negative rail voltage.

Communication techniques are often prone to hacking and disturbances in the communication system while in transit from one place to another. Encryption uses cybersecurity to defend against brute-force and cyber-attacks, including ransomware and malware. Data encryption involves converting data into a code (e.g., ciphertext) so that only those with access to a secret key or password can interpret it. Asymmetric encryption, also known as Public-Key Cryptography, encrypts and decrypts the data using two separate cryptographic asymmetric keys (e.g., a public and private key). Symmetric encryption is a type of encryption where only one secret symmetric key is used to encrypt the plaintext and decrypt the ciphertext.

There are many advantages to processing data in an analog signal format. For example, analog signals are easier to process, are less expensive to process, use less bandwidth than digital signals, and can present more refined information. However, analog signal data can be corrupted easily and encryption is very difficult. Therefore, analog signal encryption typically involves analog to digital signal conversion. Analog signal data protection techniques are generally referred to as scrambling—obscuring contents of transmission but encryption techniques are limited. A need for securely transmitting analog signals using encryption exists.

### BRIEF DESCRIPTION OF THE SEVERAL VIEWS OF THE DRAWING(S)

FIG. 1 is a schematic block diagram of an embodiment of a communication system;

FIG. 2 is a schematic block diagram of an embodiment of a communication device;

FIG. 3 is a schematic block diagram of another embodiment of a communication device;

FIG. 4 is a schematic block diagram of another embodiment of a communication system;

FIG. 4A is a schematic block diagram of another embodiment of a communication device;

FIG. 4B is a schematic block diagram of an embodiment of a computing core of a communication device;

FIG. 4C is a schematic block diagram of an embodiment of a peripheral Low Voltage Drive Circuit (LVDC) module of a communication device;

FIG. 5 is a schematic block diagram of an embodiment of a drive-sense circuit of a Low Voltage Drive Circuit (LVDC);

FIG. 5A is a schematic block diagram of another embodiment of a drive-sense circuit of a Low Voltage Drive Circuit (LVDC);

FIG. 5B is a schematic block diagram of an embodiment of a drive-sense circuit (DSC) 28 of a Low Voltage Drive Circuit (LVDC);

FIG. 6 is a functional diagram of an embodiment of a Low Voltage Drive Circuit (LVDC);

FIG. 7 is a schematic block diagram of an embodiment of a Low Voltage Drive Circuit (LVDC);

FIG. 8 is a schematic block diagram of an example of two drive-sense circuits (DSCs) of two Low Voltage Drive Circuits (LVDCs);

FIG. 9 is a schematic block diagram of an example of two drive-sense circuits (DSCs) and of two Low Voltage Drive Circuits (LVDCs);

FIG. 10 is a schematic block diagram of another embodiment of a Low Voltage Drive Circuit (LVDC);

FIG. 11 is a schematic block diagram of an embodiment of a receive analog to digital circuit;

FIG. 12 is a schematic block diagram of an embodiment of a portion of a Low Voltage Drive Circuit (LVDC);

FIG. 13 is a schematic block diagram of an embodiment of a portion of a Low Voltage Drive Circuit (LVDC);

FIG. 14 is a schematic block diagram of an embodiment of a portion of a Low Voltage Drive Circuit (LVDC);

FIG. 15 is a schematic block diagram of an example of two drive-sense circuits (DSCs) of two Low Voltage Drive Circuits (LVDCs) coupled to a bus;

FIG. 16 is a schematic block diagram of an embodiment of a portion of a Low Voltage Drive Circuit (LVDC);

FIG. 17 is a schematic block diagram of an embodiment of a portion of a Low Voltage Drive Circuit (LVDC);

FIGS. 18A-18D are schematic block diagrams of embodiments of an analog encryption signal generator;

FIG. 19 is an example of an interpreted encryption key;

FIG. 20 is a schematic block diagram of an embodiment of a polynomial encoding module;

FIG. 21 is a schematic block diagram of an embodiment of a signal information module;

FIG. 22 is a schematic block diagram of an embodiment of an analog signal generator;

FIG. 23 is a schematic block diagram of an embodiment of a modulation module;

FIG. 24 is a schematic block diagram of an embodiment of a portion of a Low Voltage Drive Circuit (LVDC);

FIG. 25 is an example of encrypted analog outbound data and encrypted analog inbound data;

FIG. 26 is a schematic block diagram of an embodiment of a portion of a Low Voltage Drive Circuit;

FIGS. 27A-27B are schematic block diagrams of embodiments of an analog encryption signal generator;

FIG. 28 is an example of an interpreted encryption key;

FIG. 29 is a schematic block diagram of an embodiment of a polynomial encoding module;

FIG. 30 is a schematic block diagram of an embodiment of a signal count module;

FIG. 31 is a schematic block diagram of an embodiment of a frequency offset module;

FIG. 32 is a schematic block diagram of an embodiment of an analog signal generator;

FIG. 33 is a schematic block diagram of an embodiment of a modulation module;

FIG. 34 is a schematic block diagram of an embodiment of a drive-sense circuit (DSC);

FIG. 35 is a schematic block diagram of an example of two drive-sense circuits (DSCs) coupled to two electrodes;

FIG. 36 is a schematic block diagram of an example of operation of two drive-sense circuits (DSCs);

FIG. 37 is a schematic block diagram of an embodiment of a drive-sense circuit (DSC) coupled to a load;

FIG. 38 is a schematic block diagram of another embodiment of a communication device;

FIG. 39 is a schematic block diagram of another embodiment of a communication device;

FIG. 40 is a schematic block diagram of an embodiment of a touch screen display with sensors;

FIG. 41 is a schematic block diagram of an embodiment of a drive-sense module (DSM);

FIG. 42 is a schematic block diagram of an embodiment of a portion of a drive-sense circuit;

FIG. 43 is a schematic block diagram of another embodiment of a portion the drive-sense circuit;

FIG. 44 is a schematic block diagram of an embodiment of a plurality of drive-sense modules;

FIG. 45 is a schematic block diagram of an example of a user computing device (UCD) communicating with an interactive computing device (ICD);

FIG. 46 is a schematic block diagram of an embodiment of a screen-to-screen (STS) connection;

FIG. 47 is a schematic block diagram of an example of transmitting close proximity signals from a user computing device to an interactive computing device;

FIGS. 48A-48B are schematic block diagrams of an example of obtaining an encryption key via a screen-to-screen (STS) connection;

FIG. 49 is a schematic block diagram of an example of a portion of two drive-sense modules (DSMs) of two screen-to-screen (STS) communication units coupled via an STS connection;

FIG. 50 is a schematic block diagram of an embodiment of a portion of a drive-sense module (DSM);

FIG. 50A is a schematic block diagram of an embodiment of a portion of a drive-sense module (DSM);

FIG. 51 is a schematic block diagram of an embodiment of a receive encrypt/decrypt module;

FIG. 52 is a schematic block diagram of an embodiment of a transmit encrypt module; and

FIG. 53 is a logic flow diagram of an example of a method of driving and receiving analog encryption signals via a screen-to-screen (STS) connection.

### DETAILED DESCRIPTION OF THE INVENTION

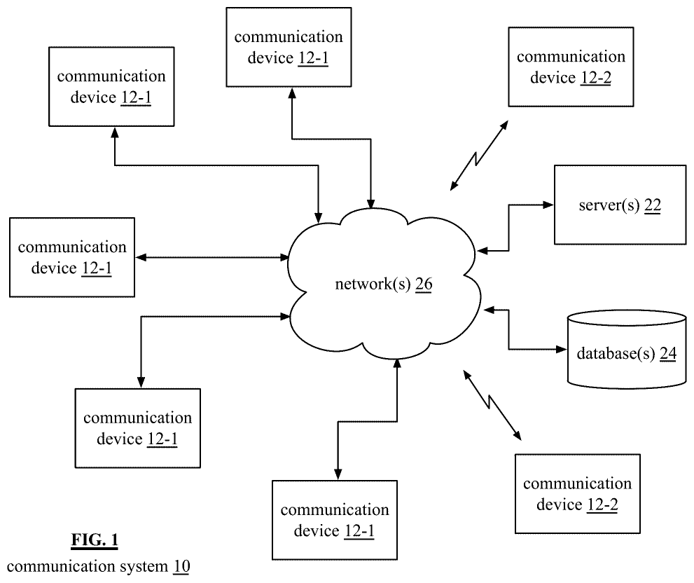

FIG. 1 is a schematic block diagram of an embodiment of a communication system 10 that includes a plurality of wired communication devices 12-1, a plurality of wireless communication devices 12-2, one or more servers 22, one or more databases 24, and one or more networks 26. Embodiments of communication devices 12-1 and 12-2 are similar in construct and/or functionality with a difference being the communication devices 12-1 couple to the network(s) 26 via a wired network card and the wireless communication devices 12-2 coupled to the network(s) 26 via a wireless connection. In an embodiment, a communication device can have both a wired network card and a wireless network card such that it is both communication devices 12-1 and 12-2.

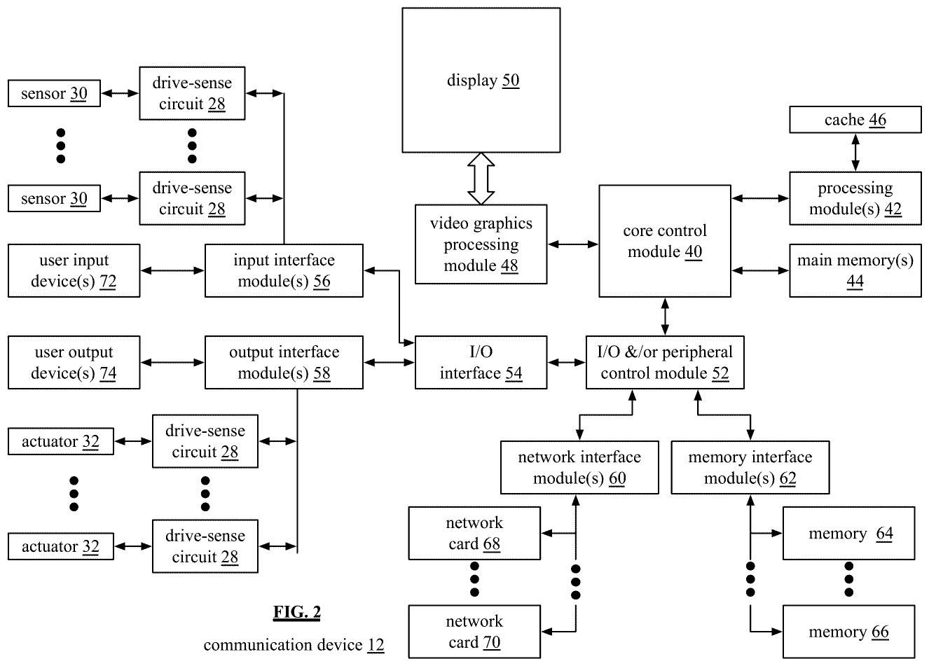

A communication device 12-1 and/or 12-2 is a computing device and may be a portable computing device and/or a fixed computing device. A portable computing device may be a social networking device, a gaming device, a cell phone, a smart phone, a digital assistant, a digital music player, a digital video player, a laptop computer, a handheld computer, a tablet, a video game controller, and/or any other portable device that includes a computing core. A fixed computing device may be a computer (PC), a computer server, a cable set-top box, a satellite receiver, a television set, a printer, a fax machine, home entertainment equipment, a video game console, and/or any type of home or office computing equipment. The computing devices 12-1 and/or 12-2 will be discussed in greater detail with reference to one or more of FIGS. 2, 3, and 5.

A server 22 is a special type of computing device that is optimized for processing large amounts of data requests in parallel. A server 22 includes similar components to that of the communication devices 12-1 and/or 12-2 with more robust processing modules, more main memory, and/or more hard drive memory (e.g., solid state, hard drives, etc.). Further, a server 22 is typically accessed remotely; as such it does not generally include user input devices and/or user output devices. In addition, an embodiment of a server is a standalone separate computing device and/or may be a cloud computing device.

A database 24 is a special type of computing device that is optimized for large scale data storage and retrieval. A database 24 includes similar components to that of the communication devices 12-1 and/or 12-2 with more hard drive memory (e.g., solid state, hard drives, etc.) and potentially with more processing modules and/or main memory. Further, a database 24 is typically accessed remotely; as such it does not generally include user input devices and/or user output devices. In addition, an embodiment of a database 24 is a standalone separate computing device and/or may be a cloud computing device.

The network(s) 26 includes one or more local area networks (LAN) and/or one or more wide area networks (WAN), which may be a public network and/or a private network. A LAN may be a wireless-LAN (e.g., Wi-Fi access point, Bluetooth, ZigBee, etc.) and/or a wired LAN (e.g., Firewire, Ethernet, etc.). A WAN may be a wired and/or wireless WAN. For example, a LAN is a personal home or business's wireless network and a WAN is the Internet, cellular telephone infrastructure, and/or satellite communication infrastructure.

The communication devices 12 communicate in a wired manner and/or wireless manner within the communication system 10. For example, the wired communication devices 12-1 and/or the wireless communication devices 12-2 include or connect to one or more touch screens with sensors and drive-sense circuits for communicating touch sense data within the communication system 10. The touch sense data communication is between devices and/or is within a device.

Drive-sense circuits allow for driving and sensing a load (e.g., a sensor, etc.) and transmit and receiving on the same line and have a variety of uses and applications such as touch screen controllers, low voltage communications, medical sensing and control, motor sensing and control, body as a network sensing, screen to screen communications, user identification, and passive device identification. Drive-sense circuits will be discussed in greater detail with reference to one or more of the subsequent Figures.

As another example, wired communication devices 12-1, the wireless communication devices 12-2, the server 22, and/or the database 24 include one or more low voltage drive circuits (LVDC) for communicating data via one or more lines of a bus (e.g., a bus includes one or more lines, each line is a wired connection, a wire, a trace on a PCB, etc.). The data communication is between devices and/or is within a device. For example, two computing devices communicate with each other via their respective LVDCs. As another example, components within a computing device have associated LVDCs and the components communicate data via the LVDCs.

As another example, a communication device 12 may be an interactive communication device that performs screen-to-screen (STS) communications with another communication device (e.g., a user computing device) via an STS wireless connection. The term wireless indicates the communication is performed at least in part without a wire. For example, the STS wireless connection is via a transmission medium (e.g., one or more of a human body, close proximity (e.g., within a few inches), a surface (for vibration encoding, etc.), etc. In an embodiment, the STS wireless connection is performed via a local direct communication (e.g., not performed via network). The STS wireless connection may be in accordance with a data protocol (e.g., data format, encoding parameters, frequency range, etc.), which will be discussed in further detail with reference to one or more subsequent Figures.

The wired communication devices 12-1 and/or the wireless communication devices 12-2 are operable to transmit encrypted analog data signals (e.g., analog outbound data), decrypt encrypted received analog data signals (e.g., analog inbound data), and encrypt received analog data signals (e.g., analog inbound data) within the communication system 10 for enhanced analog data transmission/storage security.

FIG. 2 is a schematic block diagram of an embodiment of a communication device 12 (e.g., 12-1 and/or 12-2). The communication device 12 includes a core control module 40, one or more processing modules 42, one or more main memories 44, cache memory 46, a video graphics processing module 48, a display 50, an Input-Output (I/O) peripheral control module 52, one or more input interface modules 56, one or more output interface modules 58, one or more network interface modules 60, and one or more memory interface modules 62. A processing module 42 is described in greater detail at the end of the detailed description of the invention section and, in an alternative embodiment, has a direction connection to the main memory 44. In an alternate embodiment, the core control module 40 and the I/O and/or peripheral control module 52 are one module, such as a chipset, a quick path interconnect (QPI), and/or an ultra-path interconnect (UPI).

Each of the main memories 44 includes one or more Random Access Memory (RAM) integrated circuits, or chips. For example, a main memory 44 includes four DDR4 (4th generation of double data rate) RAM chips, each running at a rate of 2,400 MHz. In general, the main memory 44 stores data and operational instructions most relevant for the processing module 42. For example, the core control module 40 coordinates the transfer of data and/or operational instructions from the main memory 44 and the memory 64-66. The data and/or operational instructions retrieve from memory 64-66 are the data and/or operational instructions requested by the processing module or will most likely be needed by the processing module. When the processing module is done with the data and/or operational instructions in main memory, the core control module 40 coordinates sending updated data to the memory 64-66 for storage.

The memory 64-66 includes one or more hard drives, one or more solid state memory chips, and/or one or more other large capacity storage devices that, in comparison to cache memory and main memory devices, is/are relatively inexpensive with respect to cost per amount of data stored. The memory 64-66 is coupled to the core control module 40 via the I/O and/or peripheral control module 52 and via one or more memory interface modules 62. In an embodiment, the I/O and/or peripheral control module 52 includes one or more Peripheral Component Interface (PCI) buses to which peripheral components connect to the core control module 40. A memory interface module 62 includes a software driver and a hardware connector for coupling a memory device to the I/O and/or peripheral control module 52. For example, a memory interface 62 is in accordance with a Serial Advanced Technology Attachment (SATA) port.

The core control module 40 coordinates data communications between the processing module(s) 42 and the network(s) 26 via the I/O and/or peripheral control module 52, the network interface module(s) 60, and a network card 68 or 70. A network card 68 or 70 includes a wireless communication unit or a wired communication unit. A wireless communication unit includes a wireless local area network (WLAN) communication device, a cellular communication device, a Bluetooth device, and/or a ZigBee communication device. A wired communication unit includes a Gigabit LAN connection, a Firewire connection, and/or a proprietary computer wired connection. A network interface module 60 includes a software driver and a hardware connector for coupling the network card to the I/O and/or peripheral control module 52. For example, the network interface module 60 is in accordance with one or more versions of IEEE 802.11, cellular telephone protocols, 10/100/1000 Gigabit LAN protocols, etc.

The core control module 40 coordinates data communications between the processing module(s) 42 and input device(s) 72 via the input interface module(s) 56 and the I/O and/or peripheral control module 52. An input device 72 includes a keypad, a keyboard, control switches, a touchpad, a microphone, a camera, etc. An input interface module 56 includes a software driver and a hardware connector for coupling an input device to the I/O and/or peripheral control module 52. In an embodiment, an input interface module 56 is in accordance with one or more Universal Serial Bus (USB) protocols.

The core control module 40 coordinates data communications between the processing module(s) 42 and output device(s) 74 via the output interface module(s) 58 and the I/O and/or peripheral control module 52. An output device 74 includes a speaker, etc. An output interface module 58 includes a software driver and a hardware connector for coupling an output device to the I/O and/or peripheral control module 52. In an embodiment, an output interface module 56 is in accordance with one or more audio codec protocols.

The processing module 42 communicates directly with a video graphics processing module 48 to display data on the display 50. The display 50 includes an LED (light emitting diode) display, an LCD (liquid crystal display), and/or other type of display technology. The display has a resolution, an aspect ratio, and other features that affect the quality of the display. The video graphics processing module 48 receives data from the processing module 42, processes the data to produce rendered data in accordance with the characteristics of the display, and provides the rendered data to the display 50.

FIG. 2 further illustrates sensors 30 and actuators 32 coupled to drive-sense circuits 28, which are coupled to the input interface module 56 (e.g., USB port). Alternatively, one or more of the drive-sense circuits 28 is coupled to the communication device via a wireless network card (e.g., WLAN) or a wired network card (e.g., Gigabit LAN). As another example, one or more of the sensors 30, actuators 32, and drive-sense circuits 28 are internal to the communication device. While not shown, the communication device 12 further includes a BIOS (Basic Input Output System) memory coupled to the core control module 40.

A sensor 30 functions to convert a physical input into an electrical output and/or an optical output. The physical input of a sensor may be one of a variety of physical input conditions. For example, the physical condition includes one or more of, but is not limited to, acoustic waves (e.g., amplitude, phase, polarization, spectrum, and/or wave velocity); a biological and/or chemical condition (e.g., fluid concentration, level, composition, etc.); an electric condition (e.g., charge, voltage, current, conductivity, permittivity, eclectic field, which includes amplitude, phase, and/or polarization); a magnetic condition (e.g., flux, permeability, magnetic field, which amplitude, phase, and/or polarization); an optical condition (e.g., refractive index, reflectivity, absorption, etc.); a thermal condition (e.g., temperature, flux, specific heat, thermal conductivity, etc.); and a mechanical condition (e.g., position, velocity, acceleration, force, strain, stress, pressure, torque, etc.). For example, piezoelectric sensor converts force or pressure into an eclectic signal. As another example, a microphone converts audible acoustic waves into electrical signals.

There are a variety of types of sensors to sense the various types of physical conditions. Sensor types include, but are not limited to, capacitor sensors, inductive sensors, accelerometers, piezoelectric sensors, light sensors, magnetic field sensors, ultrasonic sensors, temperature sensors, infrared (IR) sensors, touch sensors, proximity sensors, pressure sensors, level sensors, smoke sensors, and gas sensors. In many ways, sensors function as the interface between the physical world and the digital world by converting real world conditions into digital signals that are then processed by communication devices for a vast number of applications including, but not limited to, medical applications, production automation applications, home environment control, public safety, and so on.

The various types of sensors have a variety of sensor characteristics that are factors in providing power to the sensors, receiving signals from the sensors, and/or interpreting the signals from the sensors. The sensor characteristics include resistance, reactance, power requirements, sensitivity, range, stability, repeatability, linearity, error, response time, and/or frequency response. For example, the resistance, reactance, and/or power requirements are factors in determining drive circuit requirements. As another example, sensitivity, stability, and/or linear are factors for interpreting the measure of the physical condition based on the received electrical and/or optical signal (e.g., measure of temperature, pressure, etc.).

An actuator 32 converts an electrical input into a physical output. The physical output of an actuator may be one of a variety of physical output conditions. For example, the physical output condition includes one or more of, but is not limited to, acoustic waves (e.g., amplitude, phase, polarization, spectrum, and/or wave velocity); a magnetic condition (e.g., flux, permeability, magnetic field, which amplitude, phase, and/or polarization); a thermal condition (e.g., temperature, flux, specific heat, thermal conductivity, etc.); and a mechanical condition (e.g., position, velocity, acceleration, force, strain, stress, pressure, torque, etc.). As an example, a piezoelectric actuator converts voltage into force or pressure. As another example, a speaker converts electrical signals into audible acoustic waves.

An actuator 32 may be one of a variety of actuators. For example, an actuator 32 is one of a comb drive, a digital micro-mirror device, an electric motor, an electroactive polymer, a hydraulic cylinder, a piezoelectric actuator, a pneumatic actuator, a screw jack, a servomechanism, a solenoid, a stepper motor, a shape-memory allow, a thermal bimorph, and a hydraulic actuator.

The various types of actuators have a variety of actuators characteristics that are factors in providing power to the actuator and sending signals to the actuators for desired performance. The actuator characteristics include resistance, reactance, power requirements, sensitivity, range, stability, repeatability, linearity, error, response time, and/or frequency response. For example, the resistance, reactance, and power requirements are factors in determining drive circuit requirements. As another example, sensitivity, stability, and/or linear are factors for generating the signaling to send to the actuator to obtain the desired physical output condition.

In an example of operation, the communication device 12 communicates with a plurality of drive-sense circuits 28, which, in turn, communicate with a plurality of sensors 30. The sensors 30 and/or the drive-sense circuits 28 are within the communication device 12 and/or external to it. For example, the sensors 30 may be external to the communication device 12 and the drive-sense circuits are within the communication device 12. As another example, both the sensors 30 and the drive-sense circuits 28 are external to the communication device 12. When the drive-sense circuits 28 are external to the computing device, they are coupled to the communication device 12 via wired and/or wireless communication links.

The communication device 12 communicates with the drive-sense circuits 28 to; (a) turn them on, (b) obtain data from the sensors (individually and/or collectively), (c) instruct the drive-sense circuit on how to communicate the sensed data to the communication device 12, (d) provide signaling attributes (e.g., DC level, AC level, frequency, power level, regulated current signal, regulated voltage signal, regulation of an impedance, frequency patterns for various sensors, different frequencies for different sensing applications, etc.) to use with the sensors, and/or (e) provide other commands and/or instructions.

As a specific example, the sensors 30 are distributed along a pipeline to measure flow rate and/or pressure within a section of the pipeline. The drive-sense circuits 28 have their own power source (e.g., battery, power supply, etc.) and are proximally located to their respective sensors 30. At desired time intervals (milliseconds, seconds, minutes, hours, etc.), the drive-sense circuits 28 provide a regulated source signal or a power signal to the sensors 30. An electrical characteristic of the sensor 30 affects the regulated source signal or power signal, which is reflective of the condition (e.g., the flow rate and/or the pressure) that the sensor is sensing.

The drive-sense circuits 28 detect the effects on the regulated source signal or power signals as a result of the electrical characteristics of the sensors. The drive-sense circuits 28 then generate signals representative of change to the regulated source signal or power signal based on the detected effects on the power signals. The changes to the regulated source signals or power signals are representative of the conditions being sensed by the sensors 30.

The drive-sense circuits 28 provide the representative signals of the conditions to the communication device 12. A representative signal may be an analog signal or a digital signal. In either case, the computing device 12-1 interprets the representative signals to determine the pressure and/or flow rate at each sensor location along the pipeline. The communication device may then provide this information to the server 22, the database 24, and/or to another communication device for storing and/or further processing.

As another example of operation, communication device 12 is coupled to a drive-sense circuit 28, which is, in turn, coupled to a sensor 30. The sensor 30 and/or the drive-sense circuit 28 may be internal and/or external to the communication device 12-2. In this example, the sensor 30 is sensing a condition that is particular to the communication device 12-2. For example, the sensor 30 may be a temperature sensor, an ambient light sensor, an ambient noise sensor, etc. As described above, when instructed by the communication device 12 (which may be a default setting for continuous sensing or at regular intervals), the drive-sense circuit 28 provides the regulated source signal or power signal to the sensor 30 and detects an effect to the regulated source signal or power signal based on an electrical characteristic of the sensor. The drive-sense circuit generates a representative signal of the effect and sends it to the communication device 12.

In another example of operation, the communication device 12 is coupled to a plurality of drive-sense circuits 28 that are coupled to a plurality of sensors 30 and is coupled to a plurality of drive-sense circuits 28 that are coupled to a plurality of actuators 32. The general functionality of the drive-sense circuits 28 coupled to the sensors 30 in accordance with the above description.

Since an actuator 32 is essentially an inverse of a sensor in that an actuator converts an electrical signal into a physical condition, while a sensor converts a physical condition into an electrical signal, the drive-sense circuits 28 can be used to power actuators 32. Thus, in this example, the communication device 12 provides actuation signals to the drive-sense circuits 28 for the actuators 32. The drive-sense circuits modulate the actuation signals on to power signals or regulated control signals, which are provided to the actuators 32. The actuators 32 are powered from the power signals or regulated control signals and produce the desired physical condition from the modulated actuation signals.

As another example of operation, communication device 12 is coupled to a drive-sense circuit 28 that is coupled to a sensor 30 and is coupled to a drive-sense circuit 28 that is coupled to an actuator 32. In this example, the sensor 30 and the actuator 32 are for use by the communication device 12. For example, the sensor 30 may be a piezoelectric microphone and the actuator 32 may be a piezoelectric speaker.

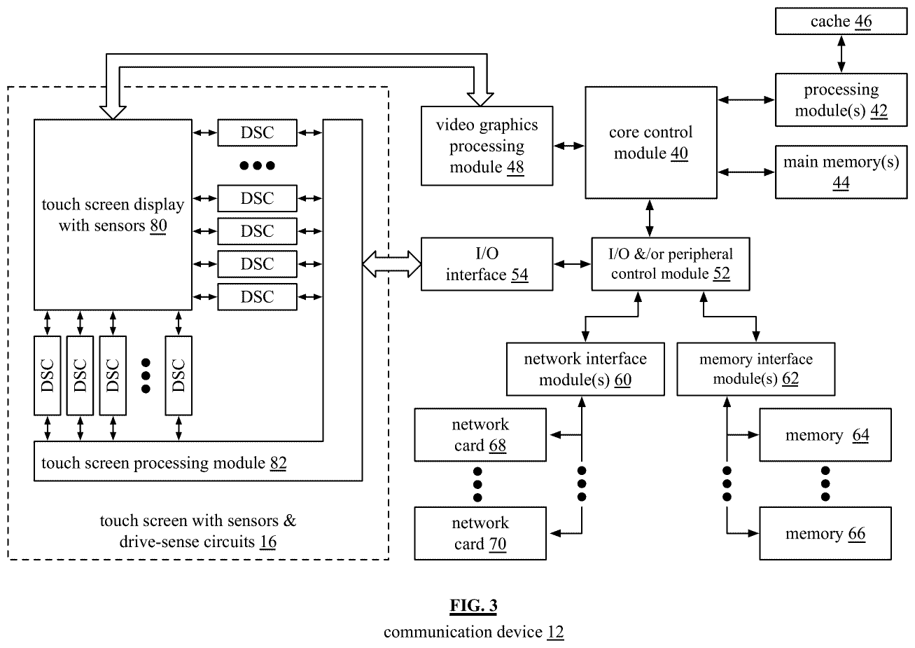

FIG. 3 is a schematic block diagram of another embodiment of a communication device 12 that includes a core control module 40, one or more processing modules 42, one or more main memories 44, cache memory 46, a video graphics processing module 48, a touch screen 16, an Input-Output (I/O) peripheral control module 52, one or more input interface modules 56, one or more output interface modules 58, one or more network interface modules 60, and one or more memory interface modules 62. The touch screen 16 includes a touch screen display 80, a plurality of sensors 30, a plurality of drive-sense circuits (DSCs), and a touch screen processing module 82.

The communication device 12 operates similarly to the communication device 12 of FIG. 2 with the addition of a touch screen as an input device. The touch screen includes a plurality of sensors (e.g., electrodes, capacitor sensing cells, capacitor sensors, inductive sensor, etc.) to detect a proximal touch of the screen. For example, when one or more fingers touches the screen, capacitance of sensors proximal to the touch(es) are affected (e.g., impedance changes). The drive-sense circuits (DSCs) coupled to the affected sensors detect the change and provide a representation of the change to the touch screen processing module 82, which may be a separate processing module or integrated into the processing module 42.

The touch screen processing module 82 processes the representative signals from the drive-sense circuits (DSC) to determine the location of the touch(es). This information is inputted to the processing module 42 for processing as an input. For example, a touch represents a selection of a button on screen, a scroll function, a zoom in-out function, etc.

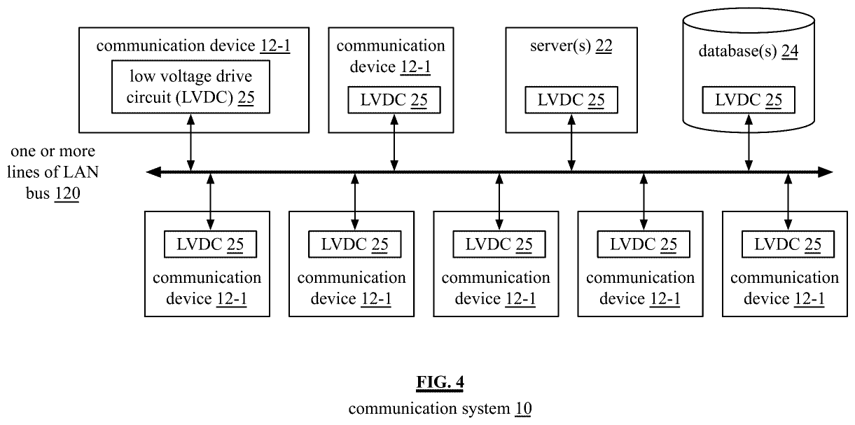

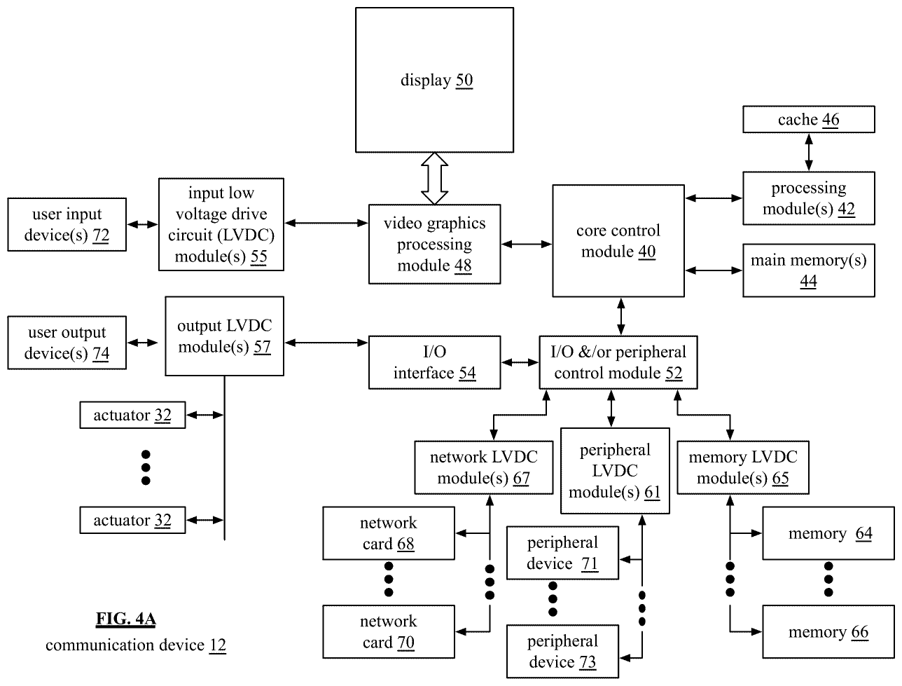

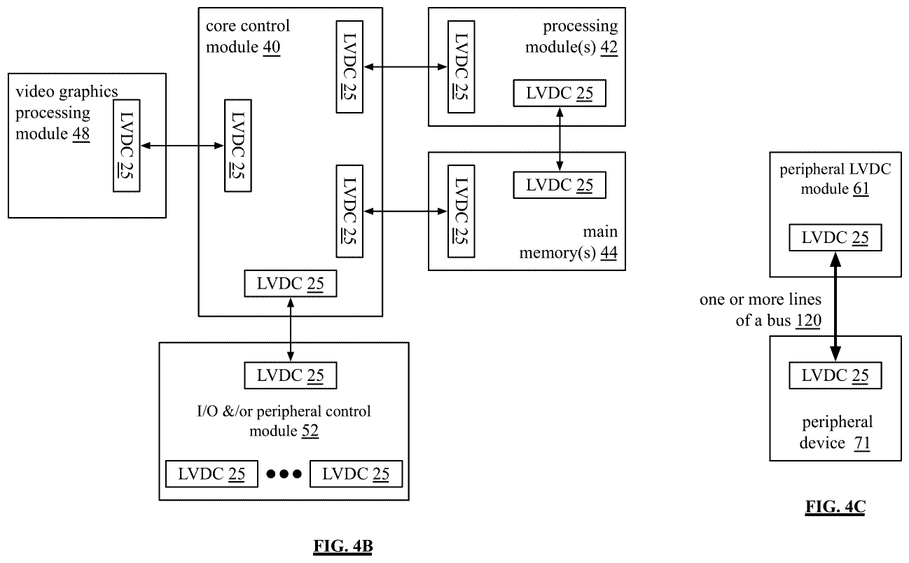

FIG. 4 is a schematic block diagram of another embodiment of a communication system 10 that includes communication devices 12-1, a server 22, and a database 24 coupled to one or more lines of a LAN bus 120. Each device 12-1, 16, and 18 includes one or more LVDCs 25 for communicating data via the line of the LAN bus 120.

An LVDC 25 functions to convert transmit digital data from its host device into an analog transmit signal. As an example, a host device is a communication (i.e., computing) device, a server, or a database. As another example, a host device is an interface of one the communication device, the server, or the database. As yet another example, a host device is an integrated circuit of the communication device, the server, or the database. As a further example, a host device is a die of an integrated circuit.

The LVDC 25 produces the analog transmit signal to have an oscillating component at a given frequency that represents the transmit digital data and to have a very low magnitude. For example, the magnitude of the oscillating component is between five percent and 75 percent of the rail to rail voltage (or current) of the LVDC (e.g., Vdd-Vss of the LVDC). By keeping the magnitude of the oscillating component very low with respect to the rail to rail voltage (or current), data is transmitted with very low power and very good noise immunity. As a specific example, if the voltage magnitude of the oscillating component is 25 mV (milli-volts) and the current is 0.1 mA (milli-amps), then the power is 2.5 μW (micro-watts).

The LVDC 25 also functions to convert an analog receive signal into received digital data that is provided to its host. The analog receive signal is an analog transmit signal from another LVDC of the same host or a different host and is received from the same line of the bus as which the LVDC transmits its analog transmit signal. For an LVDC, the analog receive signal is at the same frequency as its analog transmit signal for half duplex communication and is at a different frequency for full duplex communication.

An LVDC 25 is capable of communicating data with one or more other LVDCs using a plurality of frequencies. Each frequency supports a conveyance of data. For example, the transmit digital data can be divided up into data streams, where each data stream is transmitted on a different frequency of the analog transmit signal. This increases the data rate per line of the bus with very little increase in power. One or more other LVDCs can receive the multiple frequencies of the analog transmit signal, recover the data streams, and recover the transmitted digital data.

FIG. 4A is a schematic block diagram of another embodiment of a communication device 12 that includes a core control module 40, one or more processing modules 42, one or more main memories 44, cache memory 46, a video graphics processing module 48, a display 50, an Input-Output (I/O) peripheral control module 52, one or more low voltage drive circuit (LVDC) interface module(s) 55, one or more LVDC output interface module(s) 57, one or more network LVDC module(s) 76, one or more peripheral LVDC module(s) 61, and one or more memory LVDC module(s) 62.

FIG. 4A operates similarly to the example of FIG. 2, except that the communication device 12 includes one or more LVDC interface module(s) 55 and one or more LVDC output interface module(s) 57 instead of the one or more input interface module(s) 56 and one or more output interface module(s) 58. FIG. 4A further includes one or more network LVDC module(s) 67 and one or more memory LVDC module(s) instead of the one or more network interface module(s) 60 and the one or more memory interface module(s) 62. FIG. 4A further includes the one or more peripheral LVDC module(s) 61 which are operable to couple to one or more peripheral devices 71-73.

Each of the main memories 44 includes one or more Random Access Memory (RAM) integrated circuits, or chips. For example, a main memory 44 includes four DDR4 (4^{th} generation of double data rate) RAM chips, each running at a rate of 2,400 MHz. In general, the main memory 44 stores data and operational instructions most relevant for the processing module 42. For example, the core control module 40 coordinates the transfer of data and/or operational instructions from the main memory 44 and the memory 64-66. The data and/or operational instructions retrieved from memory 64-66 are the data and/or operational instructions requested by the processing module or will most likely be needed by the processing module. When the processing module is done with the data and/or operational instructions in main memory, the core control module 40 coordinates sending updated data to the memory 64-66 for storage.

The memory 64-66 (i.e., non-volatile memory) includes one or more hard drives, one or more solid state memory chips, and/or one or more other large capacity storage devices that, in comparison to cache memory and main memory devices, is/are relatively inexpensive with respect to cost per amount of data stored. The memory 64-66, which includes an LVDC, is coupled to the core control module 40 via the I/O and/or peripheral control module 52 and via one or more memory LVDC modules 65 In an embodiment, the I/O and/or peripheral control module 52 includes one or more Peripheral Component Interface (PCI) buses to which peripheral components connect to the core control module 40. A memory LVDC module 65 includes a software driver and hardware as discussed in one or more subsequent Figures.

The core control module 40 coordinates data communications between the processing module(s) 42 and network(s) via the I/O and/or peripheral control module 52, the network LVDC module(s) 67, and a network card 68 or 70. A network card 68 or 70 includes an LVDC and a wired or wireless communication unit. A wired communication unit includes a Gigabit LAN connection, a Firewire connection, and/or a proprietary computer wired connection. A wireless communication unit includes a wireless local area network (WLAN) communication device, a cellular communication device, a Bluetooth device, and/or a ZigBee communication device. A network LVDC module 67 includes a software driver and hardware as discussed in one or more subsequent Figures.

The core control module 40 coordinates data communications between the processing module(s) 42 and the user input device(s) 72 via the input LVDC module(s) 55 and the I/O and/or peripheral control module 57. A user input device 72 includes an LVDC and further includes one or more of a keypad, a keyboard, control switches, a touchpad, a microphone, a camera, etc. An input LVDC module 55 includes a software driver and hardware as discussed in one or more subsequent Figures.

The core control module 40 coordinates data communications between the processing module(s) 42 and the user output device(s) 74 via the output LVDC module(s) 57 and the I/O and/or peripheral control module 52. A user output device 74 includes an LVDC and a speaker, a tactile actuator, etc. An output LVDC module 57 includes a software driver and hardware as discussed in one or more subsequent Figures.

The core control module 40 coordinates data communications between the processing module(s) 42 and peripheral devices 71 and 73 via the I/O and/or peripheral control module 52 and the peripheral LVDC module(s) 61. A peripheral device 71 or 73 includes an external hard drive, a headset, a speaker, a microphone, a thumb drive, a camera, etc. A peripheral LVDC module 61 includes a software driver and hardware as discussed in one or more subsequent Figures.

The core control module 40 communicates directly with a video graphics processing module 48 to display data on the display 50. The display 50 includes an LED (light emitting diode) display, an LCD (liquid crystal display), and/or other type of display technology. The display has a resolution, an aspect ratio, and other features that affect the quality of the display. The video graphics processing module 48 receives data from the processing module 42, processes the data to produce rendered data in accordance with the characteristics of the display, and provides the rendered data to the display 50. While not shown, the communication device 12 further includes a BIOS (Basic Input Output System) memory coupled to the core control module 40.

FIG. 4B is a schematic block diagram of an embodiment of a computing core of a communication device 12. The computing core includes the core control module 40, the processing module(s) 42, the main memory 44, the video graphics processing module 48, and the and/or peripheral control module 52. These components are generally implemented as integrated circuits (ICs) and mounted on a mother board. The mother board includes traces that form buses for data to be communicated between the components.

In this embodiment, the data communication between components 40-52 is done via Low Voltage Drive Circuits (LVDCs) 25. Each component 40-52 includes one or more LVDCs for communicating with one or more other components. For example, the core control module includes four LVDCs 25: A first LVDC for one-to-one communication with the processing module 42; a second LVDC for one-to-one communication with the main memory 44; a third LVDC for one-to-one communication with the video graphics processing module 48; and a fourth LVDC for one-to-one communication with the IO and/or peripheral control module 52.

In this embodiment, the core control module 40 is coupled to the processing module 42 via a single trace for data communication there-between. The core control module 40 is also coupled, via a single trace, to the main memory 44, the video graphics processing module 48, and to the IO and/or peripheral control module 52. Similarly, the processing module 42 is coupled to the main memory via a single trace. In this manner, the number of traces on the mother board is substantially reduced in comparison to mother boards that use conventional data communication between the components. In addition, the power to convey data is substantially reduced in the present embodiment in comparison to mother boards that use conventional data communication.

In an alternate embodiment, each of the core control module 40, the processing module(s) 42, the main memory 44, the video graphics processing module 48, and the IO and/or peripheral control module 52 includes one LVDC 25 that is coupled to one or more lines of a bus. In an example, the core control module 40 communicates with the processing module 42 using a first set of channels of a frequency band; communicates with main memory 44 using a second set of channels of the frequency band; communicates with the video graphics processing module 48 using a third set of channels of the frequency band; and communicates with the IO and/or peripheral control module 52 using a fourth set of channels of the frequency band. As an example, the frequency band ranges from 1.000 GHz to 1.100 GHz with channels at frequencies every 10 MHz. As such, there are 11 channels: the first at 1.000 GHz, the second at 1.010 GHz, and so on through the eleventh at 1.100 GHz. A specific channel includes a sinusoidal signal at a particular frequency within the frequency band.

In another example of alternative embodiment, the channels are allocated to the components on an as needed basis. For example, when the main memory has data to write to memory device(s) via the IO and/or peripheral control module 52, one or more channels are allocated for this communication. When the data has been conveyed, the allocated channels are released for reallocation to another communication.

FIG. 4C is a schematic block diagram of an embodiment of a peripheral Low Voltage Drive Circuit (LVDC) module 61 of a communication device 12 coupled to a peripheral device 71 via LVDCs 25. The LVDCs 25 are coupled together via one or more lines of a bus 120. The devices communicate data in a full duplex mode per line using multiple channels or in a half-duplex mode per line using a single channel. For example, the LVDC of peripheral LVDC module 61 uses channels 1-3 (e.g., frequencies 1-3 of the frequency band) to transmit data to the LVDC of the peripheral device 71. In addition, the LVDC of the peripheral device 71 uses channels 4-6 (e.g., frequencies 4-6 of the frequency band) to transmit data to the LVDC of the peripheral LVDC module 61.

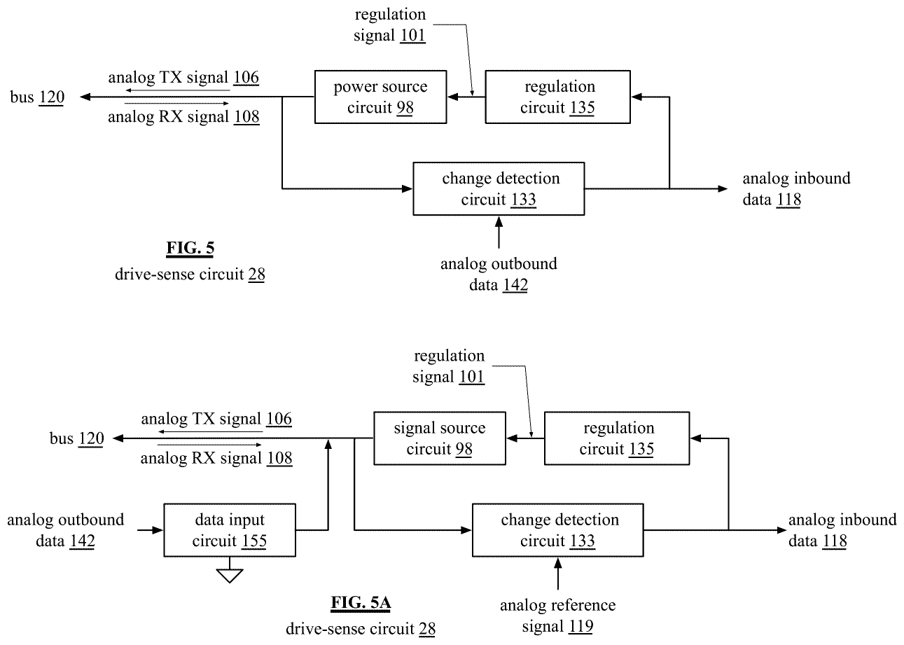

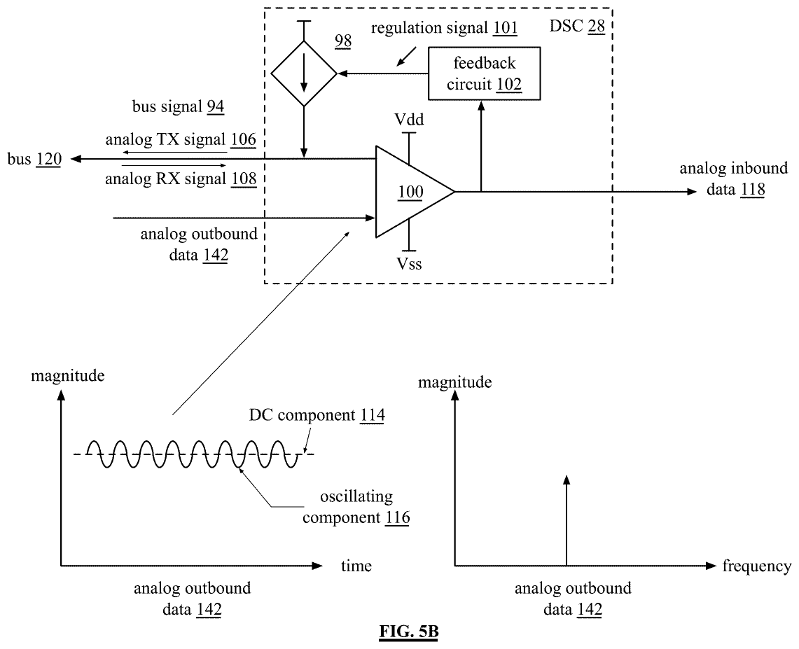

FIG. 5 is a schematic block diagram of an embodiment of a drive sense circuit 28 of a Low Voltage Drive Circuit (LVDC) coupled to one or more lines of a bus 120. The line(s) of the bus are coupled to one or more other LVDCs. The drive-sense circuit 28 includes a change detection circuit 133, a regulation circuit 135, and a power source circuit 98.

The change detection circuit 133, the regulation circuit 135, and the power source circuit 98 operate in concert to keep the inputs of the change detection circuit 133 (e.g., an operational amplifier (op-amp)) substantially matching (e.g., voltage to substantially match, current to substantially match, impedance to substantially match). The inputs to the change detection circuit 133 include the analog outbound data 142 and the signals on the line(s) of the bus 120 (e.g., the analog RX signal 108 and the analog TX signal 106).

When there is no analog RX signal, the only signal on the bus is the analog transmit signal 106. The analog transmit signal 106 is created by adjusting the operation of the change detection circuit 133, the regulation circuit 135, and the power source circuit 98 to match the analog outbound data 142. Since the analog transmit signal 106 tracks the analog outbound data 142 within the drive-sense circuit 98, when there is no analog RX signal 108, the analog inbound data 118 is a DC value.

When an analog RX signal 108 is being received, the change detection circuit 133, the regulation circuit 135, and the power source circuit 98 continue to operate in concert to keep the inputs of the change detection circuit 133 substantially matching. With the presence of the analog RX signal 108, the output of the change detection circuit 133 will vary based on the analog RX signal 108, which produces the analog inbound data 118. The regulation circuit 135 converts the analog inbound data 118 into a regulation signal 101. The power source circuit 98 adjusts the generation of its output (e.g., a regulated voltage or a regulated current) based on the regulation signal 101 to keep the inputs of the change detection circuit 133 substantially matching.

FIG. 5A is a schematic block diagram of another embodiment of a drive-sense circuit 28 of an LVDC coupled to one or more lines of a bus 120. The drive-sense circuit 28 includes the change detection circuit 133, the regulation circuit 135, the power source circuit 98, and a data input circuit 155. The change detection circuit 133, the regulation circuit 135, and the power source circuit 98 function as discussed with reference to FIG. 5 to keep the inputs of the change detection circuit 133 substantially matching. In this embodiment, however, the inputs to the change detection circuit 133 are the signals on the bus (e.g., the analog transmit signal 106 and the analog receive signal 108) and an analog reference signal 119 (e.g., a DC voltage reference signal or DC current reference signal). The analog outbound data 118 is inputted to the data input circuit 155.

The data input circuit 155 creates the analog transmit signals 106 from the analog outbound data 142 and drives it on to the bus 120. In an example, the data input circuit 155 changes the loading on the bus in accordance with the analog inbound data 118 to produce the analog transmit signal 106.

Since the analog transmit signal 106 is being created outside of the feedback loop of the change detection circuit 133, the regulation circuit 135, and the power source circuit 98, the analog inbound data 118 will include a component corresponding to the analog receive signal 108 and another component corresponding to the analog transmit signal 106.

FIG. 5B is a schematic block diagram of an embodiment of a drive-sense circuit (DSC) 28 of a Low Voltage Drive Circuit (LVDC) that includes the change detection circuit (shown as an operational amplifier (op-amp) 100), the regulation circuit (shown as feedback circuit 102), and the power source circuit 98 (shown here as a voltage controlled current source). The DSC 28 is coupled to one or more lines of a bus 120.

The power source circuit 98 may be a voltage supply circuit (e.g., a battery, a linear regulator, an unregulated DC-to-DC converter, etc.) to produce a voltage-based power signal or a current supply circuit (e.g., a current source circuit, a current mirror circuit, etc.) to produce a current-based power signal. As another example, the power source circuit is a bidirectional current supply circuit. The power source circuit 98 generates a power signal to include a DC (direct current) component and an oscillating component.

The feedback circuit 102 may be a wire, a resistor, and/or the regulation circuit that creates a regulation signal 101 to substantially remove any effects on the power signal, etc. The regulation of the power signal may be done by regulating the magnitude of the DC and/or AC components, by adjusting the frequency of AC component, and/or by adjusting the phase of the AC component.

The analog outbound data 142 may be generated by a reference signal generator (gen) (or by converting a transmit digital data received from a host device to analog outbound data) which can be a phase-locked loop (PLL) a crystal oscillator, a digital frequency synthesizer, and/or any other signal source that can provide a sinusoidal signal of desired frequency, phase shift, and/or magnitude. The analog outbound data 142 is produced to have an oscillating component 116 and a direct current (DC) component 114. The oscillating component 116 includes a sinusoidal signal, a square wave signal, a triangular wave signal, a multiple level signal (e.g., has varying magnitude over time with respect to the DC component), and/or a polygonal signal (e.g., has a symmetrical or asymmetrical polygonal shape with respect to the DC component). In the frequency domain, the sinusoidal analog outbound data 142 is a pure tone at the frequency of the oscillating component 116 with a magnitude corresponding to the DC component 114.

In an example of operation, the op-amp 100 compares the signal on the bus (i.e., bus signal 94 including the analog transmit signal 106 and the analog receive signal 108) to the analog outbound data 142 that includes DC and AC components to produce a comparison signal (e.g., analog inbound data 118). Because the analog outbound data 142 includes a DC component and an oscillating component, the bus signal 94 will have a substantially matching DC component and oscillating component. The feedback circuit 102 feeds the analog inbound data 118 to the power source circuit 98 (or regulates the comparison signal to produce a regulation signal 101 and feeds the regulation signal to the power source circuit 98). The analog inbound data 118 includes a representation of analog receive signal 108.

The power source circuit 98 generates a regulated source signal based on the analog inbound data 118 and/or regulation signal 101 as the analog TX signal 106 to adjust the bus signal 94 and output the analog outbound data as the analog transmit signal. As such, the op-amp 100 functions to keep the bus signal 94 substantially constant (e.g., substantially matching the analog outbound data 142) by creating the analog inbound data 118 to correspond to changes in the analog receive signal 108 of the bus signal 94. The power source circuit 98 and the feedback circuit 102 function to generate the analog transmit signal 106 of the bus signal 94 based on the analog inbound data 118 to substantially compensate for changes in the analog receive signal 108 such that the bus signal 94 remains substantially constant and the voltage at each input to the op-amp 100 remains substantially equal.

FIG. 6 is a functional diagram of an embodiment of a Low Voltage Drive Circuit (LVDC) 25. In general, the LVDC 25 functions to convert transmit (TX) digital data 110 into an analog transmit (TX) signal 106 and to convert an analog receive (RX) signal 108 into receive (RX) digital data 112. The LVDC 25 receives the transmit digital data 110 from its host device and transmits the analog TX signal 106 to another LVDC coupled to the line of a bus 120. The analog transmit signal 106 includes a DC component 122 and an oscillating component 124 (at frequency f__{TX}). The oscillating component 124 includes data encoded into one or more channels of a frequency band and has a very low magnitude (e.g., 5% to 75% of the rail to rail voltage and/or current powering the LVDC and/or the host device). This allows for low power high data rate communications in comparison to conventional low voltage signaling protocols.

As an example, the transmit digital data is encoded into one channel, as such the oscillating component includes one frequency: the one corresponding to the channel. As another example, the transmit digital data is divided into x number of data streams. The LVDC encodes the x number of data streams on to x number of channels. Thus, the oscillating component 124 includes x number of frequencies corresponding to the x number of channels.

The LVDC 25 receives the analog receive signal 108 from another LVDC (e.g., the one it sent its analog TX signal to and/or another LVDC coupled to the line of the bus 120). The analog receive signal 108 includes a DC component 126 and a receive oscillating component 128 (at a frequency f__{RX}). The receive oscillating component 128 includes data encoded into one or more channels of a frequency band by the other LVDC and has a very low magnitude. The LVDC converts the analog receive signal 108 into the receive digital data 112, which it provides to its host device.

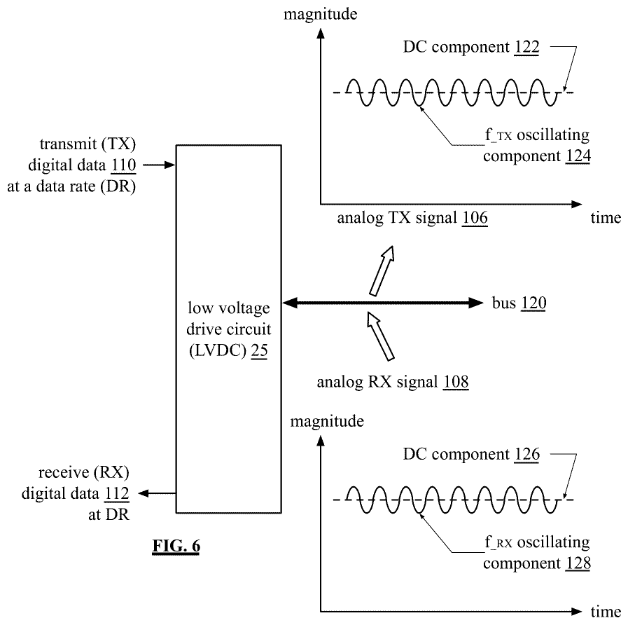

FIG. 7 is a schematic block diagram of an embodiment of a Low Voltage Drive Circuit (LVDC) 25 coupled to a host device 130 and to one or more lines of a bus 120. The host device 130 includes a processing module 134 and memory 132 (e.g., volatile memory and/or non-volatile memory). The memory 132 stores at least part of an LVDC driver 136 application. The LVDC 25 includes a drive-sense circuit 28, a receive analog to digital converter (ADC) circuit 138, and a transmit digital to analog converter (DAC) circuit 140.

In an example of operation, the processing module 134 of the host device 130 accesses the LVDC driver 136 to set up the LVDC 25 for operation. For example, the LVDC driver 136 includes operational instructions and parameters that enable the host device 130 to effectively use the LVDC for data communications. For example, the parameters include two or more of: one or more communication scheme parameters; one or more data conveyance scheme parameters, one or more receive parameters, and one or more transmit parameters. A communication scheme parameter is one of: independent communication (e.g., push data to other device without prompting from other device); dependent communication (e.g., push or pull data to or from other device with coordination between the devices); one to one communication; one to many communication; many to one communication; many to many communication; half duplex communication; and full duplex communication.

A data conveyance scheme parameter is one of: a data rate per line; a number of bits per data rate interval; data coding scheme per line and per number of bits per data rate interval; direct data communication; modulated data communication; power level of signaling per line of the bus; voltage/current level for a data coding scheme per line (e.g., function of signal to noise ratio, power level, and data rate); number of lines in the bus; and a number of lines of the bus to use.

A receive parameter includes one of: a digital data format for the received digital data; a packet format for the received digital data; analog to digital conversion scheme in accordance with parameter(s) of the communication scheme and of the data conveyance scheme of transmitted data by other LVDCs; and digital filtering parameters (e.g., bandwidth, slew rate, center frequency, digital filter coefficients, number of taps of digital filtering, stages of digital filtering, etc.).

A transmit parameter includes one of: a digital data format for the transmit digital data; a packet format for the transmit digital data; and digital to analog conversion in accordance with parameter(s) of the communication scheme and of the data conveyance scheme.

Once the LVDC 25 is set up for a particular data communication, the transmit DAC circuit 140 receives the transmit digital data 110 from its host device 130 at a data rate of the host device (e.g., 100 Mbps, 1 Gbps, etc.). If necessary, the transmit DAC circuit 140 converts the format of the transmit digital data 110 in accordance with one or more transmit parameters 146. In addition, the transmit DAC circuit 110 synchronizes the transmit digital data with a bus data rate (e.g., the data rate at which data is transmitted via a line of the bus 120) to produce a digital input of n-bits per interval of the bus data rate, where “n” is an integer greater than or equal to one. The transmit DAC circuit 140 converts the digital input into analog outbound data 142 via a range limited digital to analog converter (DAC) and a DC reference source. The DAC may be a sigma-delta DAC, a pulse width modulator DAC, a binary weighted DAC, a successive approximation DAC, and/or a thermometer-coded DAC. The drive-sense circuit 28 converts the analog outbound data 142 into the analog transmit signal 106 and drives it onto a line of the bus 120.

The drive-sense circuit 28 receives the analog receive signal 108 from the bus 120 and converts it into analog inbound data 118. The receive ADC circuit 138 converts the analog inbound data 118 into digital inbound data. The receive ADC circuit 138 filters the digital inbound data in accordance with one or more receive parameters 144 to produce the filtered data. The receive ADC circuit 138 formats and packetizes the filtered data in accordance with one or more receive parameters 144 to produce the received digital data 112. The receive ADC circuit 138 provides the received digital data 112 to the host device 130.

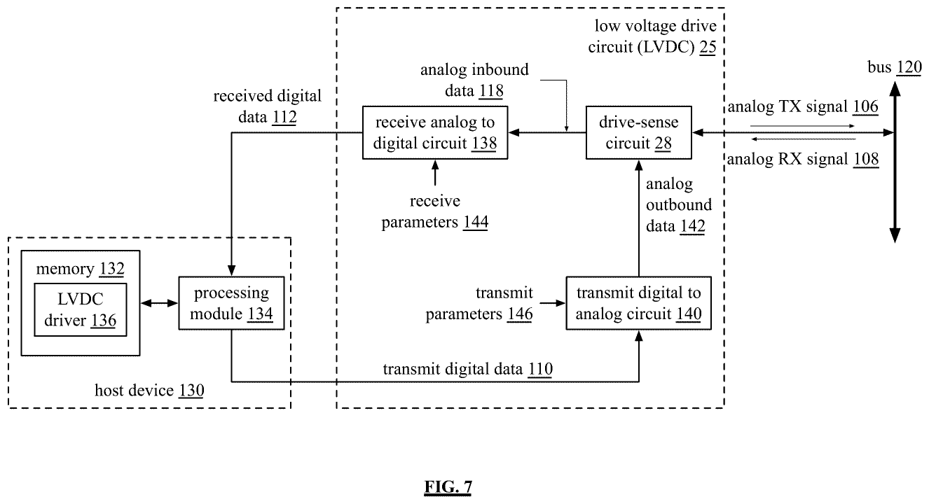

FIG. 8 is a schematic block diagram of an example of two drive-sense circuits (DSCs) 28-1 and 28-2 of two low voltage drive circuits (LVDCs) coupled to one or more lines of a bus 120. The drive-sense circuits 28-1 and 28-2 each include an operational amplifier (op-amp) 100-1 and 100-2, a feedback circuit 102-1 and 102-2, and a power source circuit 98-1 and 98-2. Each drive-sense circuit operates similarly to the drive-sense circuit of FIGS. 5-5B.

The bus signal (e.g., Vload) includes a component of the power signal produced by the power source circuits 98-1 and 98-2 (e.g., analog transmit signals shown as currents itx1 and itx2) and an analog receive signal (e.g., received current signals irx1 and irx2). The op-amps 100-1 and 100-2 compare the bus signal with analog outbound data (V_TX_1 and V_TX_2) that each include DC and AC components to produce analog inbound data (vout1 and vout2). Analog inbound data, vout1 and vout2, include a representation of the analog receive signals (currents irx1 and irx2 respectively).

The analog outbound data V_TX_1 and V_TX_2 each have an oscillating component and a direct current (DC) component. In the frequency domain, the sinusoidal signals are pure tones at the frequency of the oscillating component with a magnitude corresponding to the DC component. For example, V_TX_1 includes an oscillating component at a frequency f1 and V_TX_2 includes an oscillating component at a frequency f2. As such, the DSC 28-1 transmits a signal at a frequency f1 and receives a signal at a frequency f2 and the DSC 28-2 transmits a signal at a frequency f2 and receives a signal at a frequency f1.

The feedback circuits 102-1 and 102-2 feed the analog inbound data, vout1 and vout2, to the power source circuits 98-1 and 98-2 (or regulates the signals to produce a regulation signal and feeds the regulation signal to the power source circuits). The power source circuits 98-1 and 98-2 are operable to adjust the power signal based on the analog inbound data and/or a regulation signal to remove the analog receive signal component on the power signal. In this example, each drive-sense circuit 28-1 and 28-2 includes a capacitor connected to ground to sink the analog receive signals (currents irx2 and irx1).

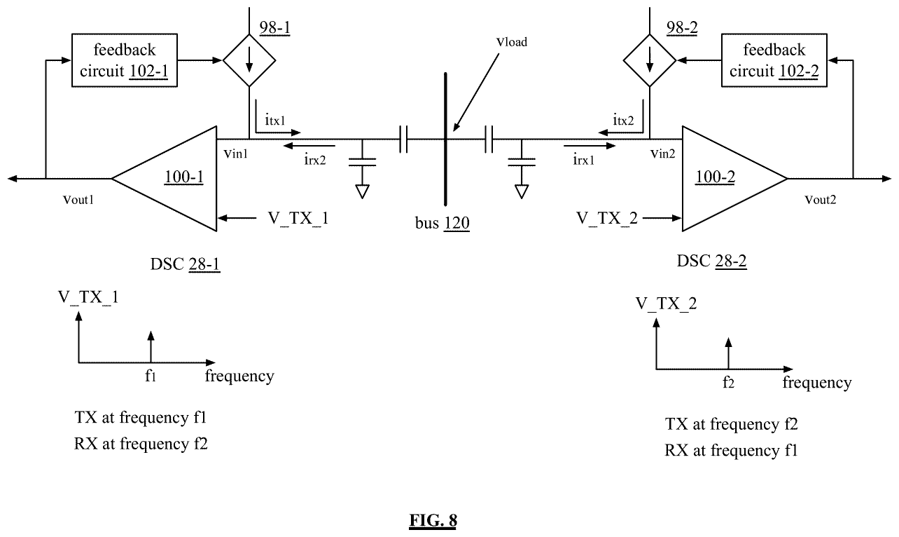

FIG. 9 is a schematic block diagram of an example of two drive-sense circuits (DSCs) 28-1 and 28-2 of two low voltage drive circuits (LVDCs) coupled to one or more lines of a bus 120. The drive-sense circuits 28-1 and 28-2 of FIG. 9 operate similarly to the drive-sense circuits of FIG. 8 except that the power source circuits 98-1 and 98-2 are bidirectional current supply circuits and each drive-sense circuit 28-1 and 28-2 does not include a capacitor connected to ground to sink the received current irx2 and irx1. Instead, the bidirectional power source circuits 98-1 and 98-2 are operable to sink the analog receive signals (currents irx2 and irx1).

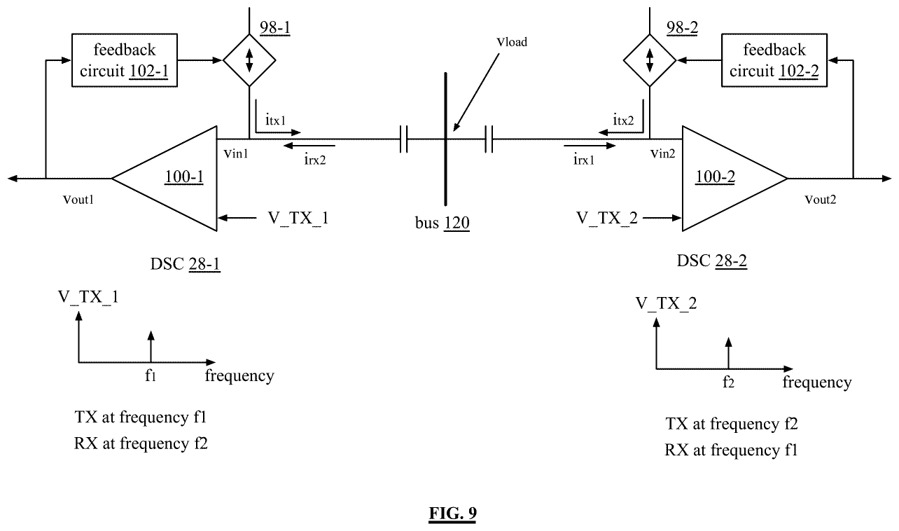

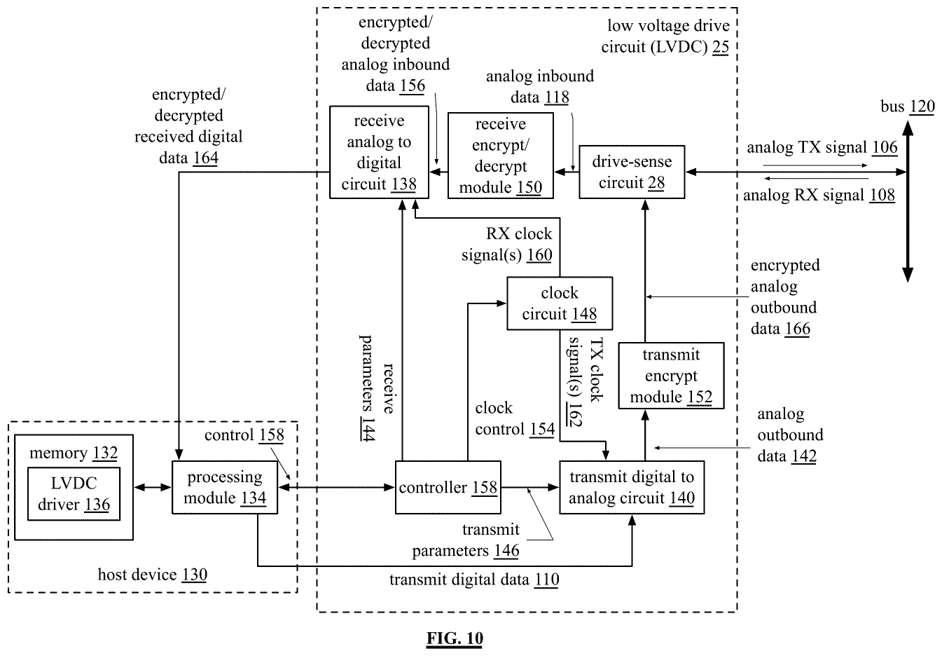

FIG. 10 is a schematic block diagram of another embodiment of a Low Voltage Drive Circuit (LVDC) 25 coupled to a host device 130 and to one or more lines of a bus 120. The host device 130 includes a processing module 134 and memory 132 (e.g., volatile memory and/or non-volatile memory). The memory 132 stores at least part of an LVDC driver 136 application. The LVDC 25 includes a drive-sense circuit 28, a receive encrypt/decrypt module 150, a receive analog to digital converter (ADC) circuit 138, a transmit encrypt module 152, a transmit digital to analog converter (DAC) circuit 140, a clock circuit 148, and a controller 158. The drive-sense circuit 28, the receive ADC circuit 138, and the transmit DAC circuit 140 function as previously discussed with reference to FIG. 7.

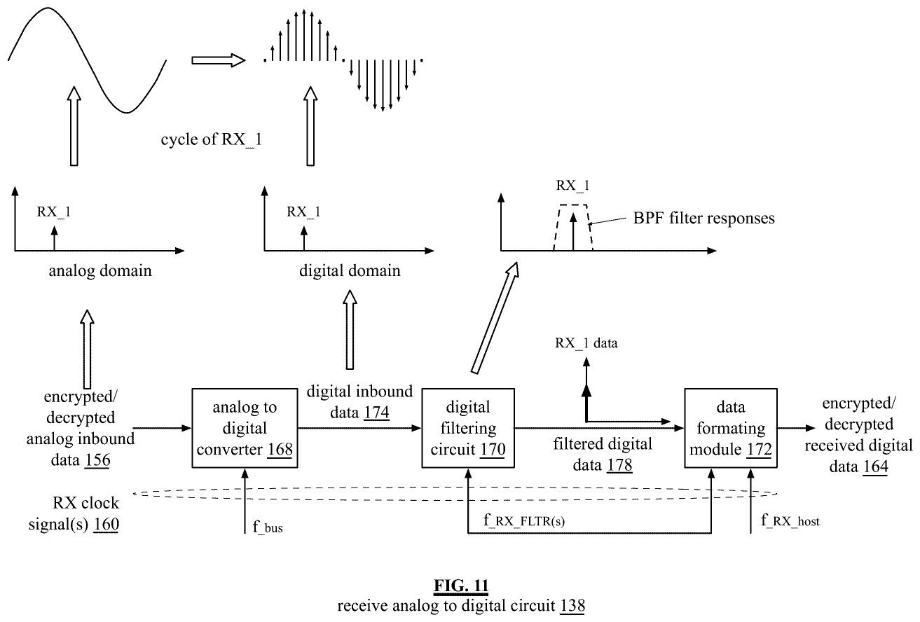

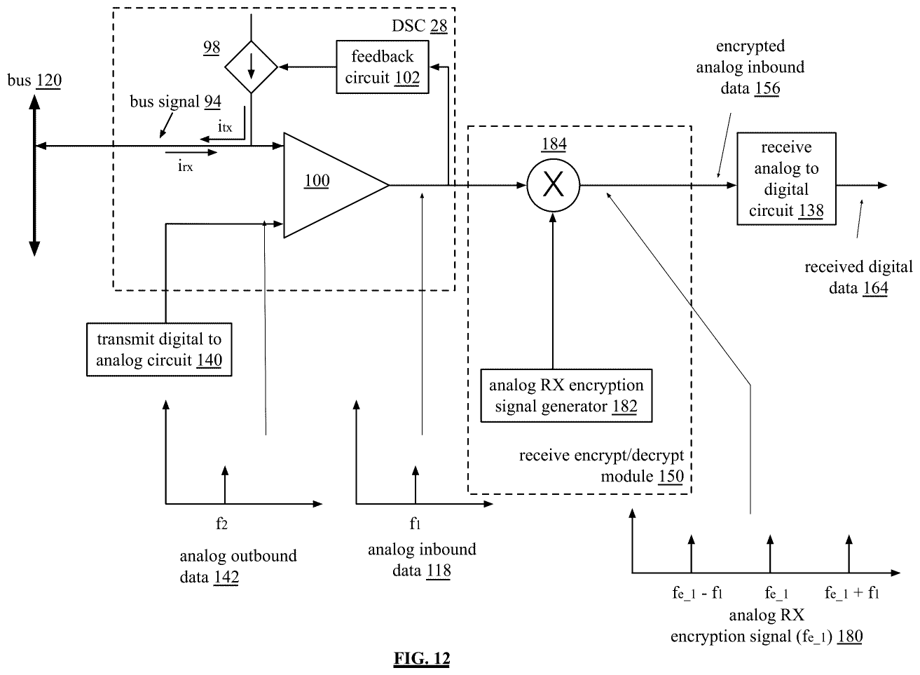

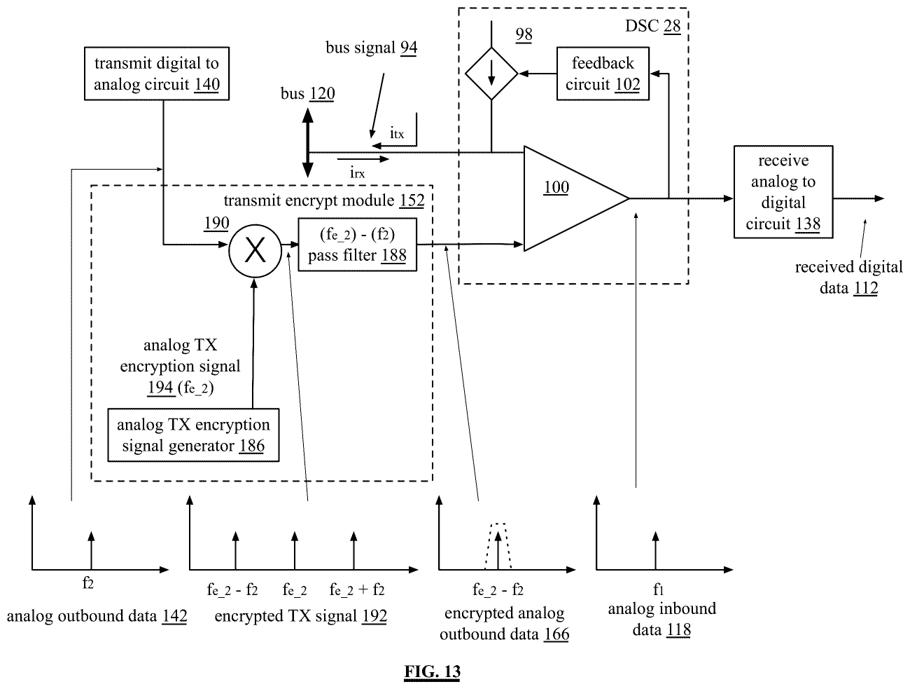

The transmit encrypt module 152 encrypts the analog outbound data 142 to produce encrypted analog outbound data 166 using one or more encryption techniques. For example, the transmit encrypt module 152 mixes or adds an analog transmit encryption signal with the analog outbound data 142 to produce the encrypted analog outbound data 166. When the frequency of the analog outbound data 142 does not need to be preserved, an analog transmit encryption signal may be multiplied to the analog outbound data 142 for encryption. In an LVDC communication or other analog signal transmit-receive communication including a drive-sense circuit, a frequency supports a conveyance of data. For example, transmit digital data can be divided up into data streams, where each data stream is transmitted on a different frequency of the analog transmit signal. Because the magnitude of the oscillating component holds the data information (e.g. the voltage magnitude), the particular frequency of the transmit signal does not affect the data measurement. As such, the frequency of the analog outbound data (i.e., the transmit signal) does not need to be preserved during encryption (e.g., the frequency can be altered without affecting the transmit data). However, while LVDC communications or other analog signal transmit-receive communications do not require frequency preservation, the frequency of the analog outbound data may be preserved as a preference or other setting. The transmit encrypt module 152 and analog outbound data encryption that does not preserve the analog outbound data frequency will be discussed in further detail with reference to at least FIGS. 13 and 15-16.

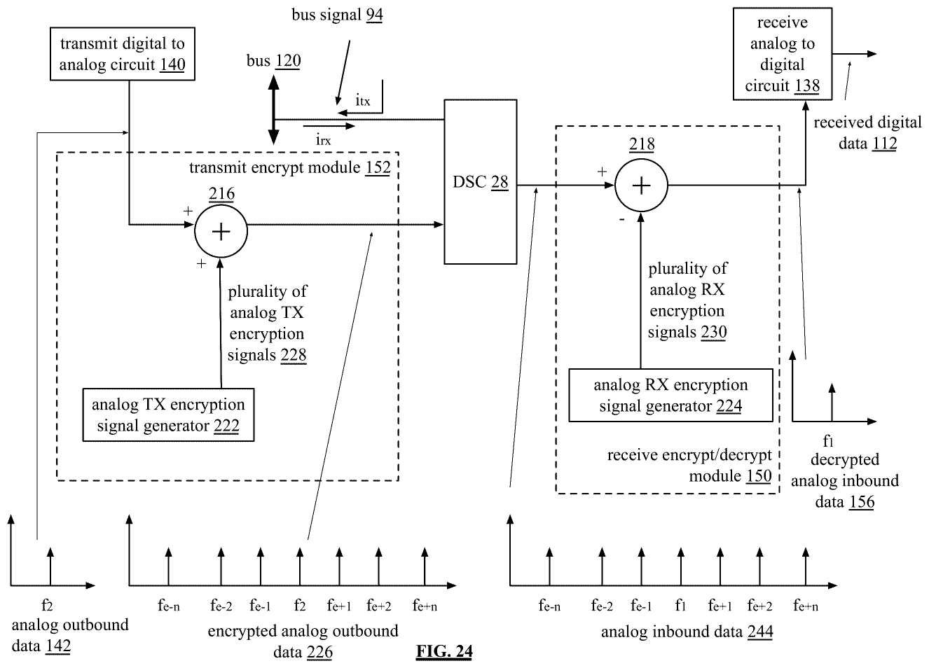

For other applications, such as touch sense or sampling a load, it is important to preserve the frequency of the analog outbound data. For example, an analog reference signal used for driving an electrode includes a DC component, a first oscillating component at a first frequency, and a second oscillating component at a second frequency. In an example, the DC component is used to measure resistance of an electrode (if desired), the first oscillating component is used to measure the impedance of self-capacitance, and the second oscillating component is used to measure the impedance of mutual-capacitance. Because the frequency components correspond to impedance measurements, the frequency of the analog reference signal (i.e., the analog outbound data) must be preserved during encryption. When the frequency of the analog outbound data 142 needs to be preserved, multiple analog transmit encryption signals may be added to the analog outbound data 142 for encryption. The transmit encrypt module 152 and analog outbound data encryption that does preserve the analog outbound data frequency will be discussed in further detail with reference to at least FIG. 24.

The receive encrypt/decrypt module 150 either encrypts or decrypts the analog inbound data 118 (depending on whether encryption is desired and/or if the analog inbound data is encrypted) to produce encrypted/decrypted analog inbound data 156 using one or more encryption/decryption techniques. For example, when the analog inbound data is encrypted, the receive encrypt/decrypt module 150 mixes or subtracts an analog receive encryption signal with the analog inbound data 118 to produce decrypted analog inbound data 156.

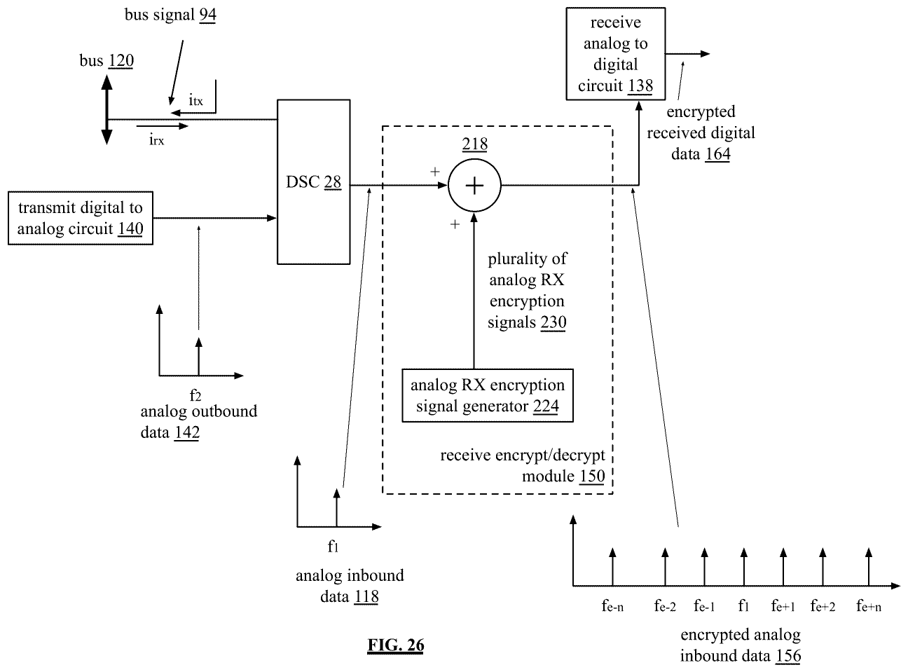

When the analog inbound data 118 is not encrypted and encryption is desired, the receive encrypt/decrypt module 150 is operable to mix or add an analog receive encryption signal with the analog inbound data 118 to produce encrypted analog inbound data 156. When the frequency of the analog inbound data 156 does not need to be preserved, an analog receive encryption signal may be multiplied to the analog inbound data 156 for encryption. When the frequency of the analog inbound data 156 does need to be preserved, multiple analog receive encryption signals may be added to the analog inbound data 156 for encryption. The receive encrypt/decrypt module 150 and analog inbound data encryption/decryption that does not require preservation of the analog inbound data frequency will be discussed in further detail with reference to at least FIGS. 12 and 14-16. The receive encrypt/decrypt module 150 and analog inbound data encryption/decryption that does require preservation of the analog inbound data frequency will be discussed in further detail with reference to at least FIGS. 24 and 26.

In this embodiment, the processing module 134 of the host device 130 accesses the LVDC driver 136 to determine control information 158 to set up the LVDC 25 for operation. The processing module 134 provides the control information 158 to the controller 158, which generates the receive parameters 144, the transmit parameters 146, and clock control signals 154 from the control information 158. In addition, the controller 158 determines one or more communication scheme parameters and/or one or more data conveyance scheme parameters based on the control information 158.

In an embodiment, the controller 158 is a processing module with associated memory. The memory (e.g., volatile and/or non-volatile) stores a plurality of look up tables: a first for the communication parameters; a second for the data conveyance scheme parameters; a third for the transmit parameters 146; a fourth for the receive parameters 144; and a fifth for clock control parameters 154 (e.g., clock rate settings, duty cycle settings, etc.).

The clock circuit 148 is operable to create one or more transmit clock signals 162 and to create one or more receive clock signals 160 based on the clock control parameters, or control information 158. For example, the clock circuit 148 generates a first receive clock signal for outputting the encrypted/decrypted received digital data 164 to the host device 130 and a second receive clock for converting the encrypted/decrypted analog inbound data 156 into digital inbound data. As another example, the clock circuit 148 generates a first transmit clock for receiving the transmit digital data 110 from the host device and a second transmit clock for converting the transmit digital data 110 into the analog outbound data 142.

FIG. 11 is a schematic block diagram of an embodiment of a receive analog to digital circuit 138 that includes an analog to digital converter (ADC) 168, a digital filtering circuit 170, and a data formatting circuit 172. The encrypted/decrypted analog inbound data 156 is a sinusoidal data signal/data stream represented in the analog frequency domain as tone RX_1 (i.e., a particular frequency). The encrypted/decrypted analog inbound data 156 may include more than one sinusoidal data stream where each data stream is represented by an individual tone in the analog frequency domain (e.g., RX_1, RX_2, etc.). The encrypted/decrypted analog inbound data 156 may be encoded via amplitude shift keying (ASK), phase shift keying (PSK), frequency shift keying (FSK), and/or another type of encoding.

The ADC 168 may be implemented in a variety of ways. For example, the ADC 106 is implemented as a flash ADC, a successive approximation ADC, a ramp-compare ADC, a Wilkinson ADC, an integrating ADC, and/or a delta encoded ADC. As yet another example, the ADC 168 is implemented as a sigma-delta ADC.

The ADC 168 uses a clock signal f__{bus} of RX clock signals 160 to receive the encrypted/decrypted analog inbound data 156 in sync with a bus clock. The ADC 168 converts the encrypted/decrypted analog inbound data 156 into digital inbound data 174 where digital inbound data 174 is a set of discrete values representative of the encrypted/decrypted analog inbound data 156. The digital inbound data 174 is represented in the digital frequency domain as tone RX_1. The digital inbound data 174 may include more than one tone in the digital frequency domain when representing more than one analog signal.

The digital filtering circuit 170 filters the digital inbound data 174 in accordance with one or more receive parameters to produce the filtered data 178. A receive parameter includes one of: a digital data format for the received digital data; a packet format for the received digital data; analog to digital conversion scheme in accordance with parameter(s) of the communication scheme and of the data conveyance scheme of transmitted data by other LVDCs; and digital filtering parameters (e.g., bandwidth, slew rate, center frequency, digital filter coefficients, number of taps of digital filtering, stages of digital filtering, etc.).

As an example, the digital filtering circuit 170 includes a digital bandpass filter (BPF) tuned to extract data at a particular frequency (e.g., RX_1). A digital BPF has a bandpass frequency range and a center frequency (f), where f is set to correspond to a channel and where a channel is carrying a frequency domain digital inbound data 174 signal (e.g., RX_1). When the digital inbound data 174 includes more than one signal (e.g., RX_1 through RX n), the digital filtering circuit 170 includes more than one BPF, where each BPF is tuned for a different channel corresponding to desired digital inbound data 174. For example, a first digital BPF is tuned for frequency RX_1, a second digital BPF is tuned for frequency RX_2, and so on.

The digital filtering circuit 170 filters digital inbound data 174 and outputs “n”-bit digital values of filtered digital data 178 corresponding to a cycle of the digital inbound data 174, where “n” is an integer greater than or equal to 1. Depending on the way the encrypted/decrypted analog inbound data 156 is encoded, a digital BPF uses amplitude shift keying (ASK), phase shift keying (PSK), and/or frequency shift keying (FSK) filtering to produce the “n”-bit digital value representative of the digital inbound data 174 per cycle of RX_1 (e.g., by interpreting amplitude, phase, and/or frequency).

In a 1-bit ASK filtering example, an ASK filtering BPF interprets amplitude of each cycle of digital inbound data 174 as corresponding to a digital logic “0” or a digital logic “1.” Cycles having a first magnitude (e.g., 0.5 V) are interpreted as digital logic value “0” and cycles having a second magnitude (e.g., 1 V) are interpreted as digital value “1.” The digital filtering circuit 170 uses clock signal f__{RX_FLTR(s)} of the RX clock signals 160 to receive the digital inbound data 174 in sync with a filter clock. The filter clock operates at a rate in accordance with the number of taps per data cycle a BPF has. For example, a BPF with 16 taps has a filter clock rate of 16 clock cycles for every one data cycle.

The data formatting module 172 formats and packetizes the filtered digital data 178 in accordance with the one or more receive parameters to produce encrypted/decrypted received digital data 164. For example, the data formatting module 172 converts the filtered digital data 178 to binary format and packetizes the formatted data to produce the encrypted/decrypted received digital data 164. The data formatting module 172 uses clock signal f__{RX_FLTR(s)} of RX clock signals 160 to receive the filtered digital data 178 in sync with a filter clock and f__{RX_host} of RX clock signals 160 to sync output of the encrypted/decrypted received digital data 164 at the data rate of a host.

FIG. 12 is a schematic block diagram of an embodiment of a portion of a Low Voltage Drive Circuit (LVDC) coupled to one or more lines of a bus 120. The portion of the LVDC includes a transmit digital to analog circuit 140, a drive-sense circuit (DSC) 28, a receive encrypt/decrypt module 150, and a receive analog to digital circuit 138. The transmit digital to analog circuit 140, the drive-sense circuit (DSC) 28, the receive encrypt/decrypt module 150, and the receive analog to digital circuit 138 of FIG. 12 operates similarly to the transmit digital to analog circuit 140, the drive-sense circuit (DSC) 28, the receive encrypt/decrypt module 150, and the receive analog to digital circuit 138 of FIG. 10 except that in FIG. 12, the receive encrypt/decrypt module 150 is shown in more detail.

FIG. 12 depicts an example where the frequency of the analog inbound data 118 does not need to be preserved, the analog inbound data 118 is not encrypted, no analog transmit encryption is desired, and analog receive encryption is desired. In this example, the transmit encrypt module is not included because analog transmit encryption is not desired.

The receive encrypt/decrypt module 150 includes a mixer 184 and an analog receive (RX) encryption signal generator 182. The mixer 184 is a frequency mixer that creates new frequencies from two signals applied to it (hence, the original frequency of the analog inbound data is not preserved).

When receiving a power signal (e.g., current signal itx), the analog receive signal (current signal irx) affects the power signal to produce a bus signal 94. The op-amp 100 compares the bus signal 94 with the analog outbound data 142 that includes a direct current (DC) component and an AC component to produce analog inbound data 118. In the frequency domain, the sinusoidal analog inbound data 118 is a pure tone at the frequency of the oscillating component with a magnitude corresponding to the DC component. For example, the analog inbound data 118 has an oscillating component at a frequency f1 (e.g., a receive frequency).

The transmit digital to analog circuit 140 provides the analog outbound data 142 having an oscillating component and a DC component to the op-amp 100. In the frequency domain, the sinusoidal analog outbound data 142 is a pure tone at the frequency of the oscillating component with a magnitude corresponding to the DC component. For example, the analog outbound data 142 has an oscillating component at a frequency f2 (e.g., a transmit frequency).

The bus signal 94 includes a component of the power signal (e.g., the analog transmit signal shown as current itx) and a component of the analog receive signal (e.g., the receive current signal current irx). The receive current signal is a sinusoidal signal that includes AC and DC components. For example, the received current signal has an oscillating component at a frequency f1 (e.g., the receive frequency).

The feedback circuit 102 feeds the analog inbound data 118 to the power source circuit 98 (or regulates the analog inbound data 118 to produce a regulation signal and feeds the regulation signal to the power source circuit 98). The power source circuit 98 is operable to adjust the power signal based on the analog inbound data 118 to remove the effect of the analog receive signal on the power signal.

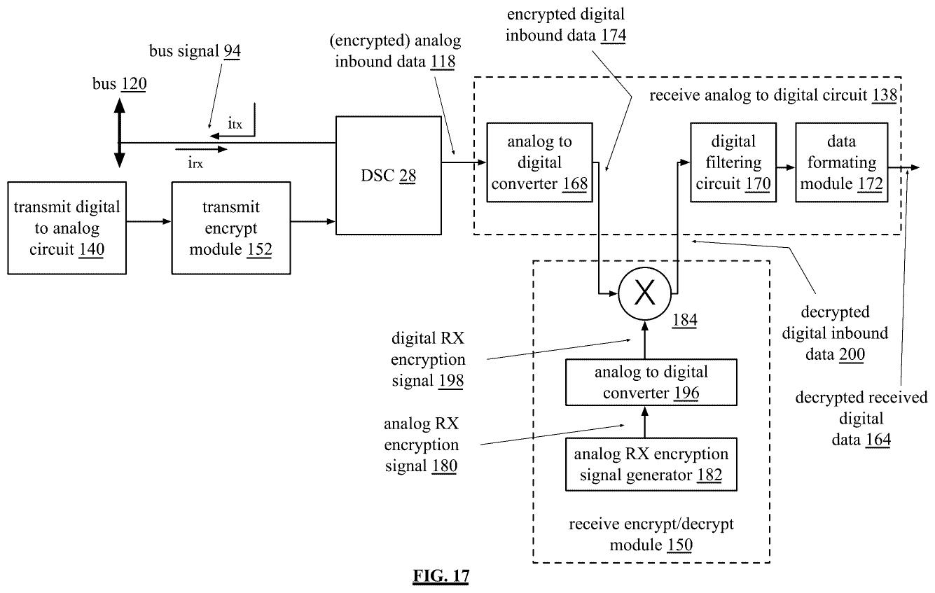

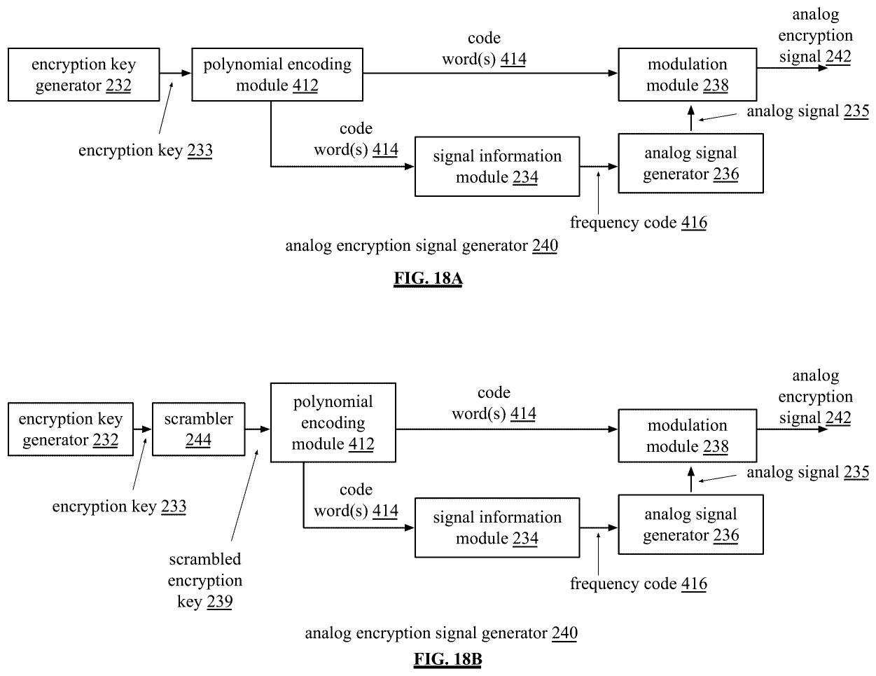

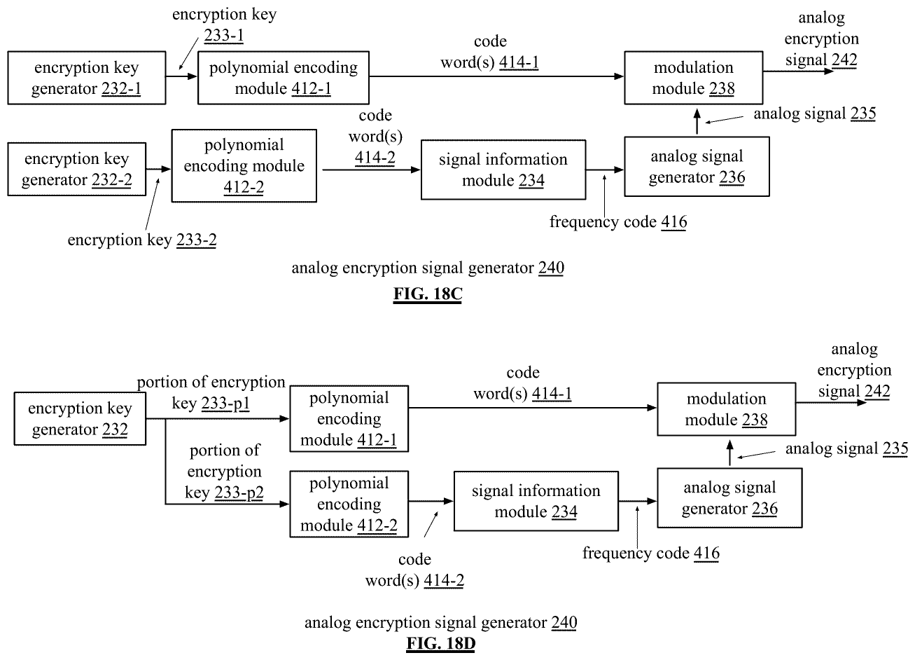

The analog RX encryption signal generator 182 produces an analog RX encryption signal 180 having oscillating component(s) and a direct current (DC) component(s). The analog RX encryption signal generator 182 generates an analog RX encryption signal 180 based on a unique encryption key that determines a sinusoidal signal of desired frequency, phase shift, and/or magnitude. For example, the analog RX encryption signal 180 has an oscillating component at a frequency fe_1. The DC component may have the same or different magnitude as compared to the analog inbound data 118 or may have a varying magnitude. In another example, the analog RX encryption signal 180 may include a frequency hopping pattern with varying frequencies. To encrypt the analog inbound data 118 at the frequency f1 with the analog RX encryption signal 180, the mixer 184 multiplies the analog inbound data 118 with the analog RX encryption signal to produce the encrypted analog inbound data 156. The analog receive encryption signal generator 182 and generating the analog RX encryption signal 180 will be discussed in more detail with reference to FIGS. 18A-23.

When the analog inbound data 118 is not encrypted (as shown), multiplying the analog inbound data 118 with the analog RX encryption signal 180 encrypts the analog inbound data 118. The encrypted analog inbound data 156 includes a modulated spectrum composed of three components where the analog inbound data 118 has been shifted by the analog RX encryption signal 180: one at the frequency of the analog RX encryption signal (fe_1) and two sidebands: one at fe_1−f1, and one at fe_1+f1. The amplitude of the encrypted analog inbound data 156 is different in comparison to the analog inbound data 118 as it is modulated by the analog RX encryption signal 180. As such, the frequency and amplitude data of the analog inbound data 118 is obscured.

The receive analog to digital circuit 138 converts the encrypted analog inbound data 156 into encrypted received digital data 164 as discussed with reference to FIG. 11. In another example, the receive analog to digital circuit 138 converts the encrypted analog inbound data 156 into encrypted digital inbound data and outputs the encrypted digital inbound data to the host device for encrypted data storage. As another example, the encrypted analog inbound data 156 is output to the host device for storage on a physical storage device.

FIG. 13 is a schematic block diagram of an embodiment of a portion of a Low Voltage Drive Circuit (LVDC) coupled to one or more lines of a bus 120 (i.e., a load). The portion of the LVDC includes a transmit digital to analog circuit 140, a drive-sense circuit (DSC) 28, a transmit encrypt module 152, and a receive analog to digital circuit 138. The transmit digital to analog circuit 140, the drive-sense circuit (DSC) 28, the transmit encrypt module 152, and the receive analog to digital circuit 138 of FIG. 13 operates similarly to the transmit digital to analog circuit 140, the drive-sense circuit (DSC) 28, the transmit encrypt module 152, and the receive analog to digital circuit 138 of FIG. 10 except that in FIG. 13, the transmit encrypt module 152 is shown in more detail.

FIG. 13 depicts an example of analog outbound data 142 encryption where the frequency of the analog outbound data 142 does not need to be preserved, and the analog inbound data is not encrypted, and analog receive encryption is not desired. In this example, the receive encrypt/decrypt module is not included/shown because analog receive encryption/decryption is not desired.

The transmit encrypt module 152 includes a mixer 190, an analog transmit (TX) encryption signal generator 186, and a (fe_2)−(f2) pass filter 188. The mixer 190 is a frequency mixer that creates new frequencies from two signals applied to it (hence, the original frequency of the analog outbound data is not preserved). The (fe_2)−(f2) pass filter 188 is a bandpass filter that passes signals with frequencies outside of the (fe_2)−(f2) range. In another embodiment, the (fe_2)−(f2) pass filter 188 is excluded. In another example, the (fe_2)−(f2) pass filter 188 is a (fe_2)+(f2) pass filter.

The analog TX encryption signal generator 186 produces an analog TX encryption signal 194 having oscillating component(s) and direct current (DC) component(s). The analog TX encryption signal generator 186 generates the analog TX encryption signal 194 based on a unique encryption key to produce a sinusoidal signal of desired frequency, phase shift, and/or magnitude. For example, the analog RX encryption signal 180 has an oscillating component at a frequency fe_2. The DC component may have the same or different magnitude as compared to the analog outbound data 142. The analog RX encryption signal 180 may have a varying magnitude. In another embodiment, the analog RX encryption signal 180 may include a frequency hopping pattern. The analog transmit encryption signal generator 186 and generating the analog RX encryption signal 180 will be discussed in more detail with reference to FIGS. 18A-23.

The transmit digital to analog circuit 140 provides analog outbound data 142 to the transmit encrypt module 152. In the frequency domain, the sinusoidal analog outbound data 142 is a pure tone at the frequency of the oscillating component with a magnitude corresponding to the DC component. For example, the analog outbound data 142 has an oscillating component at a frequency f2 (e.g., a transmit frequency). To encrypt the analog outbound data at the frequency f2 with the analog TX encryption signal 194, the mixer 190 multiplies the analog outbound data 142 with the analog TX encryption signal 194 to produce an encrypted TX signal 192.

The encrypted TX signal 192 includes a modulated spectrum composed of three components where the analog outbound data 142 has been shifted by the analog TX encryption signal 194: one at the frequency of the analog TX encryption signal (fe_2) and two sidebands: one at fe_2−f2, and one at fe_2+f2. The amplitude of the encrypted TX signal 192 is different in comparison to the analog outbound data 142 as it is modulated by the analog TX encryption signal 194. As such, the frequency and amplitude data of the analog outbound data is obscured. The (fe_2)−(f2) pass filter 188 filters signals with frequencies outside of the (fe_2)−(f2) range and thus filters out the fe_2 and fe_2+f2 components of the encrypted TX signal 192 to produce encrypted analog outbound data 166 at a frequency of fe_2−f2. When the fe_2)−(f2) pass filter 188 is omitted, the encrypted TX signal 192 including the modulated spectrum is output as the encrypted analog outbound data 166.

When receiving a power signal (e.g., current signal itx), the analog receive signal (current signal irx) affects the power signal to produce a bus signal 94. The op-amp 100 compares the bus signal 94 with the encrypted analog outbound data 166 that includes direct current (DC) components and AC components to produce analog inbound data 118. The bus signal 94 includes a component of the power signal (e.g., the transmit signal shown as current itx) and a component of the analog receive signal (e.g., the received current signal current irx). The received current signal is a sinusoidal signal that includes AC and DC components. For example, the received current signal has an oscillating component at a frequency f1 (e.g., a receive frequency).

The feedback circuit 102 feeds the analog inbound data 118 to the power source circuit 98 (or regulates the analog inbound data 118 to produce a regulation signal and feeds the regulation signal to the power source circuit 98). The power source circuit 98 is operable to adjust the power signal based on the analog inbound data 118 to remove the effect of the analog receive signal on the power signal. The receive analog to digital circuit 138 converts the analog inbound data 118 into received digital data 112 as discussed with reference to FIG. 11.

FIG. 14 is a schematic block diagram of an embodiment of a portion of a Low Voltage Drive Circuit (LVDC) coupled to one or more lines of a bus 120. The portion of the LVDC includes a transmit digital to analog circuit 140, a drive-sense circuit (DSC) 28, a transmit encrypt module 152, and a receive analog to digital circuit 138.

The portion of the LVDC of FIG. 14 operates similarly to the portion of the LVDC of FIG. 12 except that FIG. 14 depicts an example where the frequency of the analog inbound data 142 does not need to be preserved, the analog inbound data 118 is encrypted, analog receive decryption is desired, and analog transmit encryption is not desired. In this example, the transmit encrypt module is not included because analog transmit encryption is not desired.

In this example, the analog inbound data 118 has been encrypted by another LVDC using an analog RX encryption signal 180 at frequency fe_1 and a fe_1−f1 pass filter. The encrypted analog inbound data includes a modulated spectrum composed of three components where the analog inbound data 118 has been shifted by the analog RX encryption signal 180: one at the frequency of the analog RX encryption signal (fe_1) and two sidebands: one at fe_1−f1, and one at fe_1+f1. The fe_1−f1 pass filter of the other LVDC filters out the components other that the fe_1−f1 component and outputs the analog inbound data 118 at a frequency of fe_1−f1.

The mixer 184 of the receive encrypt/decrypt module 150 multiplies the analog inbound data 118 (which is encrypted) with the analog RX encryption signal 180 produced by the analog RX encryption signal generator 182. When the analog inbound data is encrypted using the analog RX encryption signal 180 at frequency fe_1 multiplying the analog inbound data with the analog RX encryption signal 180 (e.g., the same signal it was encrypted with) decrypts the analog inbound data 118.

For example, the decrypted analog inbound data 156 includes a modulated spectrum composed of two components where the analog inbound data 118 has been shifted by the analog RX encryption signal 180 again to reveal the original signal at frequency −f1 as well as a higher frequency signal at 2fe_1−f1. The receive analog to digital circuit 138 applies a bandpass filter to the decrypted analog inbound data 156 centered around the −f1 component in order to filter out the higher frequency component. The receive analog to digital circuit 138 converts the decrypted analog inbound data 156 into decrypted received digital data 164 as discussed with reference to FIG. 11.

FIG. 15 is a schematic block diagram of an example of two drive-sense circuits (DSCs) 28-1 and 28-2 of two Low Voltage Drive Circuits (LVDCs) coupled to a bus 120. The drive-sense circuits 28-1 and 28-2 each include an operational amplifier (op-amp) 100-1 and 100-2, a feedback circuit 102-1 and 102-2, a power source circuit 98-1 and 98-2, and a portion of a transmit encrypt module (a fe_1−f1 pass filter 188-1 and a fe_2−f2 pass filter 188-2). Each drive-sense circuit operates similarly to the drive-sense circuit of FIG. 5.

When receiving a power signal, the received signals on the bus 120 affect the power signal to produce a bus signal (Vload). The bus signal includes a component of the power signal (e.g., a transmit signal shown as currents itx1 and itx2) and a component of received current signals irx1 and irx2 (e.g., analog receive signals)). The op-amps 100-1 and 100-2 compare the bus signal with analog outbound data signals (V_TX_1 and V_TX_2) that each include DC and AC components to produce analog inbound data (vout1 and vout2). The analog inbound data includes a representation of the received current (irx1 and irx2 respectively).

The fe_1−f1 pass filter 188-1 filters out the components of an encrypted transmit signal other that the fe_1−f1 component and outputs the analog outbound data at a frequency of fe_1−f1. The fe_2−f2 pass filter 188-2 filters out the components of an encrypted transmit signal other that the fe_2−f2 component and outputs the analog outbound data at a frequency of fe_2−f2. In another embodiment, the fe_1−f1 pass filter 188-1 and the fe_2−f2 are omitted. In another embodiment, a fe_1+f1 pass filter is included instead of the fe_1−f1 pass filter 188-1 and a fe_2+f2 pass filter is included instead of the fe_2−f2 pass filter 188-2.

The analog outbound data signals V_TX_1 and V_TX_2 each have an oscillating component and a direct current (DC) component. In the frequency domain, the analog outbound data signals are pure tones at the frequency of the oscillating component with a magnitude corresponding to the DC component. For example, V_TX_1 includes an oscillating component at a frequency fe_1−f1 and V_TX_2 includes an oscillating component at a frequency fe_2−f2. As such, the DSC 28-1 transmits a signal at a frequency fe_1−f1 and receives a signal at a frequency fe_2−f2 and the DSC 28-2 transmits a signal at a frequency fe_2−f2 and receives a signal at a frequency fe_1−f1.

The feedback circuits 102-1 and 102-2 feed the analog inbound signals vout1 and vout2 to the power source circuits 98-1 and 98-2 (or regulates the analog inbound signals to produce regulation signals and feeds the regulation signals to the power source circuits). The power source circuits 98-1 and 98-2 are operable to adjust the power signal based on the signals (the analog inbound signals signal and/or regulation signals) to remove the effect of the analog receive signal on the bus signal. In this example, the power source circuits 98-1 and 98-2 are bidirectional current supply circuits operable to sink the received currents irx2 and irx1. In another embodiment, the power source circuits 98-1 and 98-2 are current supply circuits and capacitors are included to sink the received currents irx2 and irx1.

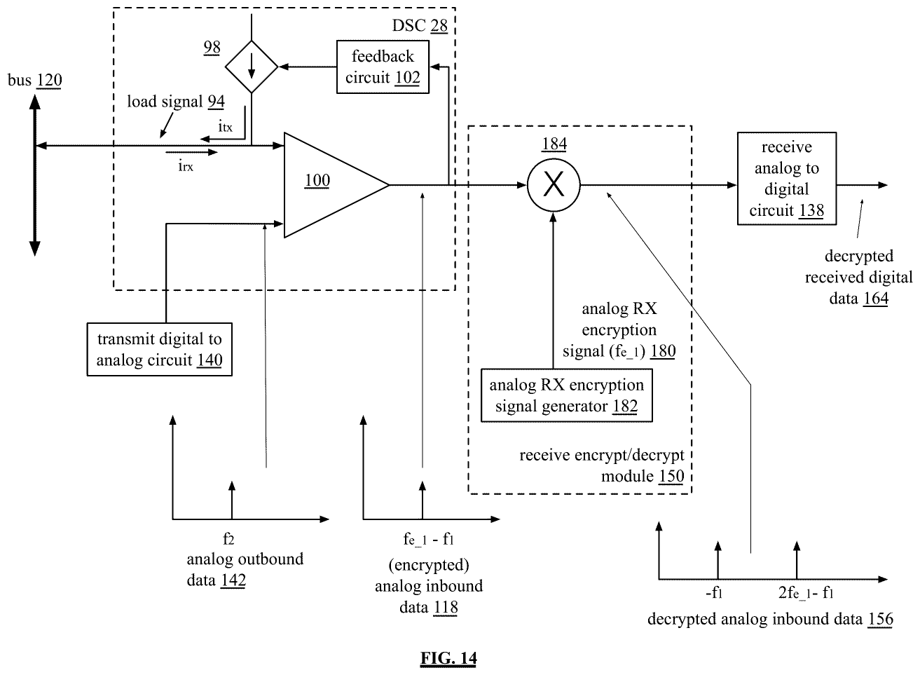

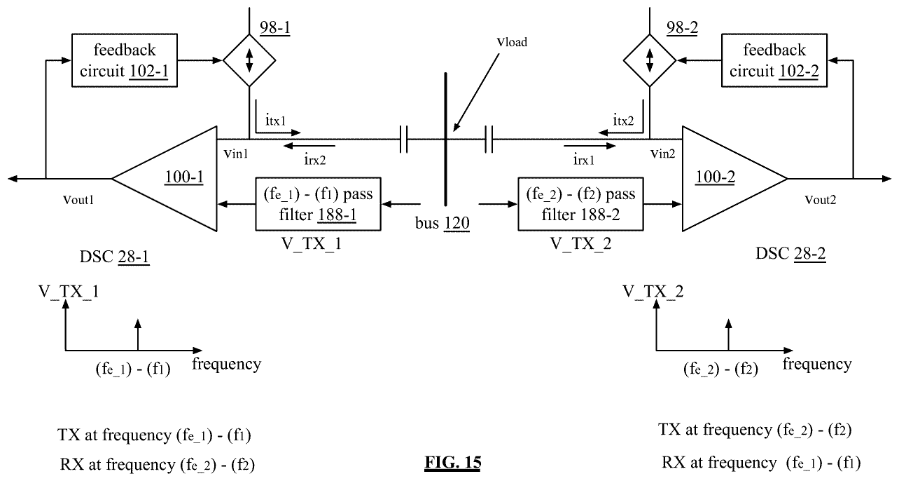

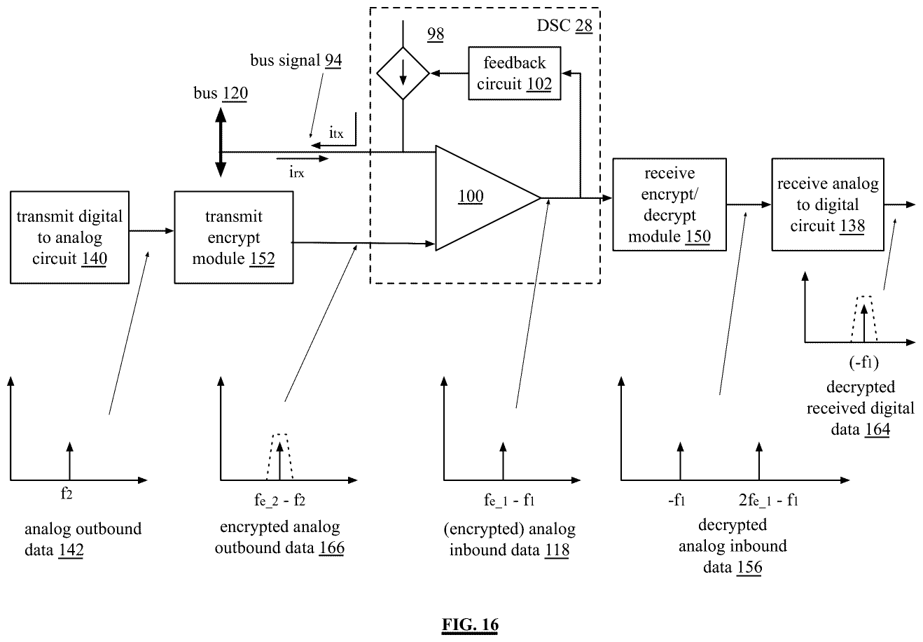

FIG. 16 is a schematic block diagram of an embodiment of a portion of a Low Voltage Drive Circuit (LVDC) coupled to one or more lines of a bus 120. The portion of the LVDC includes a transmit digital to analog circuit 140, a drive-sense circuit (DSC) 28, a transmit encrypt module 152, a receive encrypt/decrypt module 150, and a receive analog to digital circuit 138. The portion of the LVDC of FIG. 16 operates similarly to the portion of the LVDC of FIGS. 13-14 except that in FIG. 16, the LVDC includes both the transmit encrypt module 152 and the receive encrypt/decrypt module 150 because analog transmit encryption is desired and analog receive decryption is desired. Similar to the embodiment of FIG. 15, the portion of the LVDC shown transmits an encrypted analog transmit signal to another LVDC and receives an encrypted analog receive signal from the other LVDC.

The transmit digital to analog circuit 140 provides analog outbound data 142 having an oscillating component and a DC component to the transmit encrypt module 140. In the frequency domain, the sinusoidal analog outbound data 142 is a pure tone at the frequency of the oscillating component with a magnitude corresponding to the DC component. For example, the analog outbound data 142 has an oscillating component at a frequency f2 (e.g., a transmit frequency). The transmit encrypt module 152 encrypts the analog outbound data 142 and filters encrypted analog outbound data signal with frequencies outside of the fe_2−f2 range to produce encrypted analog outbound data 166 at a frequency of fe_2−f2. In another embodiment, the transmit encrypt module 152 does not filter encrypted analog outbound data signal with frequencies outside of the fe_2−f2 range to produce an encrypted analog outbound data 166 having a spectrum of frequencies.

When receiving a power signal (e.g., current signal itx), the analog receive signal (current signal irx) affects the power signal to produce a bus signal. The op-amp 100 compares the bus signal 94 with the encrypted analog outbound data 166 that includes direct current (DC) components and AC components to produce (encrypted) analog inbound data 118.

The bus signal 94 includes a component of the power signal (e.g., the transmit signal shown as current itx) and a component of the analog receive signal (e.g., the received current signal current irx). The received current signal is a sinusoidal signal that includes AC and DC components. In this example, the analog inbound data 118 has been encrypted by another LVDC using an analog RX encryption signal 180 at frequency fe_1 and a fe_1−f1 pass filter to produce analog inbound data 118 at a frequency of fe_1−f1. In another embodiment, the analog inbound data 118 has been encrypted by another LVDC using an analog RX encryption signal 180 at frequency fe_1 with no fe_1−f1 pass filter to produce analog inbound data 118 having a spectrum of frequencies.

The feedback circuit 102 feeds the (encrypted) analog inbound data 118 to the power source circuit 98 (or regulates the analog inbound data 118 to produce a regulation signal and feeds the regulation signal to the power source circuit 98). The power source circuit 98 is operable to adjust the bus signal 94 based on the analog inbound data 118 to remove the effect of the analog receive signal on the power signal. The receive analog to digital circuit 138 converts the analog inbound data 118 into received digital data 112 as discussed with reference to FIG. 11.

The receive encrypt/decrypt module 150 decrypts the (encrypted) analog inbound data 118 with the using an analog RX encryption signal 180 at a frequency fe_1 (e.g., by multiplying the encrypted analog inbound data 118 with the analog RX encryption signal 180) to produce decrypted analog inbound data 156 at −f1 as well as a higher frequency signal at 2fe_1−f1. The analog RX encryption signal 180 is the same signal used to encrypt the analog inbound data 118 by the other LVDC. The RX encryption signal at fe_1 may be the same or different as the TX encryption signal at fe_2. The receive analog to digital circuit 138 applies a bandpass filter to the decrypted analog inbound data 156 centered around the −f1 component in order to filter out the higher frequency component. The receive analog to digital circuit 138 converts the decrypted analog inbound data 156 into decrypted received digital data 164 as discussed with reference to FIG. 11.

FIG. 17 is a schematic block diagram of an embodiment of a portion of a Low Voltage Drive Circuit (LVDC) coupled to one or more lines of a bus 120. The portion of the LVDC includes a transmit digital to analog circuit 140, a drive-sense circuit (DSC) 28, a transmit encrypt module 152, a receive encrypt/decrypt module 150, and a receive analog to digital circuit 138. The portion of the LVDC of FIG. 17 operates similarly to the portion of the LVDC of FIG. 16 except that in FIG. 17, the (encrypted) analog inbound data 118 and the analog RX encryption signal 180 are converted to digital signals prior to mixing. Digital signals are typically easier to edit and manipulate, therefore; this embodiment may be a good option when ease of mixing is a consideration.

In FIG. 17, an analog to digital converter 168 of the receive analog to digital circuit 138 is coupled to the output of the DSC 28 and the mixer 184 of the receive encrypt/decrypt module 150. The receive encrypt/decrypt module 150 includes an analog to digital converter 196 and the mixer 184 is coupled to the digital filtering circuit 170 of the receive analog to digital circuit 138. The analog to digital converter 196 may be implemented in a variety of ways. For example, the analog to digital converter (ADC) 196 is implemented as a flash ADC, a successive approximation ADC, a ramp-compare ADC, a Wilkinson ADC, an integrating ADC, and/or a delta encoded ADC. As yet another example, the ADC 196 is implemented as a sigma-delta ADC.

The analog inbound data 118 has been encrypted by another LVDC using an analog RX encryption signal 180 (e.g., at frequency fe_1 and a fe_1−f1 pass filter to produce analog inbound data 118 at a frequency of fe_1−f1). The analog RX encryption signal generator 182 of the receive encrypt/decrypt module 150 produces an analog RX encryption signal 180 (e.g., at a frequency fe_1). The analog to digital converter 196 of the receive encrypt/decrypt module 150 converts the analog RX encryption signal 180 to a digital RX encryption signal 198.

The ADC 168 of the receive analog to digital circuit 138 uses a clock signal to receive the encrypted analog inbound data 118 in sync with a bus clock. The ADC 168 converts the encrypted analog inbound data 118 into encrypted digital inbound data 174 where the encrypted digital inbound data 174 is a set of discrete values representative of the encrypted analog inbound data 118. The ADC 168 outputs the encrypted digital inbound data 174 to the mixer 184 of the receive encrypt/decrypt module 150.

The mixer 184 multiplies the encrypted digital inbound data 174 with the digital RX encryption signal 198. Multiplying the encrypted digital inbound data 174 with the digital RX encryption signal 198 decrypts the encrypted digital inbound data 174 to produce decrypted digital inbound data 200.

The digital filtering circuit 170 filters the decrypted digital inbound data 200 in accordance with one or more receive parameters to produce the filtered data (e.g., the digital filtering circuit 170 filters out higher frequency components of the digital inbound data 200). A receive parameter includes one of: a digital data format for the received digital data; a packet format for the received digital data; analog to digital conversion scheme in accordance with parameter(s) of the communication scheme and of the data conveyance scheme of transmitted data by other LVDCs; and digital filtering parameters (e.g., bandwidth, slew rate, center frequency, digital filter coefficients, number of taps of digital filtering, stages of digital filtering, etc.).

The digital filtering circuit 170 filters the decrypted digital inbound data 200 and outputs “n”-bit digital values of filtered digital data corresponding to a cycle of the decrypted digital inbound data, where “n” is an integer greater than or equal to 1. The data formatting module 172 formats and packetizes the filtered digital data in accordance with the one or more receive parameters to produce decrypted received digital data 164. For example, the data formatting module 172 converts the filtered digital data to binary format and packetizes the formatted data to produce the encrypted received digital data 164. The configuration presented in FIG. 17 where the mixing is done with digital signals can also be applied to the embodiments of FIGS. 12 and 14.

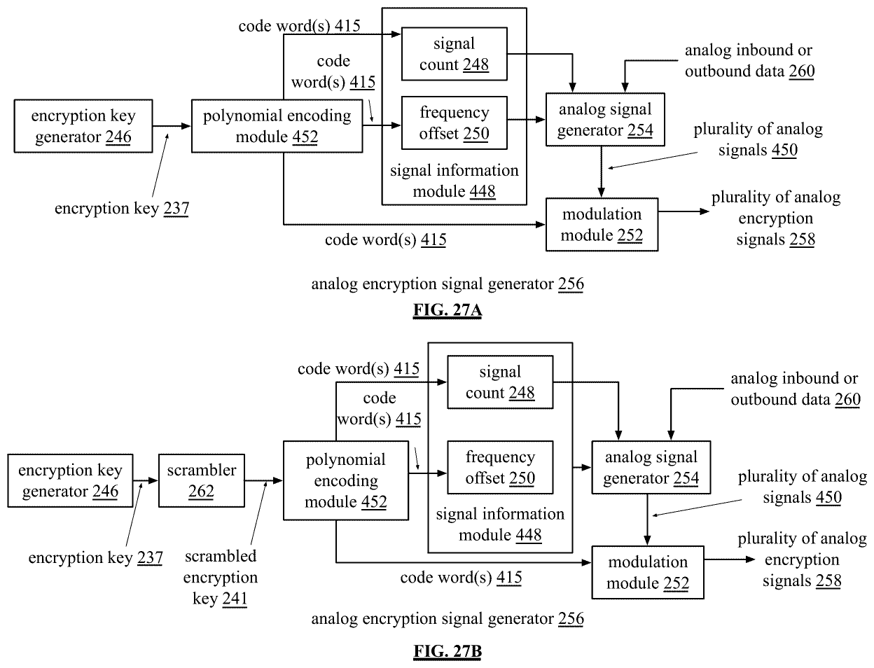

FIGS. 18A-18D are schematic block diagrams of embodiments of an analog encryption signal generator 240. The encryption signal generator 240 may be the analog receive (RX) encryption signal generator 182 or the analog transmit (TX) encryption signal generator 186 of FIGS. 12-14 and 16-17 used in embodiments where the frequency of the analog inbound or outbound data does not need to be preserved. The encryption signal generation where the frequency of the analog inbound or outbound data does need to be preserved will be discussed with reference to FIGS. 27A-33.

In FIG. 18A, the analog encryption signal generator 240 includes an encryption key generator 232, a polynomial encoding module 412, a signal information module 234, a modulation module 238, and an analog signal generator 236. The encryption key generator 232 may be a Random Bit Generator (RBG), a pseudorandom number generator, etc., that uses algorithms designed to ensure each encryption key 233 is unpredictable and unique. An encryption key is typically a random string of bits that are stored in a file, which, when processed through a cryptographic algorithm, can encode or decode cryptographic data. The longer the encryption key, the harder it is to break the encryption code. Symmetric key encryption uses a single key for both encryption and decryption. Asymmetric, or public/private encryption uses a pair of keys. Data is encrypted with one key and decrypted with the other key.

In an example of operation, the encryption key generator 232 produces a random or pseudorandom encryption key 233. The whole encryption key may be sent to the polynomial encoding module or it may be split among more than one polynomial encoding module (e.g., where one polynomial encoding module is coupled to the modulation module and one polynomial encoding module is coupled to the signal info module 234).

The polynomial encoding module 412 is operable to interpret and extract words from the encryption key 233 to determine an encoding polynomial, signal information (e.g., a set of frequencies and a frequency hop time), modulation information (a modulation scheme type), and encryption key data. Because the encryption key 233 is randomly or pseudo randomly generated, the polynomial encoding module 412 assigns meaning to certain numbers of random or pseudo random bits. For example, polynomial encoding module 412 interprets every three bits of the encryption key 233 to contain a different piece of data. For example, the first three bits of the encryption key 233 identify n (code length) of the encoding polynomial, the next three bits to identify m (polynomial degree) of the encoding polynomial, the next three bits to identify the coefficients of a generator polynomial of the encoding polynomial, the next 24 bits identify a set of 8 frequencies, the next three bits identify a frequency hop time, the next three bits identify a modulation scheme type, and the next 15 bits identify encryption key data information. An example of an interpreted encryption key 233 is shown in FIG. 19.

A portion of the encryption key that may not be fully randomly generated is the portion related to the encoding polynomial. For example, m (the polynomial degree) must be less than or equal to n (the code length) and the generator polynomial must be a polynomial of degree m. Therefore, these portions may be generated randomly but in accordance with a formula.

The polynomial encoding module 412 generates the encoding polynomial using the encoding polynomial information interpreted from the encryption key 233 and encodes the remaining information interpreted from the encryption key 233 with the encoding polynomial. The polynomial encoding module 412 interprets the encoded information to produce a plurality of code words 414. The polynomial encoding module 412 may be a standalone module as shown or each of the modulation module 238 and/or signal information module 234 may include a respective polynomial encoding module 412.

The plurality of code words 414 are inputs to the modulation module 238 and the signal information module 234. The polynomial encoding module 412 sends code words pertaining to a frequency hop time and a set of frequencies to the signal information module 234. When frequency hopping is not desired, the frequency hop time code word may correspond to a null value, a value representative of a “no frequency hop,” or be omitted and the set of frequencies would be interpreted to include only one frequency (e.g., the set includes null values, one is randomly selected, the set includes values corresponding to “no frequency” or “skip”). As an example of when frequency hopping is desired, 8 5-bit code words generated from 24 bits of the encryption key may represent 8 frequencies and another 5-bit code word generated from 3 bits of the encryption key may represent the frequency hop time.

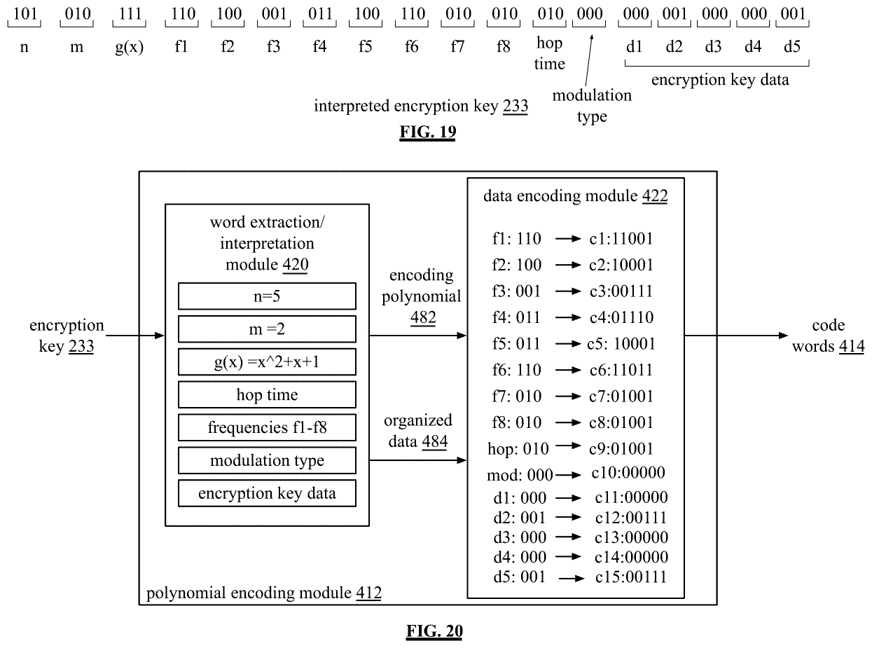

In another example, the same code word could represent a frequency and a frequency hop time where the hop times may vary from frequency to frequency. In another example, the frequency hop time is a default setting set by the signal information module 234 or a processing module of the communication device of the which the analog encryption signal generator 240 is a part of In another embodiment, the polynomial encoding module 412 sends the plurality of code words 414 to the signal information module 234 and the signal information module 234 is operable to extract the code words 414 pertaining to the frequency hop time and the set of frequencies. The polynomial encoding module 412 will be discussed in more detail with reference to FIG. 20.

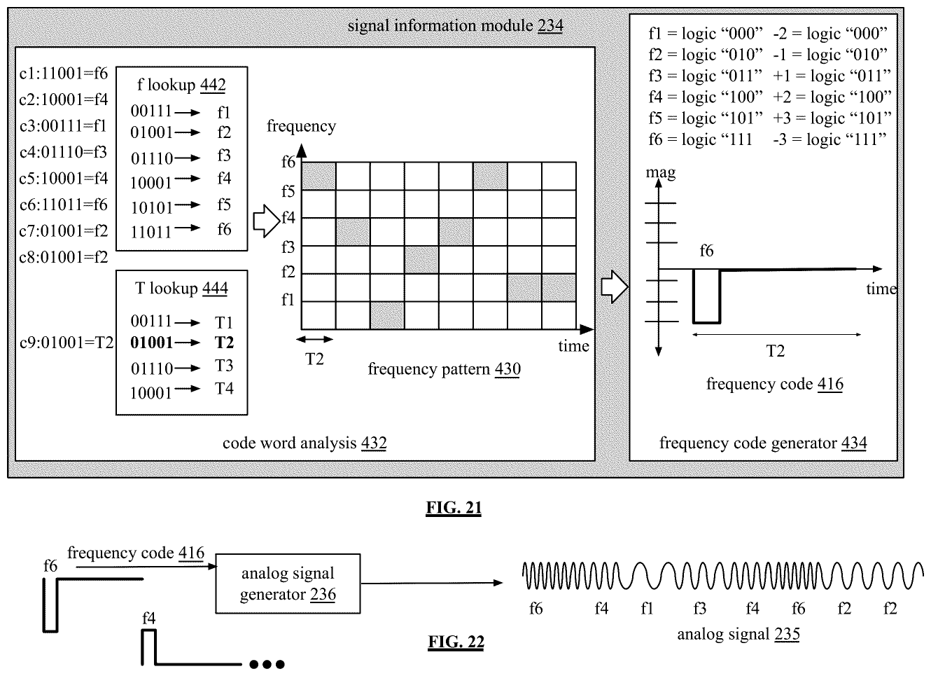

The signal information module 234 is operable to interpret the codes words 414 to determine the frequency hop time and the set of frequencies. For example, the signal information module 234 uses filtering techniques such as a lookup method to translate the code words to meaningful data. For example, the signal information module 234 refers to a lookup table of code words to frequency hop times to determine a frequency hop time and refers to a lookup table of code words to frequencies to determine the set of frequencies. The frequency hop time and the set of frequencies form a frequency pattern. Based on the frequency pattern, the signal information module 234 generates a frequency code 416. The frequency code is a digital signal that represents the frequency pattern. The digital signal may be a series of pulses that each last a time period of the frequency hop time. The signal information module 234 will be discussed in more detail with reference to FIG. 21.

The analog signal generator 236 can be a phase-locked loop (PLL) a crystal oscillator, a digital frequency synthesizer, and/or any other signal source that can provide a sinusoidal signal of desired frequency, phase shift, and/or magnitude. The analog signal generator 236 generates an analog signal 235 based on the frequency code 416. For example, the analog signal generator 236 generates an analog signal 235 that changes frequencies at intervals corresponding to the hop time as indicated in the frequency code 416.

The modulation module 238 is operable to interpret the codes words 414 to determine a modulation scheme and encryption key data. For example, the modulation module 238 uses filtering techniques such as a lookup method to translate the code words to meaningful data. For example, the modulation module 238 refers to a lookup table of code words to modulation scheme type to determine a modulation scheme type and refers to a lookup table of code words. The modulation scheme may include one or more of amplitude shift keying (ASK), phase shift keying (PSK), amplitude modulation (AM), quadrature amplitude modulation (QAM), etc. When a modulation scheme is not desired, the modulation scheme code word may correspond to zero or may be omitted.

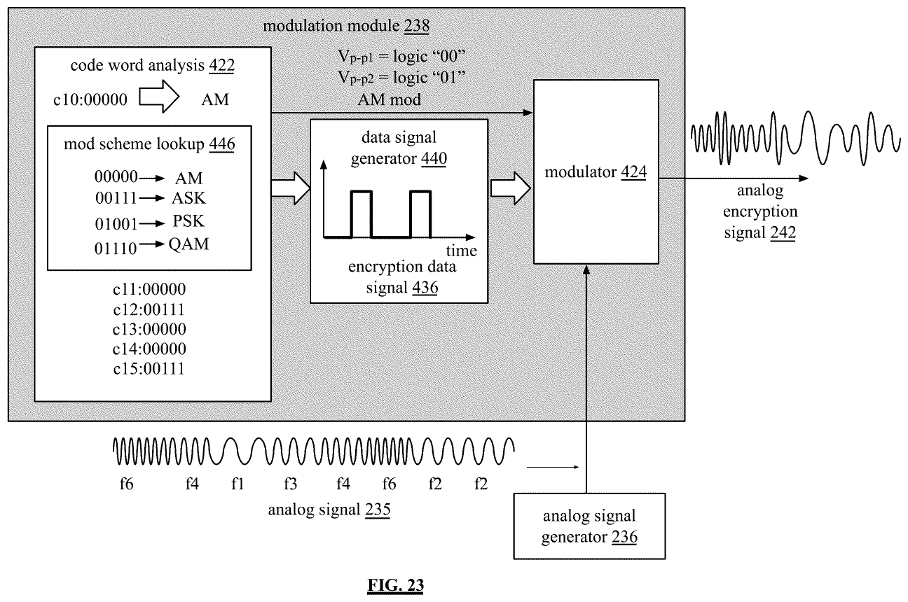

The modulation module 238 is operable to generate an encryption key data signal based on the encryption key data where the encryption key data is kept in its coded format for digital signal generation. The modulation module 238 modulates the encryption key data signal with the analog signal 235 in accordance with the modulation scheme to produce the analog encryption signal 242. The modulation module 238 will be discussed in more detail with reference to FIG. 23.

In FIG. 18B, the analog encryption signal generator 240 operates similarly to the analog encryption signal generator 240 of FIG. 18A except that a scrambler 244 is included after the encryption key generator 232. A scrambler may include a linear feedback shift register and may be additive or multiplicative. Scrambling is accomplished by the addition of components to the original data of the changing of components of the data. For example, the scrambler 244 may convert the encryption key 233 to a seemingly random output stream of the same length by pseudo-randomly selecting bits to invert. As another example, the scrambler 244 may add unpredictable, random bits to the input stream. The scrambling may be random or based on a reference such as a password.

In an example of operation, the encryption key generator 232 produces an encryption key 233. The scrambler 244 scrambles the encryption key 233 (e.g., by adding random bits) to produce a scrambled encryption key 239. The polynomial encoding module 412 would need be aware of the scrambling method such that the correct encoding polynomial can be extracted from the scrambled encryption key 239 and such that the right code words are generated. For example, the polynomial encoding module 412 knows to discard every 2 bits of data from the scrambled encryption key 239. In another embodiment, the scrambler 244 only scrambles the portion of the encryption key 233 unrelated to the encoding polynomial.

In FIG. 18C, the analog encryption signal generator 240 operates similarly to the analog encryption signal generator 240 of FIG. 18A except that it includes two encryption key generators 232-1 and 232-2 and two polynomial encoding modules 412-1 and 412-2. In this example, the encryption key generator 232-1 generates an encryption key 233-1 and provides it to the polynomial encoding module 412-1. The encryption key 233-1 indicates an encoding polynomial as well as modulation information and encryption key data. The encryption key generator 232-2 generates an encryption key 233-2 and provides it to the polynomial encoding module 412-2. The encryption key 233-2 indicates an encoding polynomial (a same or different encoding polynomial as the encryption key 233-2) as well as signal information 234. In another embodiment, one polynomial encoding module is operable to process both encryption key 233-1 and 233-2. In another embodiment, the modulation module 238 includes the polynomial encoding module 412-1 and the signal information module 234 includes the polynomial encoding module 412-2.

In FIG. 18D, the analog encryption signal generator 240 operates similarly to the analog encryption signal generator 240 of FIG. 18C except that the encryption key generator 232 generates the encryption key and then splits the encryption key 233 (e.g., into portions of the encryption key 233-p1 and 233-p2) among polynomial encoding modules 412-1 and 412-2. The portion of the encryption key 233-p1 indicates an encoding polynomial as well as modulation information and encryption key data. The portion of the encryption key 233-p2 indicates an encoding polynomial (e.g., the same encoding polynomial as the encryption key 233-p1) and signal information 234.

FIG. 19 is an example of an interpreted encryption key 233 (e.g., an encryption key that has been interpreted by the polynomial encoding module 412) that indicates an encoding polynomial, signal information, modulation information (a modulation scheme type), and encryption key data. In this example, the encoding polynomial is indicated by the first 9 bits of the encryption key 233 where the first 3 bits define n (the code length), the second 3 bits define m (the polynomial degree), and the third 3 bits define the coefficients of a generator polynomial g(x). For example, n is equal to 5, m is equal to 2, and g(x)=x²+x+1 (where 111 represents the coefficients of the generator polynomial). The next series of bits indicate a set of frequencies 1-8. The next 3 bits indicate a frequency hop time. The next three bits indicate a modulation type, and the last series of bits indicate the encryption key data d1-d5.

A different number of bits can be used to represent data and the data can be in any order. For example, the encoding polynomial information could be at the end of the encryption key or the encryption key data could be separated by the set of frequencies. Further, the encryption key could include other pertinent or non-pertinent information (where non-pertinent information can be ignored).

FIG. 20 is a schematic block diagram of an embodiment of a polynomial encoding module 412 of an analog encryption signal generator that includes a word extraction/interpretation module 420 and a data encoding module 422. The word extraction/interpretation module 420 is operable to interpret and extract words from an encryption key 233. For example, the word extraction/interpretation module 420 separates the encryption key 233 into 3-bit portions and associates those portions with subject matter. For example, the word extraction/interpretation module 420 includes a mapping that instructs the word extraction/interpretation module 420 to associate the first 9 bits with an encoding polynomial, etc. As shown here, the word extraction/interpretation module 420 has interpreted the encryption key to identify which bits are associated with n, m, g(x), hop time, frequencies f1-f8, modulation scheme type, and encryption key data to produce organized data 484.

The word extraction/interpretation module 420 interprets the bits corresponding to the encoding polynomial and generates the encoding polynomial 482. The word extraction/interpretation module 420 provides the encoding polynomial 482 and the organized data 484 to the data encoding module 422.

The data encoding module 422 uses the encoding polynomial 482 to transform the organized data 484 interpreted from the encryption key into a plurality of code words 414. An example of encoding with an encoding polynomial having g(x)=x²+x+1, n=5, and m=2 is shown. For example, bits 110 are encoded to form a code word of 11001. Many other encoding polynomials and/or encoding mechanisms are possible to encode encryption key data.

FIG. 21 is a schematic block diagram of an embodiment of a signal information module 234 that includes a code word analysis module 432 and a frequency code generator 434. The code word analysis module 432 includes a filtering technique such as a frequency (f) lookup table 442 and a time hop (T) lookup table 444 shown. The code word analysis module 432 obtains code words 414 that are specific to the signal information module 432 (e.g., code words c1-c9) from the polynomial encoding module or it is operable to extract the appropriate code words from the plurality of code words obtained from the polynomial encoding module.

The code word analysis module 432 uses the frequency (f) lookup table 442 and the time hop (T) lookup table to translate the code words into a frequency pattern 430. For example, the code word analysis module 432 looks up code words c1-c8 in the frequency (f) lookup table 442 and determines that these code words represent a frequency pattern of f6, f4, f1, f3, f4, f6, f2, and f2. The code word analysis module 432 looks up code word c9 in the time hop (T) lookup table 444 and determines that this code word represents a time hop of T2. Thus, the code word analysis module 432 generates a frequency pattern 430 of f6, f4, f1, f3, f4, f6, f2, and f2 with a time hop between each frequency of T2.

In another embodiment, a code word may represent a frequency and a time hop for that frequency. In another embodiment, the code word analysis module 432 uses a default or randomly generated time hop for the frequency pattern 430. In another embodiment, a single code word could represent multiple frequencies. In another embodiment, an additional code word could represent a frequency offset and another set of code words represent spacing from that offset as the set of frequencies. For example, if the offset is f1 and a frequency code word is “one,” the frequency identified is f1. In another example with the frequency offset of f1 and another code word is 3, the frequency identified is f3 which is offset by 3 times the frequency of f1.

The frequency code generator 434 takes the frequency pattern 430 from the code word analysis module 432 and generates a frequency code 416. For example, the frequency code generator 434 converts the frequency code to digital logic and generates a set of pulse signals using the digital logic. For example, for the six frequencies in the frequency pattern, the frequency code generator 434 assigns a digital logic value of −3 through +3 to the frequency values and outputs a corresponding pulse signal at time intervals of T2. As shown, a pulse at −3 (which represents frequency f6) is generated and sent for a time period of T2. After the first T2 time period, a pulse at +2 (which represents frequency f4) is sent for a time period of T2 and so on until the frequency pattern is sent to the analog signal generator 236.

FIG. 22 is a schematic block diagram of an embodiment of an analog signal generator 236 of an analog encryption signal generator. The analog signal generator 236 produces an analog signal 235 based on the frequency code 416 (e.g., a series of digital pulses) generated by the signal information module 432. As shown in a specific example, the analog signal 235 varies in frequency from f6, f4, f1, f3, f4, f6, f2, and f2 where frequency f6 is the highest frequency and the frequencies f1-f6 increase from f1 to f6.

FIG. 23 is a schematic block diagram of an embodiment of a modulation module 238 that includes a code word analysis module 422, a data signal generator 440, and a modulator 424. The code word analysis module 432 includes a filtering technique such as a modulation (mod) scheme lookup table 446. The code word analysis module 422 receives code words 414 that are specific to the modulation module 238 (e.g., code words c10-c15) or it is operable to extract the appropriate code words from the plurality of code words.

The code word analysis module 422 uses the modulation (mod) scheme lookup table 446 to translate the appropriate code word into a modulation scheme selection. For example, the code word analysis module 422 looks up code word c10 in the modulation (mod) scheme lookup table 446 and determines that code word c10 represents a modulation scheme of amplitude modulation (AM). In this example, the amplitude modulation scheme includes modulation of a signal between amplitudes Vp-p1 and Vp-p2 where Vp-p1 represents a digital logic value of “00” Vp-p1 represents a digital logic value of “01.” The code word analysis module 422 provides an indication to the modulator 424 that a modulation scheme of amplitude modulation will be used.

The code word analysis module 422 categorizes code words c11-c15 as encryption key data. The data signal generator 440 generates an encryption data signal 436 from the encryption key data and provides it to the modulator 424. In this example, each code word for each encryption key data value is a zero (00000) or one (00111) which is translated to a digital signal of zeros and ones (0, 1, 0, 0, 1). In another embodiment, each binary digit of a code word is translated to a digital value of the digital signal. The frequency of the encryption key data signal 436 may be default setting or indicated by an additional code word.

The modulator 424 is operable to modulate the encryption data signal 436 with the analog signal 235 in accordance with the modulation scheme to produce the analog encryption signal 242. In this example, the modulation scheme is amplitude modulation and the analog signal 235 includes frequency hopping. As such, the encryption key data is represented via amplitude changes on the frequency hopped analog signal 235 (e.g., where Vp-p1 represents a digital logic value of “00” Vp-p1 represents a digital logic value of “01”). To replicate this signal, an interceptor would not only need the correct encryption key but the knowledge of how the encryption key is broken into parts and how the code words map to different data in order to demodulate the encryption data signal and then remove the frequency hopping pattern.

FIG. 24 is a schematic block diagram of an embodiment of a portion of a Low Voltage Drive Circuit (LVDC) coupled to one or more lines of a bus 120. The portion of the LVDC includes a transmit digital to analog circuit 140, a drive-sense circuit (DSC) 28, a transmit encrypt module 152, a receive encrypt/decrypt module 150, and a receive analog to digital circuit 138. The transmit digital to analog circuit 140, the drive-sense circuit (DSC) 28, and the receive analog to digital circuit 138 of FIG. 24 operate similarly to the transmit digital to analog circuit 140, the drive-sense circuit (DSC) 28, and the receive analog to digital circuit 138 of FIG. 17. FIG. 24 depicts an example where the analog outbound data frequency is preserved, transmit data encryption is desired, and receive decryption is desired.

The transmit digital to analog circuit 140 provides the analog outbound data 142 having an oscillating component and a DC component to the transmit encrypt module 152. In the frequency domain, the sinusoidal analog outbound data 142 is a pure tone at the frequency of the oscillating component with a magnitude corresponding to the DC component. For example, the analog outbound data 142 has an oscillating component at a frequency f2 (e.g., a transmit frequency).

The transmit encrypt module 152 includes an adder 216, and an analog transmit (TX) encryption signal generator 222. The analog transmit encryption signal generator 222 produces a plurality of analog transmit (TX) encryption signals 228 having a plurality of frequencies that differ from the frequency f2. The analog transmit (TX) encryption signals 228 may have the same or different magnitude as the analog outbound data 142 or may have varying magnitudes. The analog transmit (TX) encryption signals 228 may have the same or different phase as the analog outbound data 142 or may have varying phases. The analog transmit encryption generator 222 operates differently than the analog transmit encryption generator of FIG. 13 in order to produce a plurality of signals and will be discussed in more detail with reference to FIGS. 27A-33.

The adder 216 adds the analog outbound data 142 (either magnitude adjusted or not) having the frequency f2 with the plurality of analog transmit (TX) signals 228 having the plurality of frequencies to produce encrypted analog outbound data 226 having frequency components at fe-n through fe−1, f2, and fe+1 through fe+n. As such, the frequency component f2 of the analog outbound data 142 is not changed but the analog outbound data 142 is obscured by the addition of other signals with varying frequencies, phases, and/or magnitudes.

When receiving a power signal (e.g., current signal itx), an analog receive signal (current signal irx) affects the power signal to produce a bus signal 94. The DSC 28 compares the bus signal 94 with the encrypted analog outbound data 226 to produce analog inbound data 244 that includes a representation of the analog receive signal.

In this example, the analog receive signal (and thus the analog inbound data 244) has been encrypted by a transmit encrypt module of another LVDC by adding a plurality of encryption signals at varying frequencies to analog outbound data having a frequency of f1. For example, the analog inbound data 244 includes a plurality frequency components at fe−n through fe−1, f1, and fe+1 through fe+n. The plurality of encryption signals generated by the transmit encrypt module of other LVDC may be the same or different plurality of encryption signals as the plurality of analog TX encryption signals 228.

The receive encrypt/decrypt module 150 includes an adder 218 and an analog transmit (RX) encryption signal generator 224. The analog receive encryption signal generator 224 produces a plurality of analog receive (RX) signals 230. The analog receive encryption signal generator 224 operates differently that the analog receive encryption signal generator of FIGS. 12 and 14 in order to produce a plurality of signals and will be discussed in more detail with reference to FIGS. 27A-33. The analog receive encryption signal generator 224 operates similarly to the transmit encryption signal generator of the other LVDC that produced the encrypted analog inbound data 118 in that it is operable to generate the same plurality of encryption signals that are required for decryption. The adder 216 subtracts the plurality of analog RX encryption signals from the analog inbound data 244 to produce the decrypted analog inbound data 156 having a frequency of f1.

While FIG. 24 depicts both the transmit encrypt module 152 and the receive encrypt/decrypt module 150, one or the other may be omitted or unused when operating similarly to the embodiments discussed with reference to FIGS. 12-14 (e.g., only transmit encryption is desired, only receive encryption is desired, etc.).

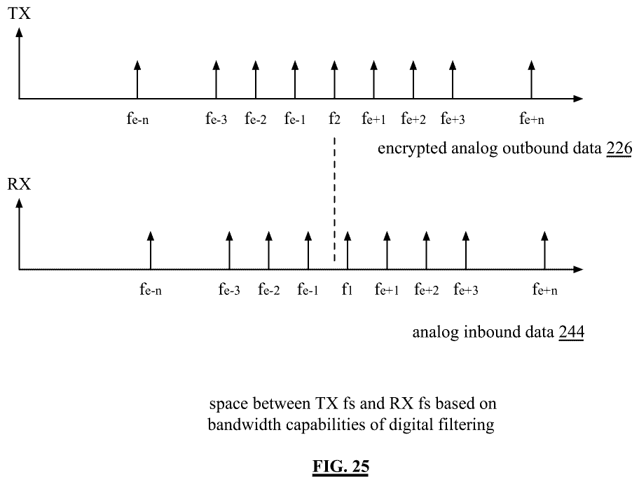

FIG. 25 is an example of encrypted analog outbound data 226 and encrypted analog inbound data 244 with reference to embodiment of FIG. 24 where the encrypted analog outbound data 226 includes frequency components at fe−n through fe−1, f2, and fe+1 through fe+n and the encrypted analog inbound data 244 includes frequency components at fe−n through fe−1, f1, and fe+1 through fe+n.

The transmit digital to analog circuits 140 of communicating low voltage drive circuits (LVDCs) provide analog outbound data with space between the frequencies of the signals depending on the bandwidth capabilities of LVDC's receive analog to digital circuit 138. As discussed with reference to FIG. 11, the LVDC's receive analog to digital circuit 138 filters the analog inbound data to extract the magnitude of the oscillating component that holds the data information (e.g. the voltage magnitude). In order to extract the data, the oscillating component frequencies must be spaced out to extract the desired frequencies with bandpass filtering.

In this example, the encrypted analog outbound data 226 includes the analog outbound data at frequency f2 and the encrypted analog inbound data 244 (e.g., the analog outbound data of another LVDC) includes the analog inbound data at frequency f1 where frequencies f1 and f2 are spaced out to account for the bandwidth capabilities of a corresponding LVDC's receive analog to digital circuit 138.

FIG. 26 is a schematic block diagram of an embodiment of a portion of a Low Voltage Drive Circuit (LVDC) coupled to one or more lines of a bus 120. The portion of the LVDC includes a transmit digital to analog circuit 140, a drive-sense circuit (DSC) 28, a receive encrypt/decrypt module 150, and a receive analog to digital circuit 138. The transmit digital to analog circuit 140, the drive-sense circuit (DSC) 28, the receive encrypt/decrypt module 150, and the receive analog to digital circuit 138 of FIG. 26 operate similarly to the transmit digital to analog circuit 140, the receive encrypt/decrypt module 150, the drive-sense circuit (DSC) 28, and the receive analog to digital circuit 138 of FIG. 24 except FIG. 26 depicts an example where the analog outbound data frequency is preserved, receive signal encryption is desired (e.g., the data is encrypted for storage), and transmit encryption is not desired. In this example, the transmit encrypt module is not included because analog transmit encryption is not desired.

The transmit digital to analog circuit 140 provides the analog outbound data 142 having an oscillating component and a DC component to the DSC 28. In the frequency domain, the sinusoidal analog outbound data 142 is a pure tone at the frequency of the oscillating component with a magnitude corresponding to the DC component. For example, the analog outbound data 142 has an oscillating component at a frequency f2 (e.g., a transmit frequency).

When receiving a power signal (e.g., current signal itx), the analog receive signal (current signal irx) affects the power signal to produce a bus signal 94. The DSC 28 compares the bus signal 94 with the analog outbound data 142 that includes direct current (DC) components and AC components to produce analog inbound data 118 that includes a representation of the analog receive signal.

The bus signal 94 includes a component of the power signal (e.g., the transmit signal shown as current itx) and a component of the analog receive signal (e.g., the received current signal current irx). The receive current signal is a sinusoidal signal that includes AC and DC components. In this example, the analog inbound data 118 has not been encrypted by another LVDC and has an oscillating component at a frequency f1 (e.g., a receive frequency).

The receive encrypt/decrypt module 150 includes an adder 218 and an analog receive (RX) encryption signal generator 224. The analog receive encryption signal generator 224 produces a plurality of analog receive (RX) encryption signals 230 at a variety of frequencies (e.g., fe−n through fe−1 and fe+1 through fe+n) that differ from the frequency f1. The plurality of analog receive (RX) encryption signals 230 may also include magnitudes and/or phases differing from the analog inbound data or varying magnitudes and/or phases.

The adder 216 adds the analog inbound data 232 with the plurality of analog receive (RX) signals 230 to produce encrypted analog inbound data 156 where the encrypted analog inbound data 156 includes frequency components fe−n through fe−1, f1, and fe+1 through fe+n. As such, the analog inbound data 156 at frequency f1 is not changed but is obscured by the addition of other signals at various frequencies, magnitudes, and/or phases. The analog receive encryption signal generator 224 is discussed in more detail with reference to FIGS. 27A-33.

The receive analog to digital circuit 138 converts the encrypted analog inbound data 156 into encrypted received digital data 164 as discussed with reference to FIG. 11. In another example, the receive analog to digital circuit 138 converts the encrypted analog inbound data 156 into encrypted digital inbound data and outputs the encrypted digital inbound data to the host device for encrypted data storage. As another example, the encrypted analog inbound data 156 is output to the host device for storage on a physical storage device.

FIGS. 27A-27B are schematic block diagrams of embodiments of an analog encryption signal generator 256. The analog encryption signal generator 256 of FIGS. 27A-27B operates similarly to the analog encryption signal generators 240 of FIGS. 18A-18B except that the encryption key 237 information is interpreted differently in order to generate multiple encryption signals. Another difference is that the analog encryption signal generator 256 of FIGS. 27A-27B requires the analog inbound or outbound data 260 as an input to the analog signal generator 245.

The encryption signal generator 256 may be the analog receive (RX) encryption signal generator or the analog transmit (TX) encryption signal generator of FIGS. 24 and 26 where the frequency of the analog inbound or outbound data requires preservation. In FIG. 27A, the analog encryption signal generator 256 includes an encryption key generator 246, a polynomial encoding module 452, a signal information module 448, a modulation module 252, and an analog signal generator 254. The signal information module 448 includes a signal count module 248 and a frequency offset module 250.

The encryption key generator 246 may be a Random Bit Generator (RBG), a pseudorandom number generator, etc., that uses algorithms designed to ensure each encryption key 237 is unpredictable and unique. An encryption key is typically a random string of bits that are stored in a file, which, when processed through a cryptographic algorithm, can encode or decode cryptographic data. The longer the encryption key, the harder it is to break the encryption code. Symmetric key encryption uses a single key for both encryption and decryption. Asymmetric, or public/private encryption uses a pair of keys. Data is encrypted with one key and decrypted with the other key.

In an example of operation, the encryption key generator 246 produces an encryption key 237. The whole encryption key may be sent to the polynomial encoding module 452 or it may be split among more than one polynomial encoding modules 452 (e.g., where one polynomial encoding module 452 is coupled to the modulation module 252 and one polynomial encoding module 452 is coupled to the signal information module 448).

The polynomial encoding module 452 is operable to interpret and extract words from the encryption key 237 to determine an encoding polynomial, signal information (e.g., a signal count and a frequency offset), modulation information (a modulation scheme type), and encryption key data. Because the encryption key 237 is randomly or pseudo randomly generated, the polynomial encoding module 452 assigns meaning to certain numbers of random or pseudo random bits. For example, polynomial encoding module 452 interprets every three bits of the encryption key 233 to contain a different piece of data.

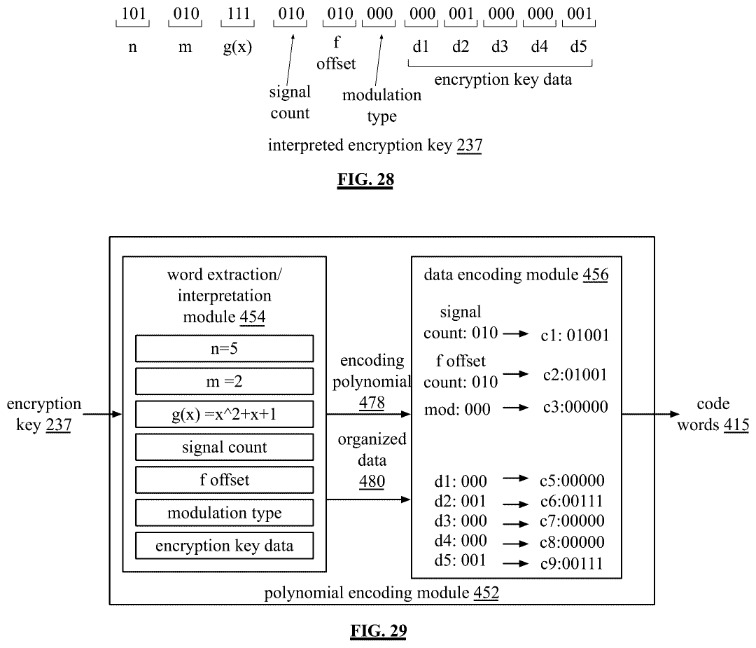

For example, the first three bits of the encryption key identify n (code length) of the encoding polynomial, the next three bits identify m (polynomial degree) of the encoding polynomial, the next three bits to identify the coefficients of a generator polynomial, the next three bits identify a signal count, the next three bits identify a frequency offset, the next three bits identify a modulation scheme type, and the next 15 bits identify encryption key data information. An example of an interpreted encryption key 237 is shown in FIG. 28.

A portion of the encryption key that may not be fully randomly generated is the portion related to the encoding polynomial. For example, m (the polynomial degree) must be less than or equal to n (the code length) and the generator polynomial must be a polynomial of degree m. Therefore, these portions may be generated randomly but in accordance with a formula.

The polynomial encoding module 452 generates the encoding polynomial using the encoding polynomial information interpreted from the encryption key 237 and encodes the remaining information interpreted from of the encryption key 237 with the encoding polynomial. The polynomial encoding module 452 interprets the encoded information to produce a plurality of code words 415. The polynomial encoding module 452 may be a standalone module as shown or each of the modulation module 252 and/or signal information module 448 may include a respective polynomial encoding module 452.

The plurality of code words 415 are inputs to the modulation module 252 and the signal information module 448 (e.g., a signal count module 248 and a frequency offset module 250 of the signal information module 448). The polynomial encoding module 452 sends code words 415 pertaining to the signal count to the signal count module 248 and code words pertaining to frequency offset to the frequency offset module 250. In another embodiment, the polynomial encoding module 452 sends the plurality of code words 415 to the signal count module 248 and the frequency offset module 250 and the signal count module 248 and frequency offset module 250 are operable to extract the code words pertaining to the signal count and frequency offset.

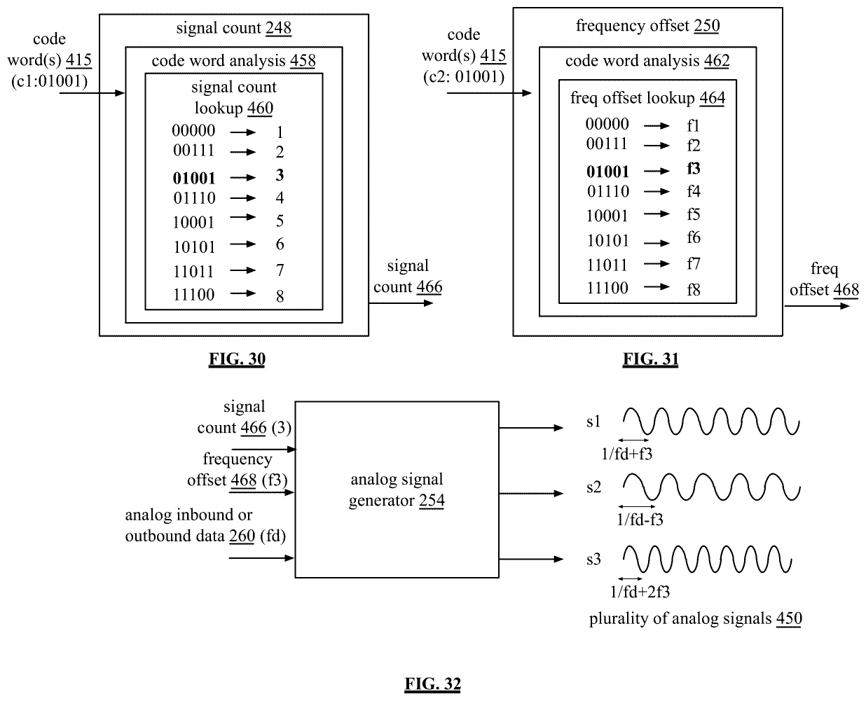

The polynomial encoding module 452 sends code words 415 pertaining to a modulation scheme and encryption key data to the modulation module 252. In another embodiment, the polynomial encoding module 452 sends the plurality of code words 415 to the modulation module 252 and the modulation module 252 is operable to extract the code words pertaining to the modulation scheme and encryption key data. The polynomial encoding module 452 will be discussed in more detail with reference to FIG. 29.

The signal count module 248 and frequency offset module 250 of the signal information module 448 are operable to interpret the codes words 415 to determine the signal count and the frequency offset. For example, the signal count module 248 and frequency offset module 250 use filtering techniques such as a lookup method to translate the code words to meaningful data. For example, the signal count module 248 refers to a lookup table of code words to signal counts to determine a signal count and the frequency offset module 250 refers to a lookup table of code words to frequency offsets to determine a frequency offset. As an example, a 5-bit code word may represent a particular signal count and another 5-bit code word may represent a particular frequency offset. In another example, the same code word could represent a signal count and frequency offset combination.

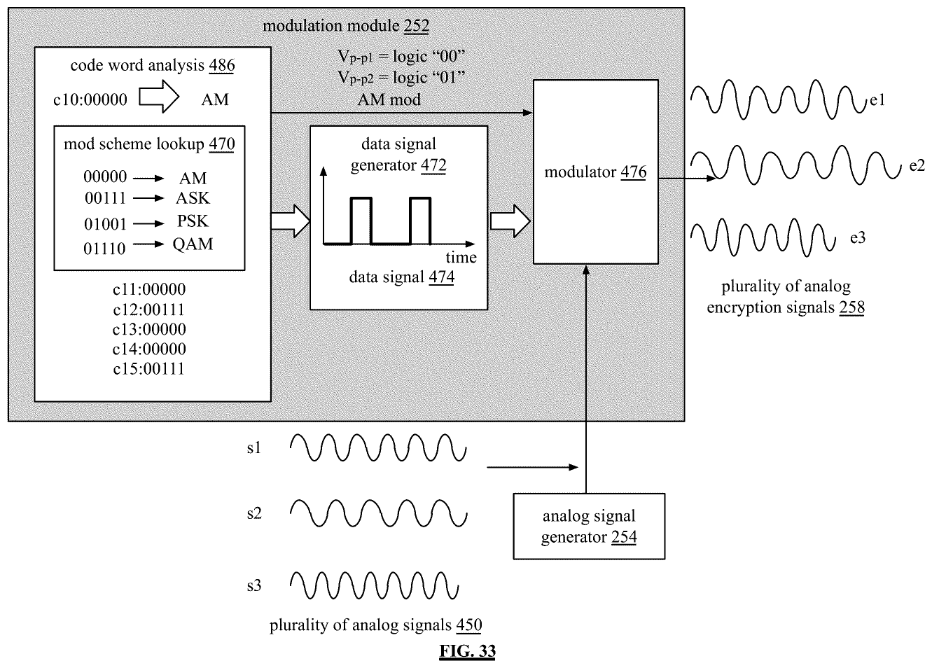

In another example, one or more of the signal count and the frequency offset are default settings set by the signal information module 448 or a processing module of the communication device of the which the analog encryption signal generator is a part of. The signal count and frequency offset are sent to the analog signal generator 254 as inputs for analog signal generation. The signal count module 248 and frequency offset module 250 of the signal information module 448 will be discussed in more detail with reference to FIGS. 30 and 31.

The analog signal generator 254 can be a phase-locked loop (PLL) a crystal oscillator, a digital frequency synthesizer, and/or any other signal source that can provide a sinusoidal signal of desired frequency, phase shift, and/or magnitude. Based on the signal count, the frequency offset, and the frequency of the analog inbound or outbound data 260, the analog signal generator 236 generates an a plurality of analog signals 450. For example, the analog signal generator 254 generates three analog signals with frequency offsets of a frequency f3 from the frequency of the analog inbound or outbound data 260.

The modulation module 252 is operable to interpret the codes words 415 to determine a modulation scheme and encryption key data. For example, the modulation module 238 uses filtering techniques such as a lookup method to translate the code words to meaningful data. For example, the modulation module 252 refers to a lookup table of code words to modulation scheme type to determine a modulation scheme type. The modulation scheme may include one or more of amplitude shift keying (ASK), phase shift keying (PSK), amplitude modulation (AM), quadrature amplitude modulation (QAM), etc. When a modulation scheme is not desired, the modulation scheme code word may correspond to zero or may be omitted.

The modulation module 252 is operable to generate an encryption key data signal based on the encryption key data where the encryption key data is kept in its coded format for digital signal generation. The modulation module 252 modulates the encryption key data signal with the plurality of analog signals 450 in accordance with the modulation scheme to produce the plurality of analog encryption signals 258. The modulation module 252 will be discussed in more detail with reference to FIG. 33.

In another embodiment, the analog encryption signal generator 256 includes two encryption key generators 246) and two polynomial encoding modules 452 similar to the example of FIG. 18C where the first polynomial encoding module is coupled to the modulation module 252 and the second polynomial encoding module is coupled to the signal information module 488. The first encryption key generator generates a first encryption key and provides it to the first polynomial encoding module. The first encryption key indicates an encoding polynomial as well as modulation information and encryption key data. The second encryption key generator generates a second encryption key and provides it to the second polynomial encoding module. The second encryption key indicates an encoding polynomial (e.g., a same or different encoding polynomial as the first encryption key) as well as signal information. In another embodiment, a signal polynomial encoding module coupled to the modulation module 252 and the signal information module 488 processes the first and second encryption keys.

In another embodiment, the analog encryption signal generator 256 includes the encryption key generator 246 and two polynomial encoding modules 452 similar to the example of FIG. 18D where a first polynomial encoding module is coupled to the modulation module 252 and the second polynomial encoding module is coupled to the signal information module 488. The encryption key generator 246 generates the encryption key and then splits the encryption key 237 into encryption key portions where a first portion is provided to a first polynomial encoding module and a second portion is provided to a second polynomial encoding module. The first portion of the encryption key indicates an encoding polynomial as well as modulation information and encryption key data. The second portion of the encryption key indicates an encoding polynomial (e.g., a same or different encoding polynomial as the first portion of the encryption key) and signal information.

In FIG. 27B, the analog encryption signal generator 256 operates similarly to the analog encryption signal generator 256 of FIG. 27A except that a scrambler 262 is included after the encryption key generator 246. A scrambler may include a linear feedback shift register and may be additive or multiplicative. Scrambling is accomplished by the addition of components to the original data of the changing of components of the data. For example, the scrambler 246 may convert the encryption key 237 to a seemingly random output stream of the same length by pseudo-randomly selecting bits to invert. As another example, the scrambler 262 may add unpredictable, random bits to the input stream. The scrambling may be random or based on a reference such as a password.

In an example of operation, the encryption key generator 246 produces an encryption key 237. The scrambler 262 scrambles the encryption key 237 (e.g., by adding random bits) to produce a scrambled encryption key 241. The polynomial encoding module 452 would need be aware of the scrambling method such that the correct encoding polynomial can be extracted from the scrambled encryption key 241 and such that the right code words are generated. For example, the polynomial encoding module 452 knows discard every 2 bits of data from the scrambled encryption key 241. In another embodiment, the scrambler 262 only scrambles the portion of the encryption key 237 unrelated to the encoding polynomial.

FIG. 28 is an example of an interpreted encryption key 237 (e.g., an encryption key that has been interpreted by the polynomial encoding module 452) that indicates an encoding polynomial, signal information (a signal count and a frequency offset), modulation information (a modulation scheme type), and encryption key data. In this example, the encoding polynomial is indicated by the first 9 bits of the encryption key 237 where the first 3 bits define n (the code length), the second 3 bits define m (the polynomial degree), and the third 3 bits define the generator polynomial g(x). For example, n is equal to 5, m is equal to 2, and g(x)=x²+x+1 (where 111 represents the coefficients of the generator polynomial). The next 3 bits indicate the signal count, the next 3 bits indicate the frequency offset, the next 3 bits indicate a modulation type, and the last series of bits indicate the encryption key data d1-d5.

A different number of bits can be used to represent data and the data can be in any order. For example, the encoding polynomial information could be at the end of the encryption key or the encryption key data could be separated by the signal information. Further, the encryption key could include other pertinent or non-pertinent information (where non-pertinent information can be ignored).

FIG. 29 is a schematic block diagram of an embodiment of a polynomial encoding module 452 of an analog encryption signal generator that includes a word extraction/interpretation module 454 and a data encoding module 456. The word extraction/interpretation module 454 is operable to interpret and extract words from an encryption key 237. For example, the word extraction/interpretation module 454 separates the encryption key 237 into 3-bit portions and associates those portions with subject matter. For example, the word extraction/interpretation module 454 includes a mapping that instructs the word extraction/interpretation module 454 to associate the first 9 bits with an encoding polynomial, etc. As shown here, the word extraction/interpretation module 454 has interpreted the encryption key to identify which bits are associated with n, m, g(x), signal count, frequency offset, modulation scheme type, and encryption key data to produce organized data 480.

The word extraction/interpretation module 454 interprets the bits corresponding to the encoding polynomial and generates the encoding polynomial 478. The word extraction/interpretation module 454 provides the encoding polynomial 478 and the organized data 480 to the data encoding module 456.

The data encoding module 456 uses the encoding polynomial 478 to transform the organized data 480 interpreted from the encryption key 237 into a plurality of code words 415. An example of encoding with an encoding polynomial having g(x)=x²+x+1, n=5, and m=2 is shown. For example, bits 010 (of the signal count) are encoded to form a code word of 01001. Many other encoding polynomials and/or encoding mechanisms are possible to encode encryption key data.

FIG. 30 is a schematic block diagram of an embodiment of a signal count module 248 of a signal information module that includes a code word analysis module 458. The code word analysis module 458 includes a filtering technique such as a signal count lookup table 460. The code word analysis module 458 obtains code words 415 from the polynomial encoding module that are specific to the signal count module 248 (e.g., code word c1) or it is operable to extract the appropriate code words from the plurality of code words or a plurality of code words associated with the signal information.

The code word analysis module 458 uses the signal count lookup table 460 to translate the code word 414 into a signal count 466. For example, the code word analysis module 458 looks up code word c1 in the signal count lookup table 460 and determines that this code word represents a signal count of 3. Thus, the code word analysis module 458 generates a signal count 466 of 3 (e.g., as a digital signal, a pulse, an indicator, etc.) for input to the analog signal generator. In another embodiment, the code word analysis module 458 uses a default or randomly generated signal count.

FIG. 31 is a schematic block diagram of an embodiment of a frequency offset module 250 of a signal information module that includes a code word analysis module 462. The code word analysis module 462 includes a filtering technique such as a frequency (f) offset lookup table 464. The code word analysis module 462 obtains code words 415 from the polynomial encoding module that are specific to the frequency offset module 250 (e.g., code word c2) or it is operable to extract the appropriate code words from the plurality of code words or from code words associated with the signal information.

The code word analysis module 462 uses the frequency (f) offset lookup table 464 to translate the code words into a frequency offset. For example, the code word analysis module 462 looks up code word c2 in the frequency (f) offset lookup table 464 and determines that this code word represents a frequency offset of f3. Thus, the code word analysis module 462 generates a frequency offset 468 of f3 (e.g., as a digital signal, a pulse, an indicator, etc.) for input to the analog signal generator.

In another embodiment, the signal count module 248 and the frequency offset module 250 may be combined and the code words may represent a signal count and frequency offset combination. In another embodiment, the code word analysis module 462 uses a default or randomly generated frequency offset.

FIG. 32 is a schematic block diagram of an embodiment of an analog signal generator 254 of an analog encryption signal generator. The analog signal generator 254 produces a plurality of analog signals 450 (signals s1, s2, and s3) based on the signal count 466 (e.g., 3), the frequency offset 468 (e.g., f3), and the analog inbound or outbound data 460. The analog signal generator 254 determines that the frequency of the analog inbound or outbound data 460 is a frequency fd. As shown in this specific example, the plurality of analog signals 450 include 3 signals (based on the signal count of 3) where the frequency offset f3 is from the analog inbound or outbound data 460 frequency of fd (e.g., a first signal s1 has a frequency of fd+f3, a second signal s2 has a frequency of fd−f3, and a third signal s3 has a frequency of fd+2f3).

FIG. 33 is a schematic block diagram of an embodiment of a modulation module 252 that includes a code word analysis module 486, a data signal generator 474, and a modulator 476. The code word analysis module 486 includes a filtering technique such as a modulation (mod) scheme lookup table 470. The code word analysis module 486 obtains code words 415 from the polynomial encoding module that are specific to the modulation module 252 (e.g., code words c10-c15) or it is operable to extract the appropriate code words from the plurality of code words.

The code word analysis module 486 uses the modulation (mod) scheme lookup table 470 to translate the appropriate code word into a modulation scheme selection. For example, the code word analysis module 486 looks up code words c10 in the modulation (mod) scheme lookup table 470 and determines that code word c10 represents a modulation scheme of amplitude modulation (AM). In this example, the amplitude modulation scheme includes modulation of a signal between amplitudes Vp-p1 and Vp-p2 where Vp-p1 represents a digital logic value of “00” Vp-p1 represents a digital logic value of “01.” The code word analysis module 486 provides an indication to the modulator 476 that a modulation scheme of amplitude modulation will be used.

The code word analysis module 486 categorizes code words c11-c15 as encryption key data. The data signal generator 474 generates an encryption data signal 474 from the encryption key data and provides it to the modulator 476. In this example, each code word for each encryption key data value is a zero (00000) or one (00111) which is translated to a digital signal of zeros and ones (0, 1, 0, 0, 1). In another embodiment, each binary digit of a code word is translated to a digital value of the digital signal. The frequency of the encryption key data signal 474 may be default setting or indicated by an additional code word.

The modulator 476 is operable to modulate the encryption data signal 474 with the plurality of analog signals 258 in accordance with the modulation scheme to produce the plurality of analog encryption signals 258. In this example, the modulation scheme is amplitude modulation and the plurality of analog signals 450 each vary in frequency as determined by the frequency offset. As such, the encryption key data is represented via amplitude changes on each of the analog signals s1-s3 (e.g., where Vp-p1 represents a digital logic value of “00” Vp-p1 represents a digital logic value of “01”) to produce analog encryption signals e1-e3. To replicate these signals, an interceptor would not only need the correct encryption key but the knowledge of how the encryption key is broken into parts and how the code words map to different data in order to demodulate the encryption data signals.

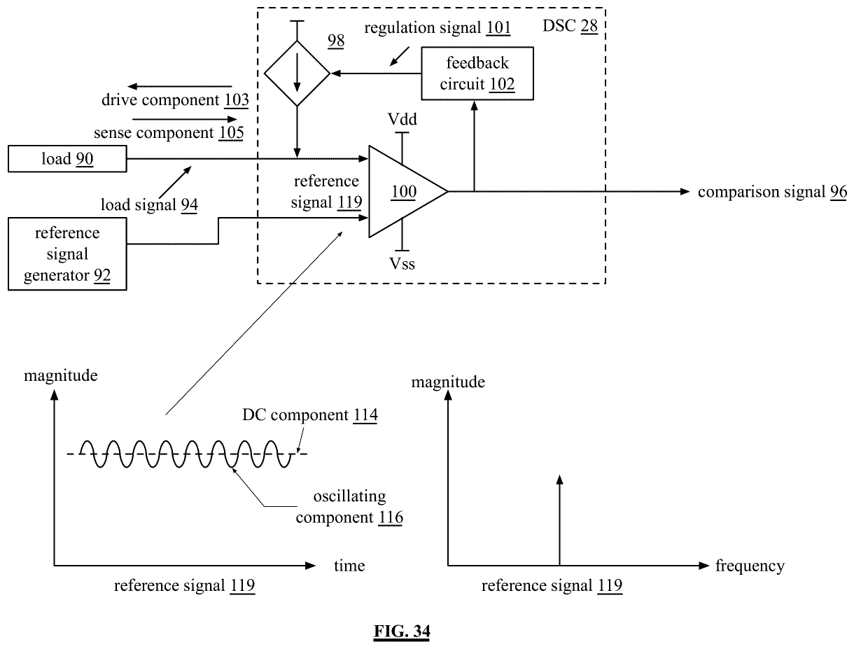

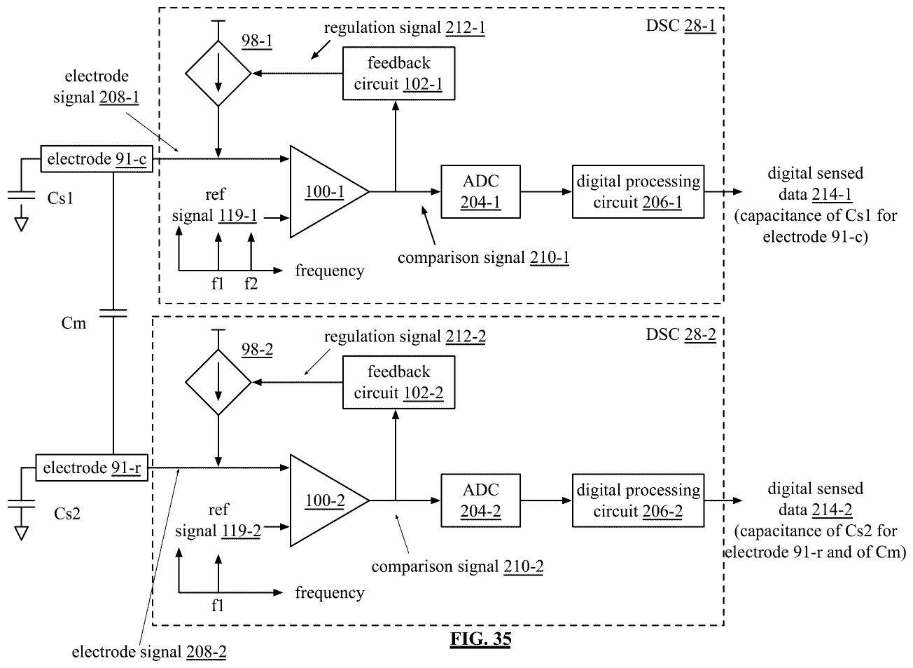

FIG. 34 is a schematic block diagram of an embodiment of a drive-sense circuit (DSC) 28 that includes an operational amplifier (op-amp) 100, a feedback circuit 102, and a power source circuit 98. The DSC is coupled to a load 90 and a reference signal generator 92. The DSC 28 of FIG. 34 operates similarly to the DSC 28 of a low voltage drive circuit (LVDC) of FIG. 5B except that the DSC 28 of FIG. 34 is operating to drive and sense a load 90 (e.g., sample a load 90) such as a sensor. For example, the DSC 28 is a DSC 28 of the communication device 12 of FIG. 2 or 3.

The power source circuit 98 may be a voltage supply circuit (e.g., a battery, a linear regulator, an unregulated DC-to-DC converter, etc.) to produce a voltage-based power signal or a current supply circuit (e.g., a current source circuit, a current mirror circuit, etc.) to produce a current-based power signal. As another example, the power source circuit is a bidirectional current supply circuit. The power source circuit 98 generates a power signal to include a DC (direct current) component and an oscillating component.

The feedback circuit 102 may be a wire, a resistor, and/or a regulation circuit that creates a regulation signal to substantially remove any effects on the power signal, etc. The regulation of the power signal may be done by regulating the magnitude of the DC and/or AC components, by adjusting the frequency of AC component, and/or by adjusting the phase of the AC component.

The reference signal generator (gen) 92 can be a phase-locked loop (PLL) a crystal oscillator, a digital frequency synthesizer, and/or any other signal source that can provide a sinusoidal signal of desired frequency, phase shift, and/or magnitude. The reference signal generator 92 produces a reference signal 119 having an oscillating component 116 and a direct current (DC) component 114. The oscillating component 116 includes a sinusoidal signal, a square wave signal, a triangular wave signal, a multiple level signal (e.g., has varying magnitude over time with respect to the DC component), and/or a polygonal signal (e.g., has a symmetrical or asymmetrical polygonal shape with respect to the DC component). In the frequency domain, the sinusoidal reference signal 119 is a pure tone at the frequency of the oscillating component 116 with a magnitude corresponding to the DC component 114.

In an example of operation, the op-amp 100 compares a load signal 94 having a drive component 103 and a sense component 103 to a reference signal 119 that includes DC and AC components to produce a comparison signal 96. Because the reference signal 119 includes a DC component and an oscillating component, the load signal 94 will have a substantially matching DC component and oscillating component. The feedback circuit 102 feeds the comparison signal 96 to the power source circuit 98 (or regulates the comparison signal to produce a regulation signal 101 and feeds the regulation signal to the power source circuit 98). The comparison signal 96 includes a representation of the sensed signal component 105 of the load signal 94.

The power source circuit 98 generates a regulated source signal based on the comparison signal 96 and/or regulation signal 101 as the drive signal component 103 of the load signal 94. The power source circuit 98 adjusts the load signal 94 based on the comparison signal 96. As such, the op-amp 100 functions to keep the load signal 94 substantially constant (e.g., substantially matching the reference signal 119) by creating the comparison signal 96 to correspond to changes in a sense signal component 105 of the load signal 94. The power source circuit 98 and the feedback circuit 102 function to generate the drive signal component 103 of the load signal 94 based on the comparison signal 96 to substantially compensate for changes in the sense signal component 105 such that the load signal 94 remains substantially constant and the voltage at each input to the op-amp 100 remains substantially equal.

In an example where the load 90 is an electrode, the drive signal component 103 is provided to the electrode 90 as a regulated current signal. The regulated current (I) signal in combination with the impedance (Z) of the electrode creates an electrode voltage (V), where V=I*Z. As the impedance (Z) of electrode changes, the regulated current (I) signal is adjusted to keep the electrode voltage (V) substantially unchanged. To regulate the current signal, the op-amp 100 outputs a comparison signal 96 based on the receive signal component 105, which is indicative of the impedance of the electrode and change thereof. The power source circuit 98 adjusts the regulated current based on the changes to the comparison signal 96.

As another example, the drive signal component 103 is provided to the electrode 90 as a regulated voltage signal. The regulated voltage (V) signal in combination with the impedance (Z) of the electrode creates an electrode current (I), where I=V/Z. As the impedance (Z) of electrode changes, the regulated voltage (V) signal is adjusted to keep the electrode current (I) substantially unchanged. To regulate the voltage signal, the op-amp 100 outputs the comparison signal 96 based on the receive signal component 105, which is indicative of the impedance of the electrode and change thereof. The power source circuit 98 adjusts the regulated voltage based on the changes to the comparison signal 96.

In another embodiment, the drive-sense circuit 28 may include an analog to digital converter coupled to the output of the op-amp that converts the comparison signal 96 to a digital sensed signal. The digital sensed signal is fed to a digital to analog converter coupled to (or part of) the feedback circuit 102 where the digital to analog converter converts the digital sensed signal to an analog regulation signal 101. The drive-sense circuit 28 may further include a driver coupled to the load to increase power of the regulated source signal to produce the drive signal component 105.

FIG. 35 is a schematic block diagram of an example of two drive-sense circuits (DSC) 28-1 and 28-2 coupled to two electrodes. A first drive-sense circuit 28-1 includes an operational amplifier (op-amp) 100-1, an analog to digital converter (ADC) 204-1, a feedback circuit 102-1, a power source circuit 98-1, and a digital processing circuit 206-1. A second drive-sense circuit 28-2 includes an operational amplifier (op-amp) 100-2, an analog to digital converter (ADC) 204-2, a feedback circuit 102-2, a power source circuit 98-2, and a digital processing circuit 206-2. The first drive-sense circuit 28-1 is coupled to a column electrode 91-c and the second drive-sense circuit 28-2 is coupled to a row electrode 91-r.

A reference signal provided to the op-amp 100-1 of the first drive-sense circuit 28-1 includes an oscillating component at a first frequency f1 and an oscillating component at a second frequency f2. The reference signal provided to the op-amp 100-2 of the second drive-sense circuit 28-2 includes an oscillating component at the first frequency f1. The first frequency f1 is used to measure the self capacitance of each electrode and the second frequency f2 is used to measure the mutual capacitance between the electrodes.

The power source circuits 98-1 and 98-2 generate a power signal to include a DC (direct current) component and an oscillating component. When receiving the power signals and when exposed to a condition, electrical characteristics of the electrodes 91-c and 91-r affect the power signals. The op-amps 100-1 and 100-2 each compare their respective power signal, which are affected by the electrodes (electrode signals 101-1 and 101-2), with respective reference signals (ref signal 118-1 and 118-2) to produce comparison signals 210-1 and 210-2. The feedback circuits 102-1 and 102-2 feed the comparison signals 210-1 and 210-2 to the respective power source circuits 98-1 and 98-2 (or regulate the comparison signals to produce a regulation signal 212-1 and 212-2 and feed the regulation signals to the power source circuits 98-1 and 98-2).

The power source circuits 98-1 and 98-2 are operable to adjust the respective power signals based on the regulation signals to remove the effects of the condition on the power signals. The ADCs 204-1 and 204-2 convert the comparison signals 210-1 and 210-2 to digital signals and provide them to a respective digital processing circuit 206-1 and 206-2. The digital processing circuits 206-1 and 206-2 filter and process the digital comparison signals to produce digital sensed data 214-1 and 214-2. The digital sensed data 214-1 and 214-2 may include raw data (e.g., impedance amounts) and/or processed data (e.g., touch, no touch, hover).

In this example, the digital processing circuit 206-1 of the first drive-sense circuit 28-1 filters the digital comparison signal 210-1 to extract a pure tone value at the first frequency that is representative of a self capacitance measurement of the column electrode 91-c. The digital sensed data 214-1 produced by the first drive-sense circuit 28-1 includes a self capacitance value of Cs1 for the column electrode 91-c.

The digital processing circuit 206-2 of the second drive-sense circuit 28-2 filters the digital comparison signal to extract pure tone values at the first and second frequencies that are representative of a self capacitance measurement of the row electrode 91-r and a mutual capacitance between the row and column electrodes. The digital sensed data 214-2 produced by the second drive-sense circuit includes a self capacitance value of Cs2 for the row electrode 91-c and a mutual capacitance value of Cm between the row and column electrode. Because the first drive-sense circuit 28-1 transmits a power signal with f1 and f2 frequency components, the second drive-sense circuit 28-2 is operable to measure the mutual capacitance via the f2 component.

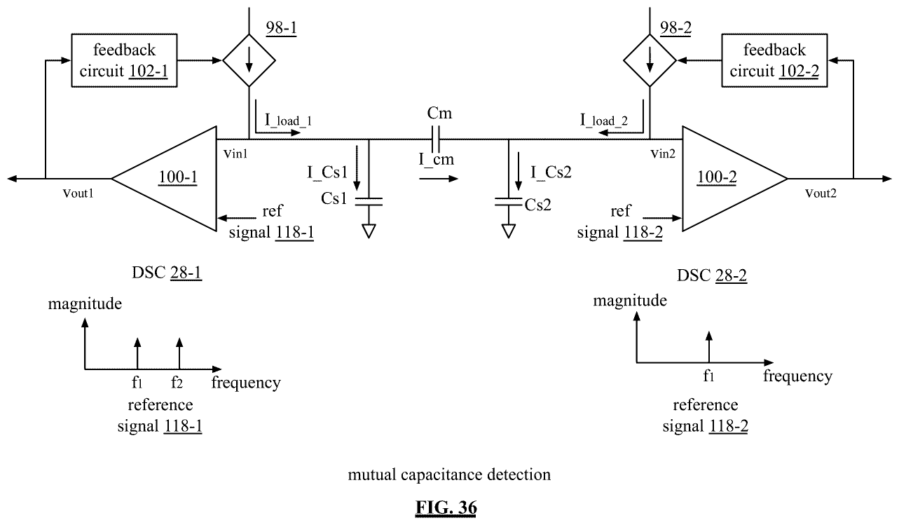

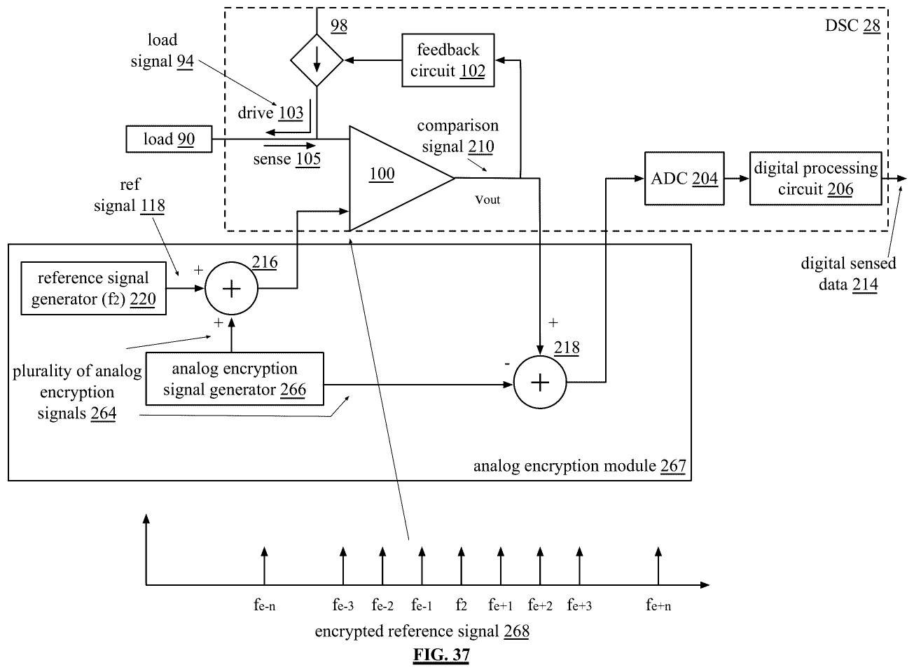

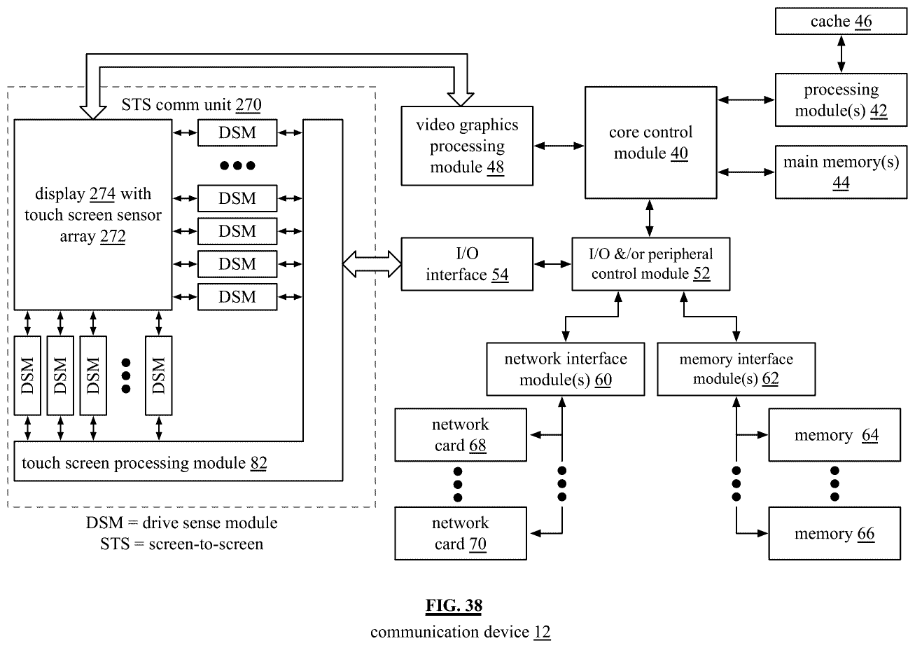

FIG. 36 is a schematic block diagram of an example of operation of two drive-sense circuits (DSCs) 28-1 and 28-2 and depicts an example of mutual capacitance detection. Referring to the example of FIG. 35, a first drive-sense circuit 28-1 is coupled to a column electrode (e.g., load_1) and the second drive-sense circuit 28-2 is coupled to a row electrode (e.g., load 2). A reference (ref) signal 118-1 provided to the op-amp 100-1 of the first drive-sense circuit 28-1 includes an oscillating component at a first frequency f1 and a second frequency f2. The reference (ref) signal 118-2 provided to the op-amp 100-2 of the second drive-sense circuit 28-3 includes an oscillating component at the first frequency f1. The first frequency f1 is used to measure the self capacitance of each electrode and the second frequency f2 is used to measure the mutual capacitance between the electrodes.

The current of the column electrode (I_load_1) is equal to the current of self capacitance of the column electrode (I_Cs1) and the current of mutual capacitance between the electrodes (I_cm). Due to the reference signal including oscillating components at a first frequency f1 and a second frequency f2, each current can be represented as a combination of the current at each of these frequencies (e.g., I_load_1=I_load_1@f1+I_load_1@f2).

The impedance of the column electrode is equal to the impedance of the self capacitance of the column electrode in parallel with a series combination of the impedance of mutual capacitance and the impedance of self capacitance of the row electrode. Because mutual capacitance is much lower than self capacitance (e.g., self capacitance is more than 10 times greater than mutual capacitance), the impedance of the mutual capacitance is much higher than the self capacitance impedances. Therefore, the impedance of the self capacitance of the column electrode is much less than the series combination of the impedance of mutual capacitance and the impedance of self capacitance of the row electrode. Therefore, most of I_load_1 flows through Cs1. However, there is some bleed over of I_load_1 through Cm (e.g., I_cm) allowing it to be measured.

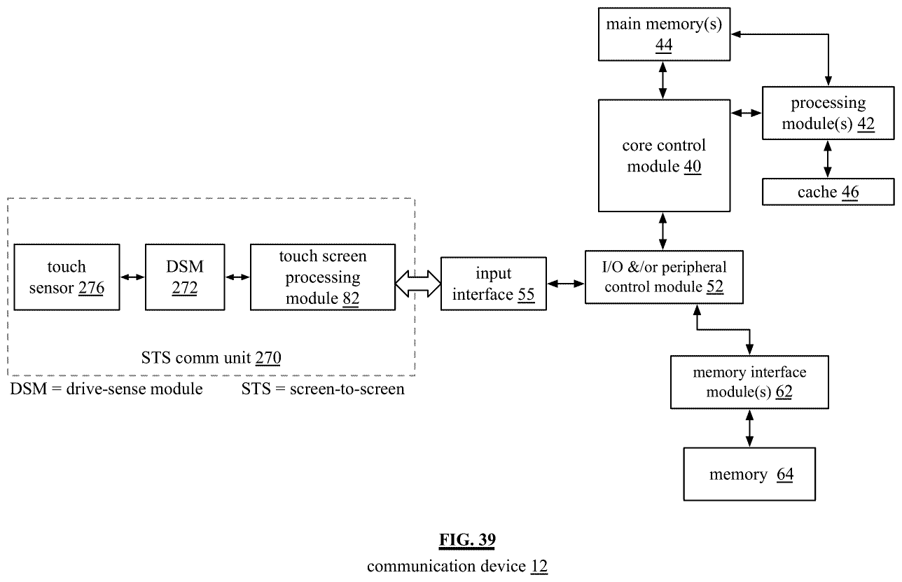

FIG. 37 is a schematic block diagram of an embodiment of a drive-sense circuit (DSC) 28 coupled to a load 90 and an analog encryption module 267. The load 90 may be a sensor such as an electrode. The drive-sense circuit (DSC) 28 operates similarly to the DSCs of FIG. 35 and includes an operational amplifier (op-amp) 100, a feedback circuit 102, a power source circuit 98, an analog to digital converter (ADC) 204, and a digital processing circuit. The analog encryption module 267 includes a reference signal generator 220, an analog encryption signal generator 266, and adders 216 and 218. In another embodiment, the reference signal generator 220 is separate from the analog encryption module 267.

FIG. 37 depicts an example of load sampling where reference signal encryption is desired. With load sampling, the frequency of the reference signal must be preserved. For example, an analog reference signal used for driving an electrode includes a DC component, a first oscillating component at a first frequency, and a second oscillating component at a second frequency. In an example, the DC component is used to measure resistance of an electrode (if desired), the first oscillating component is used to measure the impedance of self-capacitance, and the second oscillating component is used to measure the impedance of mutual-capacitance. Because the frequency components correspond to impedance measurements, the frequency of the analog reference signal must be preserved during encryption.

Within the analog encryption module 267, the reference signal generator 220 can be a phase-locked loop (PLL) a crystal oscillator, a digital frequency synthesizer, and/or any other signal source that can provide a sinusoidal signal of desired frequency, phase shift, and/or magnitude. The reference signal generator 220 produces a reference signal 118 having an oscillating component and a direct current (DC) component. For example, the reference signal 118 has a frequency component f2.

The analog encryption signal generator 266 operates similarly to the analog encryption signal generators of FIGS. 27A-33 to produce a plurality of analog encryption signals 264 having varying frequencies that differ from the reference signal frequency. The plurality of analog encryption signals 264 may also have differing magnitudes and phases from the analog reference signal 118. The adder 216 adds the reference signal 118 with the plurality of analog encryption signals 264 to produce an encrypted reference signal 268 having a plurality of frequency components (e.g., frequencies fe−n through fe−1, f2, and fe+1 through fe+n). As such, the analog reference signal's frequency at frequency f2 is not changed but is obscured by the addition of other signals at differing frequencies. In another embodiment, the analog reference signal's frequency f2 is not changed but is obscured by the addition of other signals having different magnitudes and/or phases as well as frequencies.

When receiving a power signal (e.g., drive signal 103), a sense signal 105 affects a power signal of the DSC 28 to produce a load signal 94. The op-amp 100 of the DSC 28 compares the power signal, which is affected by the load signal 94, with the encrypted reference signal 268 to produce a comparison signal 210 that includes a representation of the sense signal 105.

If the encrypted reference signal has a magnitude adjustment (e.g., adding the analog encryption signals to the analog reference signal has adjusted the analog reference signal's magnitude), the adder 218 of the analog encryption module 267 subtracts the plurality of analog encryption signals 264 from the comparison signal 210 to account for the magnitude change on the comparison signal 210 and reveal the original magnitude. When the encrypted reference signal does not include a magnitude adjustment, the adder 218 of the analog encryption module 267 can be omitted.

The analog to digital converter (ADC) 204 converts the comparison signal 210 to a digital comparison signal. The digital processing circuit 206 filters the digital comparison signal to extract a pure tone value at a sensed data frequency and processes that data to produce digital sensed data 214. The digital processing circuit 206 may instead be separated into a digital filtering circuit that filters the digital comparison signal and a processing circuit that processes the filtered data to determine a condition (e.g., a touch).

FIG. 38 is a schematic block diagram of another embodiment of a communication device 12. The communication device 12 includes a screen-to-screen (STS) communication unit 270, a core control module 40, one or more processing modules 42, one or more main memories 44, cache memory 46, a video graphics processing module 48, an input/output (I/O) peripheral control module 52, one or more input/output (I/O) interfaces 54, one or more network interface modules 60, one or more network cards 68-70, one or more memory interface modules 62 and one or more memories 64-66. The communication device of FIG. 38 operates similarly to the communication device of FIG. 3 except instead of the touch screen with sensors & drive-sense circuits, the communication device 12 includes the STS communication unit 270.

The STS communication (comm) unit 270 includes a display 274 with a touch screen sensor array 272, a plurality of drive-sense modules (DSM), and a touch screen processing module 82. In general, the sensors (e.g., electrodes, capacitor sensing cells, capacitor sensors, inductive sensors, etc.) of the touch screen sensor array 272 detect a proximal touch of the screen. For example, when one or more fingers touches (e.g., direct contact or very close (e.g., a few millimeters to a centimeter)) the screen, capacitance of sensors proximal to the touch(es) are affected (e.g., impedance changes). The drive-sense modules (DSM) coupled to the affected sensors detect the change and provide a representation of the change to the touch screen processing module 82, which may be a separate processing module or integrated into the processing module 42.

The touch screen processing module 82 processes the representative signals from the drive-sense modules (DSM) to determine the location of the touch(es). This information is inputted to the processing module 42 for processing as an input. For example, a touch represents a selection of a button on screen, a scroll function, a zoom in-out function, an unlock function, a signature function, etc. In an example, a DSM includes a drive-sense circuit (DSC) and a signal source. In a further example, one signal source is utilized for more than one DSM. The DSM allows for communication with a better signal to noise ratio (SNR) (e.g., >100 dB) due at least in part to the low voltage required to drive the DSM. The drive-sense module is discussed in greater detail with reference to one or more subsequent figures.

The processing module 42 communicates with a video graphics processing module 48 to display data on the display 274. The display 274 includes an LED (light emitting diode) display, an LCD (liquid crystal display), and/or other type of display technology. The display 274 has a resolution, an aspect ratio, and other features that affect the quality of the display. The video graphics processing module 48 receives data from the processing module 42, processes the data to produce rendered data in accordance with the characteristics of the display, and provides the rendered data to the display 274.

While a display 274 is shown integrated with a touch screen sensor array 272, the display 274 could be a mini display separate from the touch screen sensor array 272. Further, the STS communication unit 270 may include tactile functionality (e.g., a tactile portion of the display 274 includes a plurality of actuators (e.g., piezoelectric transducers to create vibrations, solenoids to create movement, etc.)). In another example, the STS communication unit 270 may include a display 274 with a touch screen sensor array 272 and another separate touch screen with sensor array (or coupled to the touch screen processing module 82 (e.g., the d display 274 with a touch screen sensor array 272 is located on a front of the communication device and the separate touch screen with sensor array is located on a back of the communication device).

In another example, the STS communication unit 270 could include a display 274 with touch screen sensor array 272 and touch sensor. The touch sensor may be a single electrode, a capacitive sensor, etc. In a specific example, the communication device is a cell phone with a display on the front and the touch sensor on the side.

FIG. 39 is a schematic block diagram of another embodiment of a communication device 12 that includes a screen-to-screen (STS) communication unit 270, a core control module 40, one or more processing modules 42, one or more main memories 44, cache memory 46, one or more input/output (I/O) peripheral control modules 52, an input interface 55, one or more memory interface modules 62, and a memory 64. The STS communication unit 270 includes a touch screen processing module 82, a drive-sense module 272 (e.g., the drive-sense module (DSM) of FIG. 26), and a touch sensor 276. In an example, the touch sensor 276 is a single electrode. In another example, the touch sensor is a capacitive sensor.

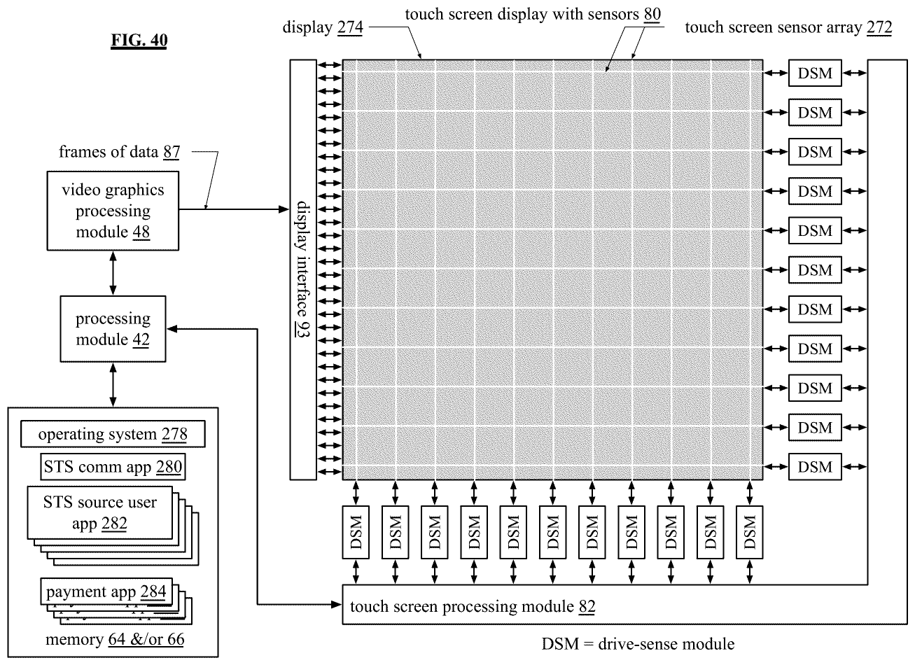

FIG. 40 is a schematic block diagram of an embodiment of a touch screen display with sensors 80 that includes a plurality of drive-sense modules (DSM), a touch screen processing module 82, a display 274, and a touch screen sensor array 272. The touch screen display with sensors 80 is coupled to a processing module 42, a video graphics processing module 48, and memory 64 and/or 66, which are components of a communication device (e.g., communication device 12 of FIG. 38), an interactive display, or other device that includes a touch screen display. An interactive display functions to provide users with an interactive experience (e.g., touch the screen to obtain information, to input information, to be entertained, to complete a transaction, etc.). For example, a store provides interactive displays for customers to order products, to find certain products, to obtain coupons, to enter contests, to sign up for store rewards, to learn information associated with a product, and many other functions.

There are a variety of other devices that include a touch screen display. For example, a vending machine includes a touch screen display to select and/or pay for an item. As another example of a device having a touch screen display is an Automated Teller Machine (ATM). As yet another example, an automobile includes a touch screen display for entertainment media control, navigation, climate control, vehicle information (e.g., tire air pressure, gas levels, etc.), etc. As a still further example, a smart device (e.g., light switch, home security control hub, thermostat, etc.) within a home includes a touch screen.

In an example, the touch screen display with sensors 80 includes a large display 274 that has a resolution equal to or greater than full high-definition (HD), an aspect ratio of a set of aspect ratios, and a screen size equal to or greater than thirty-two inches. The following table lists various combinations of resolution, aspect ratio, and screen size for the display 274, but it is not an exhaustive list.

| | Width | Height | pixel aspect | screen | |
|---|---|---|---|---|---|
| Resolution | (lines) | (lines) | ratio | aspect ratio | screen size (inches) |
| HD (high | 1280 | 720 | 1:1 | 16:9 | 32, 40, 43, 50, 55, 60, 65, |
| definition) | | | | | 70, 75, &/or >80 |
| Full HD | 1920 | 1080 | 1:1 | 16:9 | 32, 40, 43, 50, 55, 60, 65, |
| | | | | | 70, 75, &/or >80 |
| HD | 960 | 720 | 4:3 | 16:9 | 32, 40, 43, 50, 55, 60, 65, |
| | | | | | 70, 75, &/or >80 |
| HD | 1440 | 1080 | 4:3 | 16:9 | 32, 40, 43, 50, 55, 60, 65, |
| | | | | | 70, 75, &/or >80 |
| HD | 1280 | 1080 | 3:2 | 16:9 | 32, 40, 43, 50, 55, 60, 65, |
| | | | | | 70, 75, &/or >80 |
| QHD (quad | 2560 | 1440 | 1:1 | 16:9 | 32, 40, 43, 50, 55, 60, 65, |
| HD) | | | | | 70, 75, &/or >80 |
| UHD (Ultra | 3840 | 2160 | 1:1 | 16:9 | 32, 40, 43, 50, 55, 60, 65, |
| HD) or 4K | | | | | 70, 75, &/or >80 |
| 8K | 7680 | 4320 | 1:1 | 16:9 | 32, 40, 43, 50, 55, 60, 65, |
| | | | | | 70, 75, &/or >80 |
| HD and | 1280->=7680 | 720->=4320 | 1:1, 2:3, etc. | 2:3 | 50, 55, 60, 65, 70, 75, |
| above | | | | | &/or >80 |

The display 274 is one of a variety of types of displays that is operable to render frames of data into visible images. For example, the display is one or more of: a light emitting diode (LED) display, an electroluminescent display (ELD), a plasma display panel (PDP), a liquid crystal display (LCD), an LCD high performance addressing (HPA) display, an LCD thin film transistor (TFT) display, an organic light emitting diode (OLED) display, a digital light processing (DLP) display, a surface conductive electron emitter (SED) display, a field emission display (FED), a laser TV display, a carbon nanotubes display, a quantum dot display, an interferometric modulator display (IMOD), and a digital microshutter display (DMS). The display is active in a full display mode or a multiplexed display mode (i.e., only part of the display is active at a time).

The display 274 further includes touch screen sensor array 272 that provide the sensors for the touch sense part of the touch screen display. The sensor array 272 is distributed throughout the display area or where touch screen functionality is desired. For example, a first group of sensors of the sensor array 272 are arranged in rows and a second group of sensors of the sensor array 272 are arranged in columns. Note the row sensors may be separated from the column sensors by a dielectric material.

The sensor array 272 is comprised of a transparent conductive material and are in-cell or on-cell with respect to layers of the display. For example, a conductive trace is placed in-cell or on-cell of a layer of the touch screen display. The transparent conductive material, which is substantially transparent and has negligible effect on video quality of the display with respect to the human eye. For instance, a sensor of the sensor array 272 is an electrode and is constructed from one or more of: Indium Tin Oxide, Graphene, Carbon Nanotubes, Thin Metal Films, Silver Nanowires Hybrid Materials, Aluminum-doped Zinc Oxide (AZO), Amorphous Indium-Zinc Oxide, Gallium-doped Zinc Oxide (GZO), and poly polystyrene sulfonate (PEDOT).

In an example, the sensors are electrodes. As such, the rows of electrodes intersecting with the column of electrodes form a capacitive grid. For each intersection of a row and column electrode, a mutual capacitance (Cm) exists. In addition, each electrode (row and column) has a self-capacitance (Cs) with respect to a ground reference of the touch screen. As such, the touch screen sensor array includes a plurality of mutual capacitances (Cm) and a plurality of self-capacitances (Cs), where the number of mutual capacitances equals the number of rows multiplied by the number of columns and the number self-capacitances equals the number of rows plus the number of columns.

In general, changes to the self and/or mutual capacitances result from changes in the dielectric properties of the capacitances. For example, when a human touches the touch screen, self capacitance increases and mutual capacitance decreases due the dielectric properties of the person and the coupling of the person to the ground reference of the communication device. In another example, when an object is placed on the touch screen without a connection to ground, the mutual capacitances will increase or decrease depending on the dielectric properties of the object. This allows for different types of objects to be identified (e.g., touch screen pen, finger, another communication device proximal to touch screen for setting up an STS connection, etc.).

The memory 64 and/or 66 store an operating system 278, a screen-to-screen (STS) communication application 280, one or more STS source user applications 282 and one or more payment applications 284. The STS communication application 280 functions to allow STS communications from one communication device to another. For example, the STS communication application 280 works with an STS communication application on the other device to establish an STS communication protocol for the STS wireless connection. As a further example, the STS communication application stores and/or has access to verify personal data (e.g., biometric data, password, etc.) of an authorized user of the device before enabling the STS communication.

The source user applications 282 include, but are not limited to, a video playback application, a spreadsheet application, a word processing application, a computer aided drawing application, a photo display application, an image processing application, a database application, and a plurality of interactive user applications, etc. While executing a source user application 282, the processing module generates data for display (e.g., video data, image data, text data, etc.). The payment applications 284 includes, but are not limited to, a bank application, a peer-to-peer payment application, a credit card payment application, a debit card payment application, a gift card payment application, etc. Note the STS communication applications 280 and source user applications 282 are OS agnostic (e.g., are operable to function on a variety of operating systems (e.g., Mac OS, Window OS, Linux OS, etc.)).

In an example of operation of an STS communication, the touch screen processing module 82 sends display data to the video graphics processing module 48, which converts the data into frames of video 87. The video graphics processing module 48 sends the frames of video 87 (e.g., frames of a video file, refresh rate for a word processing document, a series of images, etc.) to the display interface 93. The display interface 93 provides the frames of video to the display 274, which renders the frames of video into visible images.

While the display 274 is rendering the frames of video into visible images, the drive-sense modules (DSM) provide outbound signals of the STS communication to the sensors of the touch screen sensor array 272 and receive inbound signals of the STS communication from the sensors. When the screen is proximal to another screen or receiving signals via body as a network (BaaN), capacitance of the sensors is changed by the signals from the other screen. The DSMs detect the capacitance change for affected sensors and provide the detected change to the touch screen processing module 82.

The touch screen processing module 82 processes the capacitance change of the affected sensors to determine one or more specific elements (e.g., bit, byte, data word, symbol, etc.) of the STS communication and provides this information to the touch screen processing module 82. The touch screen processing module 82 processes the one or more specific elements to determine a portion of the STS communication. For example, the specific element indicates one or more of a purchase, a quantity, an edit, an identity of an item, a purchase price, a digital signature, a security code, and an acknowledgement.

In another embodiment, the display 274, the display interface 93 and the video graphics processing module 48 may be omitted when the touch screen sensor array 272 serves a touch sense function only without an integrated display.

FIG. 41 is a schematic block diagram of an embodiment of a drive-sense module (DSM) 286 coupled to an electrode 288. The DSM 286 includes a signal source circuit 296 and a drive-sense circuit (DSC) 302. The signal source 296 includes an alternate current (AC) signal generator, an existing element of computing device 12, display data that is emanated from a display, and/or another signal source.

The DSC 302 operates similarly to the DSCs of FIGS. 34-37 and includes an analog front end 290, an analog to digital converter (ADC) & digital to analog converter (DAC) 292, and a digital processing circuit 294. The analog front end includes one or more amplifiers, filters, mixers, oscillators, converters, voltage sources, current sources, etc. For example, the analog front end 290 includes a current source, an ADC, a DAC and a comparator.

The analog to digital converter (ADC) 292 may be implemented in a variety of ways. For example, the (ADC) 292 is one of: a flash ADC, a successive approximation ADC, a ramp-compare ADC, a Wilkinson ADC, an integrating ADC, a delta encoded ADC, and/or a sigma-delta ADC. The digital to analog converter (DAC) 292 be implemented in a variety of ways. For example, the DAC 292 is one of: a sigma-delta DAC, a pulse width modulator DAC, a binary weighted DAC, a successive approximation DAC, and/or a thermometer-coded DAC. The digital processing circuit 294 includes one or more of digital filtering (e.g., decimation and/or bandpass filtering), format shifting, buffering, etc. Note in an embodiment, the digital processing circuit includes the ADC DAC 292.

In an example of operation, the DSM produces a digital inbound signal 298 that is representative of changes to an electrical characteristic (e.g., an impedance, a current, a reactance, a voltage, a frequency response, etc.) of the electrode 288 due to an STS communication. In particular, the analog front end 290 receives an analog reference signal 304 from the signal source 296 and utilizes it to determine the change in the electrical characteristic of the electrode. The analog front end 290 outputs a representation of the change to the ADC DAC 292, which converts it into a digital signal. The digital processing 294 processes the digital signal to produce digital inbound signal 298, which represents an element of the STS communication. For example, the digital processing 294 includes one or more digital filtering techniques (e.g., bandpass filters, decimation, etc.) format shifting, buffering, etc. The digital processing 294 may also include a processing module for interpreting digital information.

To transmit an element of the STS communication, the digital processing 294 converts the digital outbound signal 300 (e.g., representation of the element) into an analog outbound signal 300-1. The signal source 296 generates an analog reference signal 304 based on the analog outbound signal 300-1. For example, the analog outbound signal 300-1 indicates whether an analog reference signal is to be generated, and if so, at what frequency. As another example, the signal source 296 modulates a carrier signal with the analog outbound signal 300-1 to produce the analog reference signal 304. The analog front end 290 processes the analog reference signal 304 to drive an analog signal representing the element onto electrode 288. Further examples of the operation of the drive-sense circuit (DSC) 302 are discussed with reference to one or more of the previous Figures and in patent pending application Ser. No. 16/113,379, entitled Drive-sense Circuit With Drive-Sense Line, filed Aug. 27, 2018.

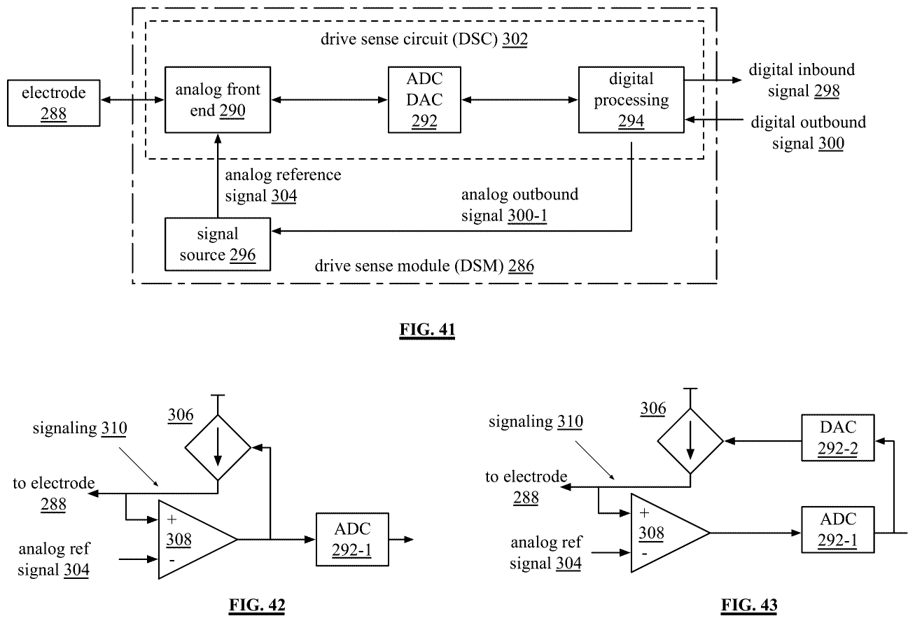

FIG. 42 is a schematic block diagram of an embodiment of a portion (e.g., the analog front end 290 and an ADC 292-1) of the drive-sense circuit 302 of FIG. 41. In this embodiment, the analog front end includes a current source 306 and a comparator 308 (e.g., an operational amplifier (op-amp)).

In the example of receiving an element (e.g., bit, byte, data word, symbol, etc.) of an STS communication, the comparator 308 produces an analog compensation signal/analog feedback signal based on comparing an analog reference signal 304 to signaling 310, which is indicative of an electrical characteristic (e.g., impedance (Z)) change to electrode 288. The ADC 292-1 converts the analog compensation signal to produce a digital inbound signal that represents the element of the STS communication. The dependent current source 306 modifies a current (I) on the output line (e.g., connected to electrode 288) based on the analog feedback signal so that a voltage (V) on the electrode remains substantially constant. For example, when an impedance (Z) decreases on electrode 288, according to the formula V=I*Z, the current is increased such that the voltage on the electrode remains substantially constant.

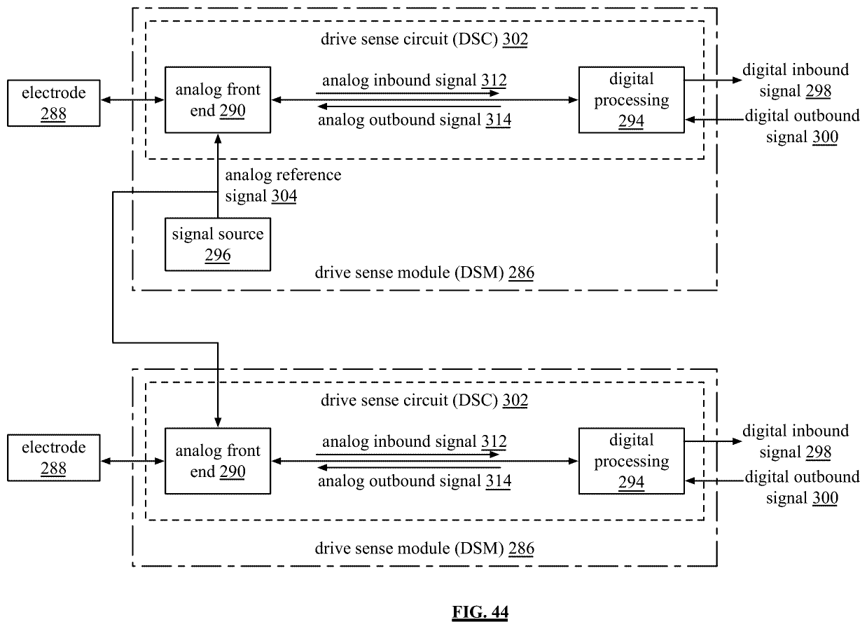

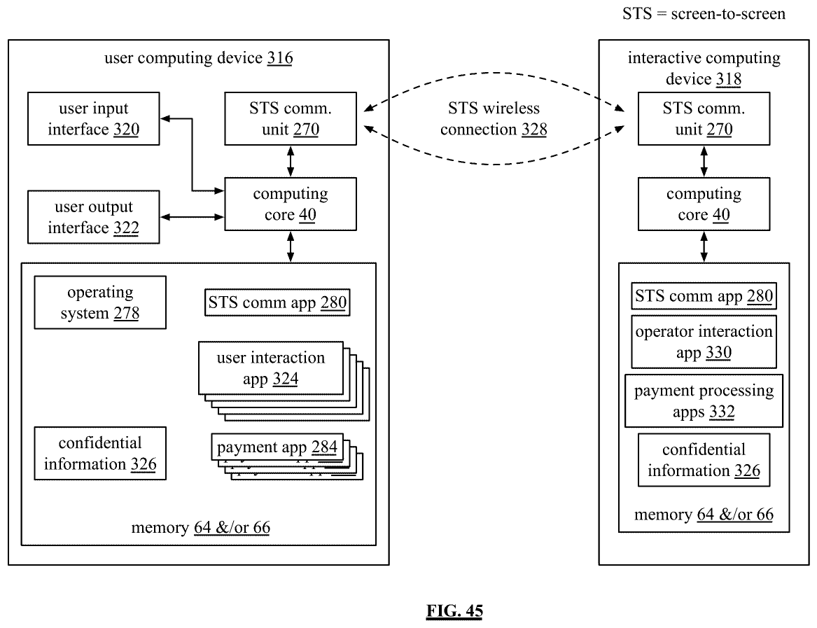

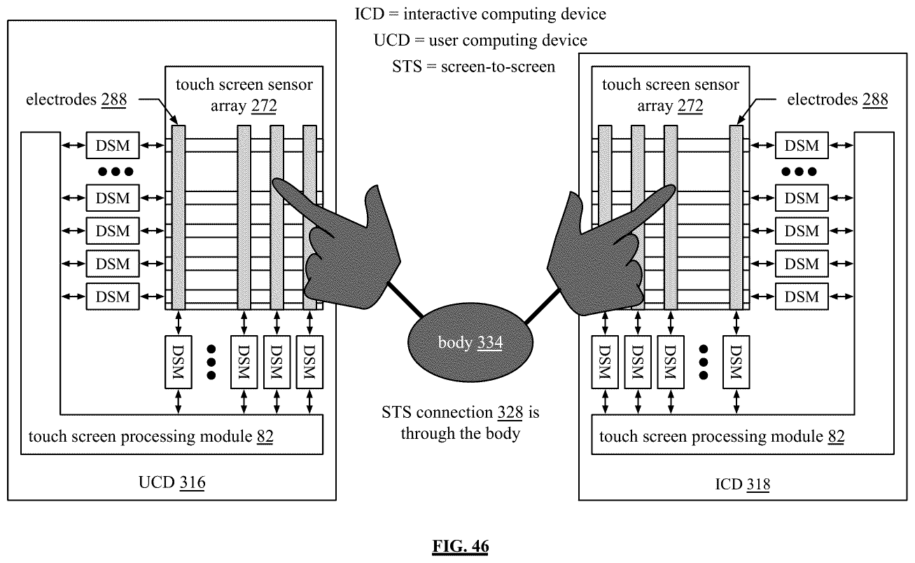

FIG. 43 is a schematic block diagram of another embodiment of a portion the drive-sense circuit 302 that includes an ADC 292-1, a DAC 292-2, a current source 306, and a comparator 308. This example is similar to FIG. 42, except that the feedback loop to the current source 306 is through the ADC 292-1 and the DAC 292-2, instead of directly from the comparator 112.

FIG. 44 is a schematic block diagram of an embodiment of a plurality of drive-sense modules 286. The drive-sense modules 286 are configured similar to FIG. 41, except that the digital processing 294 includes an analog to digital converter and a digital to analog converter and one signal source 296 provides the analog reference signal 304 to more than one drive-sense module (DSM) 286. Further, analog outbound signal 314 is sent directly to analog front end 290. The analog front end 290 also provides analog inbound signal 312 to digital processing 294.

FIG. 45 is a schematic block diagram of an example of a user computing device (UCD) 316 communicating with an interactive computing device (ICD) 318 via a screen-to-screen (STS) wireless connection 328. The user computing device (UCD) 316 may be a communication device or be implemented by a combination of two or more communication devices. For example, the user computing device 316 is a cell phone and a fob (e.g., small security hardware device with built-in authentication (e.g., keyless entry device, remote car starter, garage door opener, etc.)). As another example, the user computing device 316 is a cell phone and a car. Alternatively, the user computing device 316 is an individual device such as a cell phone, a tablet, a personal touch screen device (e.g., fob), a car, etc. The user computing device 316 includes a computing core 40 connected to a user input interface 320, a user output interface 322, an STS communication unit 270, and a memory 64 and/or 66.

The memory 64 and/or 66 of the UCD 316 includes an operating system 278, an STS communication application 280, a set (e.g., one or more) of user interaction applications 324, a set of payment applications 284, and confidential information 326. The confidential information 326 includes, but is not limited to, a user's personal information, user computing device identification (ID), user's payment information, security information (e.g., passwords, biometric data, etc.) and user's personal preferences per user application (e.g., preference for coffee orders, fast food orders, transportation tickets, event tickets, etc.).

As some limited examples, the set of user interaction applications 324 includes a fast food drive ordering application, a transportation ticket purchase application, an event ticket purchase application, a banking application, a point of sale payment application, a rental car enable and checkout application, an airline application, a sales information application, an interactive screen information application, a data transfer application, a meeting data exchange application, a hotel check in application, and a cell phone is hotel room key application.

The STS communication application 280 functions as previously described to assist the UCD 316 in setting up the communication between devices. For example, the STS communication application 280 determines (e.g., selects a default, receives a command, etc.) one or more of a communication medium (e.g., close proximity, body as a network, surface, etc.), a communication method (e.g., cellular data, STS communication link, Bluetooth, etc.), a signaling and/or pattern protocol (e.g., amplitude shift keying (ASK) modulation, etc.), and security mechanisms (e.g., security codes, encryption, data transmission of particular data types restrictions, etc.) for which the devices utilize for the communication. The payment applications 284 include, but are not limited to, one or more of a bank application, a credit card application, peer-to-peer payment application, and a cryptocurrency exchange application.

The interactive computing device (ICD) 318 includes a screen to screen (STS) communication unit 270, a computing core 40, and a memory 64 and/or 66. The memory 64 and/or 66 of the ICD 318 includes an STS communication application 280, an operator interaction application 330, a set of payment processing applications 332, and confidential information 326.

The STS communication application 280 of the ICD 318 functions similarly as the STS communication application 280 of the UCD 316 to setup the STS communications from an operator of the ICD's perspective. As an example, in setting up communication between the devices, the STS communication application of the ICD is a leader (controls communication settings) and the STS communication application of the UCD is a follower (e.g., uses settings selected by the ICD STS communication app 280). In another example, the STS communication application 280 of both the UCD 316 and the ICD 318 need to agree on and/or have control over various settings. For example, the UCD 316 and ICD 318 agree to use a cellular data connection (e.g., 5G) to transmit transactional data. However, the UCD 316 will only transmit certain confidential information via an STS wireless connection 328 and the ICD will only accept connections with a minimum bit rate over a wireless local area network (WLAN) connection with the UCD. Thus, the ICD needs to agree to receive the certain confidential information via the STS wireless connection 328 and the UCD needs to agree to transmit at the minimum bit rate over the WLAN to successfully perform the setup.

The operator interaction application 330 includes an operator version of a fast food drive ordering application, a transportation ticket purchase application, an event ticket purchase application, a banking application, a point of sale payment application, a rental car enable and checkout application, an airline application, a sales information application, an interactive screen information application, a data transfer application, a meeting data exchange application, a hotel check in application, a cell phone is hotel room key application. The payment processing application 332 includes one or more of a bank operator application, a credit card operator application, peer-to-peer payment operator application, a cryptocurrency exchange operator application, and an automated clearing house application.

Once the STS communication settings are agreed upon, the UCD 316 and ICD 318 may utilize the STS wireless connection 328 to transmit data of a transaction. The STS wireless connection 328 includes one or more connection types. For example, a first connection type is a body as a network (BaaN) connection. As another example, a second connection type is a touch screen to touch screen close proximity connection. As yet another example, a third connection type is a connective surface between the touch screen to touch screen (e.g., in order to transmit an encoded vibration signal). In an example, the user computing device 316 and the interactive computing device 318 exchange confidential information (e.g., confidential information 326), or a portion thereof via the STS wireless connection 328.

By using the STS wireless connection, the UCD 316 and ICD 318 exchange data in a secure manner and also reduce the amount of steps a user of the UCD needs to manually complete to perform a transaction. For example, using a BaaN connection, the signal is difficult for any device other than then UCD and ICD to detect. Further, when transmitting payment information during touching a screen to confirm an order of items, a user does not have to perform one or more of the steps of locating a credit card, swiping the card, verifying the amount, signing a screen or physical receipt, and returning card to a safe location.

FIG. 46 is a schematic block diagram of an embodiment of a screen-to-screen (STS) connection 328 between a user computing device (UCD) 316 and an interactive computing device (ICD) 318 through a body 334 (e.g., human body for a body as a network (BaaN) STS connection). The UCD 316 and ICD 318 include a touch screen sensor array 272, drive-sense modules, and a touch screen processing module 82. The touch screen sensor array 272 includes rows of electrodes 288 (shown in white) and columns of electrodes 288 (shown in grey).

In an example of operation, a drive-sense module generates a signal having an oscillation component based on a command from the touch screen processing module 82. The drive-sense module drives the signal onto a touch sense element (e.g., one or more electrodes 288) of the touch screen sensor array 272. When a part of the body (e.g., finger, hand, arm, foot, etc.) touches the first touch sense element or is in close proximity (e.g., within a few millimeters to tens of millimeters), the signal on the touch sense element propagates through the body 334. The ICD 318 receives the signal through another part of the body 334 (e.g., another finger) via a second touch (or close proximity connection) on the touch screen sensor array 272 of the ICD 272.

As such, data is securely transmitted from one device to another. The transmit of data is also more efficient for a user (e.g., body 334) as the data can be transmitted more seamlessly than other communication types. For example, with STS communications enabled on both the UCD and the ICD, when a user of the UCD presses (e.g. touches) a payment button on the ICD, payment information may be security transmitted from the UCD to the ICD via the STS connection 328 during the pressing without other steps (e.g., inputting payment information, selecting a payment option, scanning a bar code, swiping a card, etc.).

In a specific embodiment, the touch screen processing module may adjust the current of a signal driven onto the touch sense element based on a composition of the body in the BaaN. For example, a user's body impedance lowers as total body water of the user (e.g., stored in the user's tissues) increases. Thus, as the user's impedance changes, the touch screen processing module may adjust the current accordingly. This allows the current usage to be minimized, which may save power. This further allows for the signal to be modified to achieve desired signal characteristics (e.g., signal to noise ratio, signal strength, etc.).

In another embodiment, the STS connection 328 is formed from a first touch sensor array 272 of the UCD 316 through a first body 334 and a second body 334 to a second touch screen sensor array 272 of the ICD 318, or vice versa. There are various ways a connection between the bodies can occur. For example, the connection occurs when user 1 and user 2 first bump, shake hands or otherwise have skin-to-skin contact that allows the signal (e.g., driven onto a touch sense element of the touch screen) to propagate. In a specific example, the STS connection 328 is formed between the UCD 316 and the ICD 318 when a body #1 is in contact with a body #2 for a certain time period (e.g., 20 milliseconds, 0.2 seconds, 3 seconds, etc.).

In another embodiment, a first STS connection 328 is formed between a first UCD 316 and the ICD 318 via a first body 334 and a second STS connection 328 is formed between the ICD 318 and a second UCD #316 via a second body 334. In that example, the first UCD and the second UCD can share data via the first and second STS connections 328 and the ICD 318.

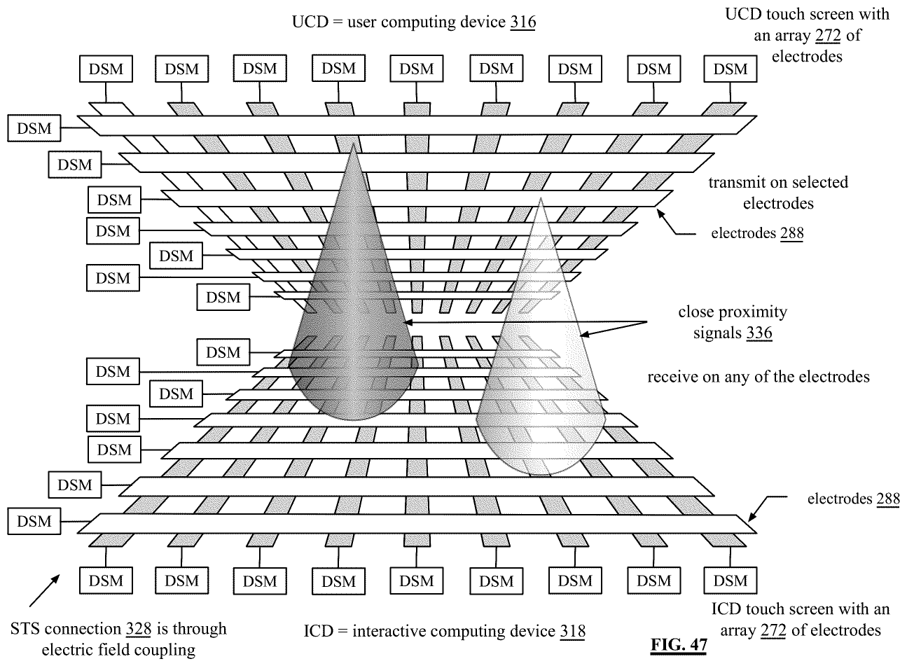

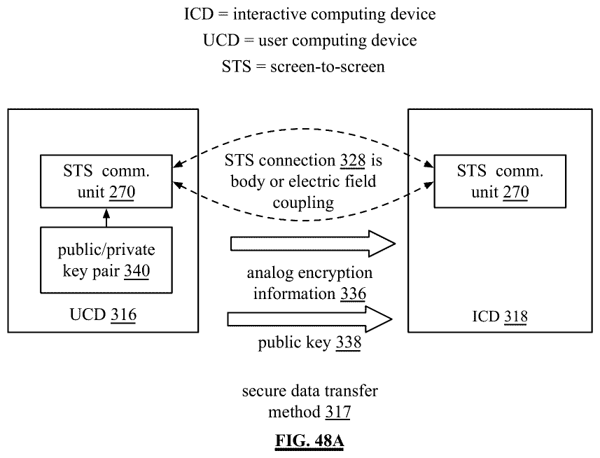

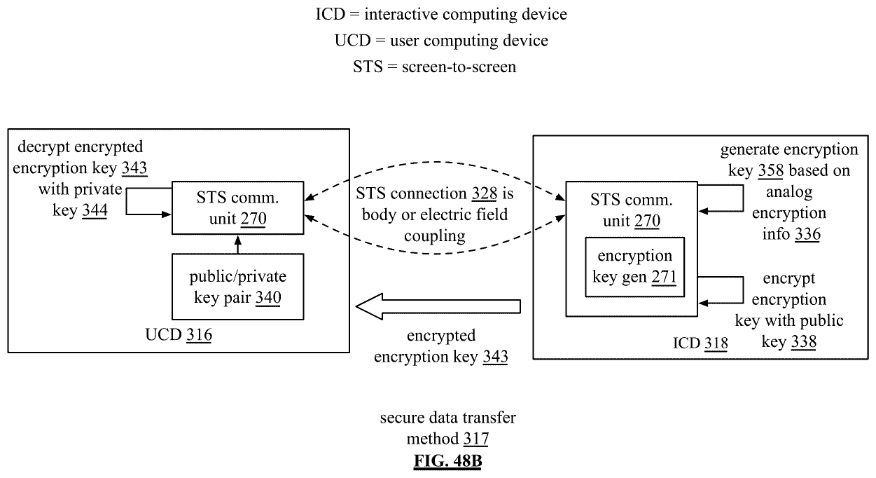

FIG. 47 is a schematic block diagram of an example of transmitting close proximity signals 336 from a user computing device 316 to an interactive computing device 318 to form a screen to screen (STS) connection 328 via electric field coupling. The user computing device 316 includes drive-sense modules (DSMs) and a touch screen array 272 of electrodes 288. The interactive computing device 318 includes drive-sense modules (DSMs) and a touch screen array 272 of electrodes 288.

In an example of operation, data is transmitted in close proximity signals 338 via one or more electrodes 288 of the user computing device (UCD) 316 touch screen with an array 272 of electrodes 288. The electrodes 288 are shaped and designed for capacitance sensing (e.g., not radio frequency (RF) transmission). In an example, the electrodes of the computing device generate and shape an electric field. At close proximity (e.g., a few centimeters (cm) to 10's of cm (e.g., 70 cm), electrodes in another computing device will detect the electric field. In this example, the signaling is very low power and the radiated energy from the signal drops off very rapidly (e.g., less than few feet before signal to noise ratio is too low).

In an example, the UCD 316 selects one or more of the electrodes 288 to transmit the close proximity signals 336. For example, the UCD 316 determines an optimal area (e.g., which contains one or more electrodes) of the touch screen sensor array 272 to transmit to produce the selected electrodes 288. As another example, the UCD 316 selects electrodes for receiving close proximity signals 336 to be transmitted from the ICD 318. Note the UCD 316 may select one or more different electrodes for receiving and transmitting the close proximity signals 336.

FIGS. 48A-48B are schematic block diagrams of an example of obtaining an encryption key via a screen-to-screen (STS) connection 328 using a secure data transfer method 317. In this example, FIGS. 48A-48B include a user computing device (UCD) 316 and an interactive computing device (ICD) 318, but in other embodiments, the STS connection 328 could be between two or more computing devices of any kind (e.g., between user computing devices, etc.). The UCD 316 and the ICD 318 each include an STS communication (comm) unit 270 that operates similarly to the STS communication units of previous Figures to establish an STS connection 328 between computing devices. The STS connection 328 may be through a body as discussed with reference to FIG. 46 or through electric field coupling as discussed with reference to FIG. 47 or through a connective surface.

To establish an encrypted, secure communication between the computing devices 316-318 that utilizes analog signal encryption (e.g., analog signal encrypted communication), one or more of the UCD 316 and ICD 318 will share an encryption key for analog signal encryption for a particular communication. A new encryption key may be sent for every new communication session, generated upon request or default setting, and/or saved for future communications between the devices. To send the encryption key via the STS connection 328, additional security is added through the use of a secure data transfer method 317. In the example of FIG. 48A-48B, the secure data transfer method 317 is a public/private key pair 340. However, other secure data transfer methods are possible to securely transfer data such as digital certificates, digital signatures, password/passcode (e.g., temporary or permanent), etc.

As shown in FIG. 48A, the UCD 316 stores a public/private key pair 340. However, in other examples, one or more of the UCD 316 and the ICD 318 include its own unique public/private key pair 340. To initiate the analog signal encrypted communication by receiving an encryption key, the UCD 316 sends analog encryption information 336 and the public key 338 of the public/private key pair 340 the to the ICD 318. In another embodiment, the ICD 318 sends analog encryption information 336 and the public key 338 of the public/private key pair 340 the to the UCD 316, where the ICD 318 stores a public/private key pair.

The public key 338 of the public/private key pair 340 uses asymmetric algorithms that convert messages into an unreadable format. A computing device with a public key can encrypt a message intended for a specific receiver and confirm a signature signed by the receiver's private key. The public key may utilize a public key infrastructure (PKI) to bind the public key to a respective entity (e.g., a person, organization, etc.) through a process of registration and issuance of certificated by a certificate authority (CA). The private key is a secret key that can decrypt the message that is encrypted with the public key and can be used to sign a message so that a recipient knows the message could only have come from you.

The analog encryption information 336 includes a request for an encryption key to use in the analog encrypted communication and an analog encryption method selection. The analog encryption method selection includes whether to preserve the analog signal's frequency (e.g., through the use of an analog encryption signal generator similar to the embodiments of FIGS. 24-37), or to not preserve the analog signal's frequency (e.g., through the use of an analog encryption signal generator similar to the embodiments of FIGS. 12-33), and/or other desired encryption key information (e.g., a key length, key interpretation information, etc.). The analog encryption method selection may be selected by one or more of the UCD 316 and ICD 318, be a default setting set by one or more of the UCD 316 and ICD 318, or may be predetermined based on the type and/or needs of the communication. For example, when the STS connection is electric field coupling, the analog encryption method may be predetermined to preserve the analog signal's frequency in order to preserve the frequency for capacitive sense measurement.

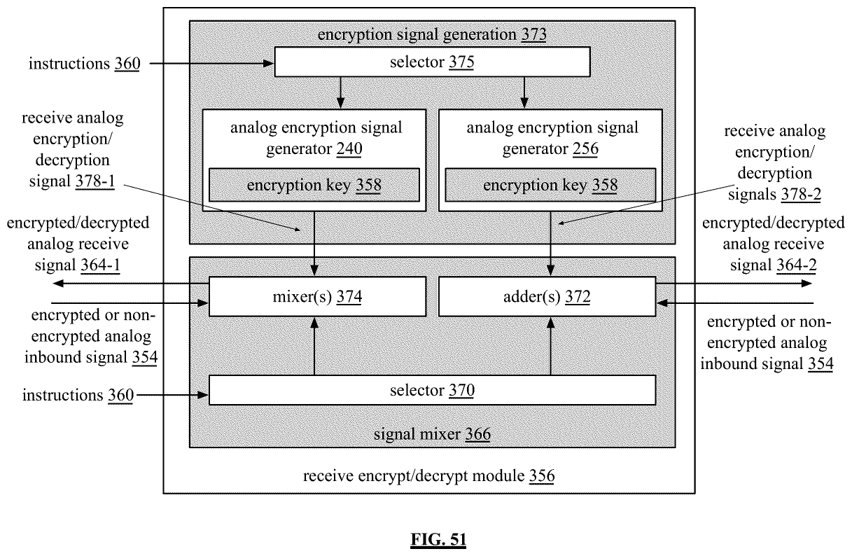

Based on the analog encryption method selection, the STS communication unit operable to set up a transmit and/or receive encrypt module of a drive sense module of an STS communication unit of a computing device for the analog encryption method that is selected. Setting up a transmit and/or receive encrypt module of a drive sense module of an STS communication unit of a computing device for the analog encryption method that is selected will be discussed in greater detail with reference to FIGS. 50-52.

In FIG. 48B, the ICD 318 generates the requested encryption key based on the analog encryption information. For example, the STS communication unit 270 includes an encryption key generator (gen) 271 (e.g., of a transmit encrypt module of the drive sense module) that generates the encryption key 358 based on the analog encryption information 336. The encryption key generator 271 may be a Random Bit Generator (RBG), a pseudorandom number generator, etc., that uses algorithms designed to ensure each encryption key 271 is unpredictable and unique. An encryption key is typically a random string of bits that are stored in a file, which, when processed through a cryptographic algorithm, can encode or decode cryptographic data. The analog encryption information may dictate the creation of the encryption key. For example, when frequency of the analog inbound or outbound data does not need to be preserved, the encryption key may include more bits to identify a series of frequencies in a frequency hopping pattern to be used in encryption signal generation (e.g., as in the example of FIGS. 27A-33).

The STS communication unit 270 of the ICD 318 (e.g., a processing module of the STS communication unit) encrypts the encryption key using the public key 338 to produce an encrypted encryption key 343. The UCD 316 obtains the encrypted encryption key 343 via the STS connection 328 and is operable to decrypt the encrypted encryption key 343 with the private key 344 of the public/private key pair 340 to produce the encryption key. For example, a processing module of the digital processing of the STS communication unit 270 or of another section of the UCD 316 decrypts the encrypted encryption key 343 with the private key 344.

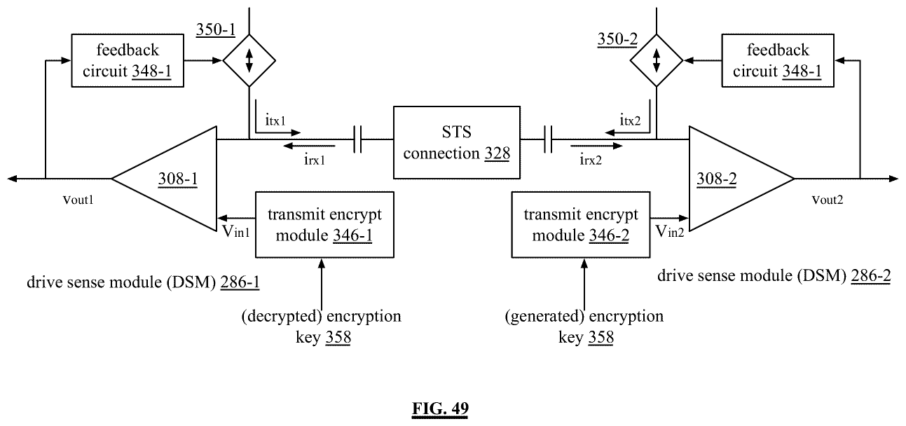

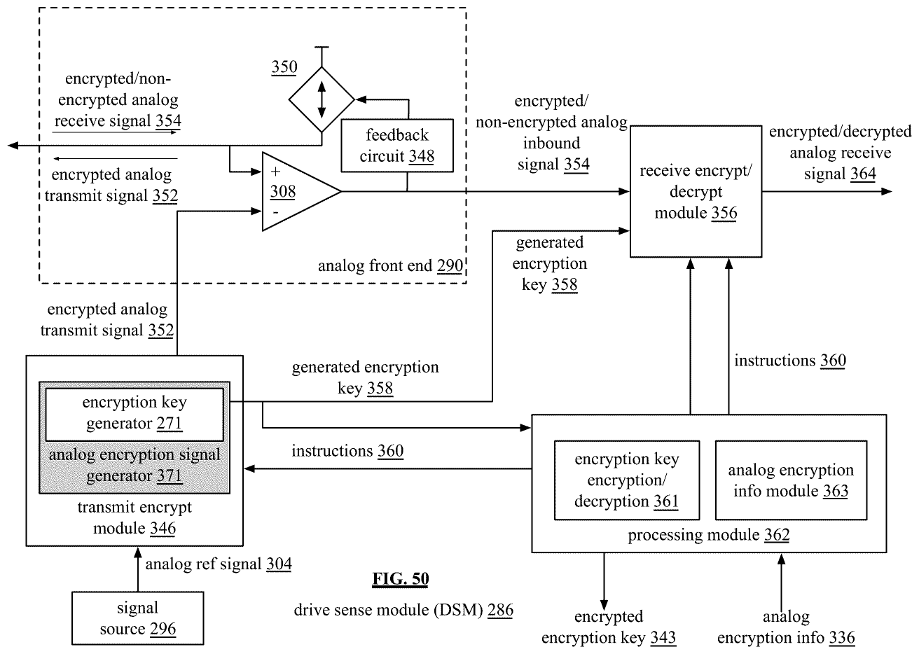

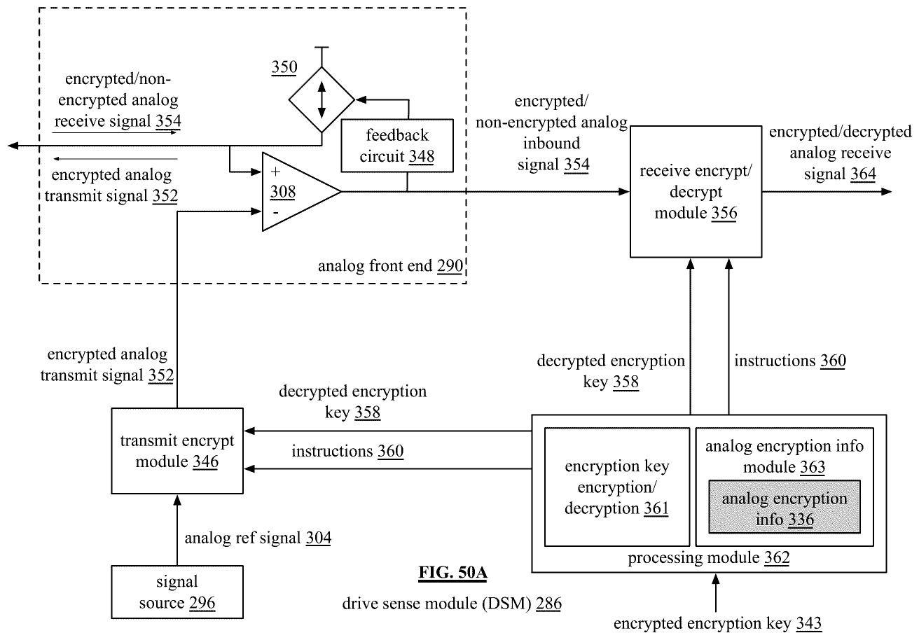

FIG. 49 is a schematic block diagram of an example of a portion of two drive sense modules (DSMs) 286-1 and 286-2 of two screen-to-screen (STS) communication units coupled via an STS connection 328. For example, the DSM 286-1 is of a user computing device such as a cell phone and the DSM 286-2 is of an interactive computing device such as an ATM or payment terminal. The STS connection 328 may be via a body as discussed with reference to FIG. 46 or via electric field coupling as discussed with reference to FIG. 47 or via a connective surface. The portions of the DSMs 286-1 and 286-2 include an operational amplifier (op-amp) 308-1 and 308-2, a feedback circuit 348-1 and 348-2, a power source circuit 350-1 and 350-2, and transmit analog encryption modules 346-1 and 346-2.

The transmit encrypt modules 346-1 and 346-2 operate similarly to the transmit encrypt modules of previous Figures except that the analog encryption method used by the transmit encrypt modules 346-1 and 346-2 is configurable and determined by analog encryption information. The transmit encrypt modules 346-1 and 346-2 will be discussed in more detail with reference to FIG. 52.

The transmit encrypt module 346-1 utilizes a decrypted encryption key 358 (e.g., decrypted using a private key) to encrypt analog outbound data Vin1. The transmit analog encryption module 346-2 utilizes a generated encryption key 358 (e.g., generated using the analog encryption information sent from the other computing device) to encrypt analog outbound data Vin2. The generated and decrypted encryption keys 358 are the same encryption key that has been designated for this particular STS communication.

The feedback circuit 348-1 and 348-2 may be a wire, a resistor, and/or a regulation circuit that creates a regulation signal to substantially remove any effects on the power signal, etc. The regulation of the power signal may be done by regulating the magnitude of the DC and/or AC components, by adjusting the frequency of AC component, and/or by adjusting the phase of the AC component. The remaining portion of the DSM 286-1 and 286-2 operates similarly to the DSM of FIGS. 41-43.

When receiving a power signal, the received signals received via the STS connection 328 (e.g., irx1 and irx2) affect the power signal to produce load signals. The load signal includes a component of the power signal (e.g., a transmit signal shown as currents itx1 and itx2) and a component of received current signals irx1 and irx2 (e.g., analog receive signals)). The op-amps 308-1 and 308-2 compare the load signals with analog outbound data signals (Vin1 and Vin2) that each include DC and AC components to produce analog inbound data (Vout1 and Vout2). The analog inbound data (e.g., vout1 and vout2) includes a representation of the received current (irx1 and irx2 respectively).

The transmit analog encryption modules 346-1 and 346-2 are operable to encrypt the outbound analog signals in accordance with encryption keys 358 and the analog encryption information. The encrypted analog outbound signals Vin1 and Vin2 each have oscillating component(s) and direct current (DC) component(s). In the frequency domain, the sinusoidal reference signal includes pure tone(s) at frequency component(s) of the oscillating component(s) with magnitudes corresponding to the DC component(s). For example, Vin1 includes an oscillating component at a frequency fe_1−f1 and Vin2 includes an oscillating component at a frequency fe_2−f2 (e.g., similar to the example of FIG. 15). As such, the DSM 286-1 transmits a signal at a frequency fe_1−f1 and receives a signal at a frequency fe_2−f2 and the DSM 286-2 transmits a signal at a frequency fe_2−f2 and receives a signal at a frequency fe_1−f1.

The feedback circuits 305-1 and 305-2 feed the analog inbound signals vout1 and vout2 to the power source circuits 350-1 and 350-2 (or regulates the analog inbound signals vout1 and vout2 to produce a regulation signal and feeds the regulation signals to the power source circuits). The power source circuits 350-1 and 350-2 are operable to adjust the power signal based on the signal (the analog inbound signals vout1 and vout2 and/or a regulation signal) to remove the effect of the signals received via the STS connection 328 (e.g., the received signals irx1 and irx2) on the power signal. In this example, the power source circuits 350-1 and 350-2 are bidirectional current supply circuits operable to sink the received current irx2 and irx1. In another embodiment, the power source circuits 350-1 and 350-2 are current supply circuits and capacitors are included to sink the received currents irx2 and irx1.

FIG. 50 is a schematic block diagram of an embodiment of a portion of a drive-sense module (DSM) 286 that includes an analog front end 290, a transmit encrypt module 346, a signal source 296, a receive encrypt/decrypt module 356, and a processing module 362. The processing module 362 may be a standalone processing module or a portion of another processing module of a screen-to-screen communication unit or other portion of a communication device. In another embodiment, one or more of the transmit encrypt module and the receive encrypt/decrypt module 356 include the processing module 362. In FIG. 50, the DSM 286 is of a device similar to the interactive computing device from the examples of FIGS. 48A-49 and continues the example of FIGS. 48A-49.

The analog front end 290 operates similarly to the analog front end of FIGS. 41-44 except that the analog to digital converter (ADC) and/or digital to analog converter (DAC) are not included, a feedback circuit 348 is shown (as discussed with reference to FIG. 49), and the power source circuit 350 is a bidirectional current source (as discussed with reference to FIG. 49). The signal source 296 operates similarly to the signal source 296 of previous Figures.

The processing module 362 includes an encryption key encryption/decryption module 361 and an analog encryption information (info) module 363. When the device is similar to the interactive computing device from the examples of FIGS. 48A-49, the analog encryption information module 363 of the processing module 362 is operable to interpret analog encryption information 336 pertaining to desired analog encrypted communication obtained from another computing device (e.g., a user computing device) to generate instructions 360.

The analog encryption information 336 includes a request for an encryption key to use in the analog encrypted communication and an analog encryption method selection. The analog encryption method selection includes whether to preserve the analog signal's frequency (e.g., through the use of an analog encryption signal generator similar to the embodiments of FIGS. 24-37), or to not preserve the analog signal's frequency (e.g., through the use of an analog encryption signal generator similar to the embodiments of FIGS. 12-33), and/or other desired encryption key information (e.g., a key length, key interpretation information, etc.).

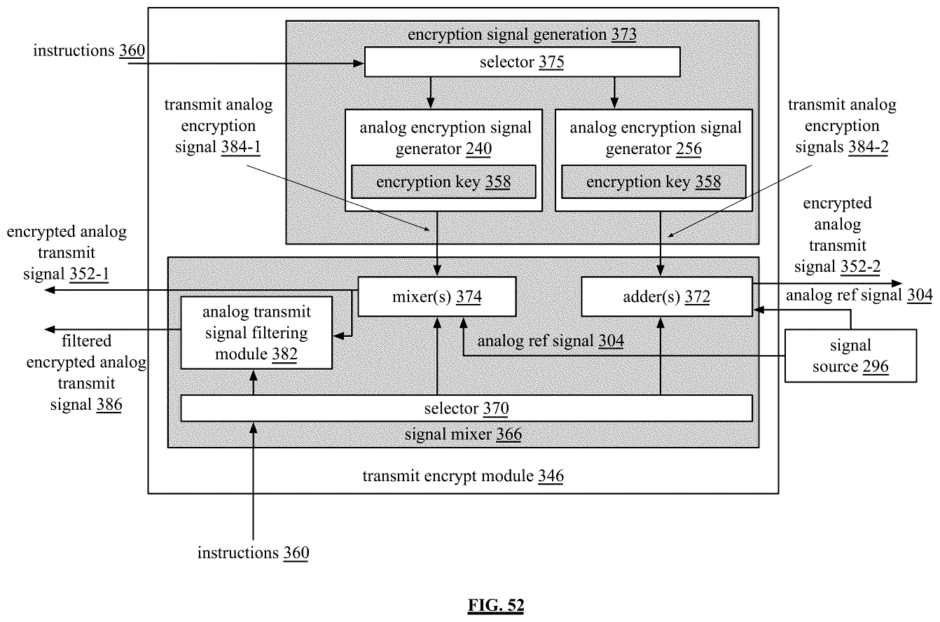

Based on the analog encryption method selection, the processing module 362 generates instructions 360 on how to generate the encryption key and how to set up a transmit and/or receive encrypt module of a drive sense module of an STS communication unit of a computing device for the analog encryption method that is selected. Setting up a transmit and/or receive encrypt module of a drive sense module of an STS communication unit of a computing device for the analog encryption method that is selected will be discussed in greater detail with reference to FIGS. 51-52.

Based on the request for an encryption key, the processing module 362 instructs the transmit encrypt module (e.g., an encryption key generator 271 of an analog encryption signal generator of the transmit encrypt module 271) to generate an encryption key (e.g., generated encryption key 358) in accordance with the analog encryption method selection. The encryption key generator 271 is operable to provide the generated encryption key 358 to the receive encrypt/decrypt module 356 and the processing module 362. In another embodiment, the encryption key generator 271 provides the generated encryption key 358 to the processing module 362 and the processing module 362 provides the generated encryption key 358 to the receive encrypt/decrypt module 356.

The encryption key encryption/decryption module 361 of the processing module 362 is operable to encrypt the generated encryption key 358 using a public key of a public/private key pair (where the public key was provided by the other device) to produce an encrypted encryption key 343 to be sent to the other computing device via an STS connection.

When set up by the processing module 362 in accordance with the analog encryption information 336, the transmit encryption module 346 is operable to encrypt the analog reference signal 304 to produce an encrypted analog transmit signal 352. The transmit analog encryption module 346 will be discussed in greater detail with reference to FIG. 52.

When set up by the processing module 362 in accordance with the analog encryption information 336 and the encryption key 358, and when provided analog inbound data (encrypted or unencrypted) from the other device, the receive encrypt/decrypt module 356 is operable to encrypt/decrypt the encrypted/non-encrypted analog inbound signal 354 to produce an encrypted or decrypted analog receive signal 364. The receive encrypt/decrypt module 356 will be discussed in greater detail with reference to FIG. 51.

When a communication device only receives encrypted data, the transmit analog encryption module 346 may be omitted and the encryption key is generated by the receive encrypt/decrypt module 356. When a communication device only transmits encrypted data, the receive encrypt/decrypt module 356 may be omitted.

FIG. 50A is a schematic block diagram of an embodiment of a portion of a drive-sense module (DSM) 286 that includes an analog front end 290, a transmit encrypt module 346, a signal source 296, a receive encrypt/decrypt module 356, and a processing module 362. The processing module 362 may be a standalone processing module or a portion of another processing module of a screen-to-screen communication unit or other portion of a communication device. In another embodiment, one or more of the transmit encrypt module and the receive encrypt/decrypt module 356 include the processing module 362. In FIG. 50A, the DSM 286 is of a device similar to the user computing device from the examples of FIGS. 48A-49 and continues the example of FIGS. 48A-49.

The analog front end 290 operates similarly to the analog front end of FIGS. 41-44 except that the analog to digital converter (ADC) and/or digital to analog converter (DAC) are not included, a feedback circuit 348 is shown (as discussed with reference to FIG. 49), and the power source circuit 350 is a bidirectional current source (as discussed with reference to FIG. 49). The signal source 296 operates similarly to the signal source 296 of previous Figures.

The processing module 362 includes an encryption key encryption/decryption module 361 and an analog encryption information (info) module 363. When the device is similar to the user computing device from the examples of FIGS. 48A-49, the analog encryption information module 363 of the processing module 362 is operable to generate analog encryption information 336 pertaining to a desired analog encrypted communication with another computing device (e.g., an interactive computing device) to use the analog encryption information 336 to generate instructions 360.

The analog encryption information 336 includes a request for an encryption key to use in the analog encrypted communication and an analog encryption method selection. The analog encryption method selection includes whether to preserve the analog signal's frequency (e.g., through the use of an analog encryption signal generator similar to the embodiments of FIGS. 24-37), or to not preserve the analog signal's frequency (e.g., through the use of an analog encryption signal generator similar to the embodiments of FIGS. 12-33), and/or other desired encryption key information (e.g., a key length, key interpretation information, etc.).

Based on the analog encryption method selection, the processing module 362 generates instructions 360 on how to set up a transmit and/or receive encrypt module of a drive sense module of an STS communication unit of a computing device for the analog encryption method that is selected. Setting up a transmit and/or receive encrypt module of a drive sense module of an STS communication unit of a computing device for the analog encryption method that is selected will be discussed in greater detail with reference to FIGS. 51-52.

Based on the request for an encryption key, the processing module 362 receives an encrypted encryption key 343 from the interactive computing device. The encryption key encryption/decryption module 361 of the processing module 362 is operable to decrypt the encrypted encryption key 343 using a private key of a public/private key pair (where the public/private key pair is stored by the user computing device) to produce a decrypted encryption key 358.

The processing module 362 sends the decrypted encryption key 358 and instructions 360 the transmit encrypt module 346 and the receive encrypt/decrypt module 356. When set up by the processing module 362 in accordance with the analog encryption information 336 and the encryption key 358, the transmit encryption module 346 is operable to encrypt the analog reference signal 304 to produce an encrypted analog transmit signal 352. The transmit analog encryption module 346 will be discussed in greater detail with reference to FIG. 52.

When set up by the processing module 362 in accordance with the analog encryption information 336 and the encryption key 358, and when provided analog inbound data (encrypted or unencrypted) from the other device, the receive encrypt/decrypt module 356 is operable to encrypt/decrypt the encrypted/non-encrypted analog inbound signal 354 to produce an encrypted or decrypted analog receive signal 364. The receive encrypt/decrypt module 356 will be discussed in greater detail with reference to FIG. 51.

When a communication device only receives encrypted data, the transmit analog encryption module 346 may be omitted. When a communication device only transmits encrypted data, the receive encrypt/decrypt module 356 may be omitted.

FIG. 51 is a schematic block diagram of an embodiment of a receive encrypt/decrypt module 356 of a drive sense module (DSM) that includes a signal mixer 366 and an encryption signal generator 373. The signal mixer 366 includes a selector 370 one or more adders 372 for adding or subtracting signals and one or more mixers 374 for multiplying signals. The selector 370 may be a multiplexor or other selection mechanism for selecting whether to add, subtract, or multiply signal(s).

The encryption signal generator 373 includes a selector 375, an analog encryption signal generator 240 (e.g., of FIGS. 18A-18D), and an analog encryption signal generator 256 (e.g., of FIGS. 27A-27B). The selector 375 may be a multiplexor or other selection mechanism for selecting whether to select the analog encryption signal generator 240 or the analog encryption signal generator 256. The analog encryption signal generator 240 and an analog encryption signal generator 256 each include the encryption key 358 (e.g., it generated the encryption key 358 or received it from another module).

Based on the instructions 360, the selector 375 selects either the analog encryption signal generator 240 or the analog encryption signal generator 256. The analog encryption signal generator 240 operates similarly to the analog encryption signal generators of FIGS. 18A-18D to produce an receive analog encryption/decryption signal 378-1 and is selected when preservation of the analog inbound data frequency is not required/desired. The analog encryption signal generator 256 operates similarly to the analog encryption signal generators of FIGS. 27A-27B to produce a plurality of receive analog encryption/decryption signals 378-2 and is selected when preservation of the analog inbound data frequency is required/desired.

Based on the instructions 360, the selector 370 selects to mix via the mixer(s) 374 encrypted or non-encrypted analog inbound data 354 with a receive analog encryption/decryption signal 378-1 to produce an encrypted/decrypted analog receive signal 364-1 when preservation of the analog inbound data frequency is not required/desired or selects to add via the adder(s) 373 the encrypted or non-encrypted analog inbound data 354 with the plurality of receive analog encryption/decryption signals 378-2 to produce an encrypted/decrypted analog receive signal 364-2.

FIG. 52 is a schematic block diagram of an embodiment of a transmit encrypt module 346 of a drive sense module (DSM) that includes a signal mixer 366 and an encryption signal generator 373. The signal mixer 366 includes a selector 370 one or more adders 372 for adding or subtracting signals, one or more mixers 374 for multiplying signals, and an analog transmit signal filtering module 382. The selector 370 may be a multiplexor or other selection mechanism for selecting whether to add, subtract, or multiply signal(s).

The encryption signal generator 373 includes a selector 375, an analog encryption signal generator 240 (e.g., of FIGS. 18A-18D), and an analog encryption signal generator 256 (e.g., of FIGS. 27A-27B). The selector 375 may be a multiplexor or other selection mechanism for selecting whether to select the analog encryption signal generator 240 or the analog encryption signal generator 256. The analog encryption signal generator 240 and an analog encryption signal generator 256 each include the encryption key 358 (e.g., it generated the encryption key 358 or received it from another module).

Based on the instructions 360, the selector 375 selects either the analog encryption signal generator 240 or the analog encryption signal generator 256. The analog encryption signal generator 240 operates similarly to the analog encryption signal generators of FIGS. 18A-18D to produce a transmit analog encryption signal 384-1 and is selected when preservation of the analog outbound data frequency is not required/desired. The analog encryption signal generator 256 operates similarly to the analog encryption signal generators of FIGS. 27A-27B to produce a plurality of transmit analog encryption signals 384-2 and is selected when preservation of the analog outbound data frequency is required/desired.

Based on the instructions 360, the selector 370 selects to mix via the mixer(s) 374 analog outbound data (e.g., reference signal 304) with a transmit analog encryption signal 384-1 to produce an encrypted analog transmit signal 352-1 when preservation of the analog inbound data frequency is not required/desired or selects to add via the adder(s) 373 the analog outbound data (e.g., reference signal 304) with a plurality of transmit analog encryption signals 384-2 to produce an encrypted analog transmit signal 352-2.

Based on the instructions 360, the selector 370 may alternatively select to mix via the mixer(s) 374 analog outbound data (e.g., reference signal 304) with the transmit analog encryption signal 384-1 to produce an encrypted analog transmit signal 352-1 then passes the encrypted analog transmit signal 352-1 to the analog transmit signal filtering module 382 to produce a filtered encrypted analog transmit signal 386. For example, the analog transmit signal filtering module 382 is a bandpass filter that filters out one or more frequency components from the encrypted analog transmit signal 352-1.

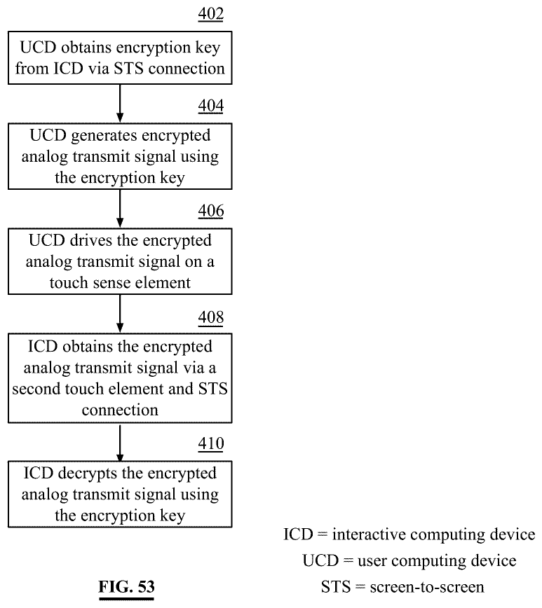

FIG. 53 is a logic flow diagram of an example of a method of driving and receiving analog encryption signals via a screen-to-screen (STS) connection. The method begins with step 402 where a first computing device (e.g., a user computing device (UCD)) obtains an encryption key from a second computing device (e.g., an interactive computing device (ICD)) via the STS connection using a secure data transfer method. The STS connection includes at least one of a human body and a close proximity between the first and second computing devices (e.g., electric field coupling).

The secure data transfer method includes one or more of a public/private key pair, digital certificates, passwords, passcodes, etc. In an example, to obtain the encryption key, the first computing device sends analog encryption information and a public key of a public/private key pair to the second computing device. The public key uses asymmetric algorithms that convert messages into an unreadable format. A computing device with a public key can encrypt a message intended for a specific receiver and confirm a signature signed by the receiver's private key. The public key may utilize a public key infrastructure (PKI) to bind the public key to a respective entity (e.g., a person, organization, etc.) through a process of registration and issuance of certificated by a certificate authority (CA). The private key is a secret key that can decrypt the message that is encrypted with the public key and can be used to sign a message so that a recipient knows the message could only have come from you.

The analog encryption information includes a request for an encryption key to use in the analog encrypted communication, an analog encryption method selection, and analog encryption method information. The analog encryption method selection includes whether to preserve the analog signal's frequency (e.g., through the use of an analog encryption signal generator similar to the embodiments of FIGS. 24-37), or to not preserve the analog signal's frequency (e.g., through the use of an analog encryption signal generator similar to the embodiments of FIGS. 12-33), and/or other desired encryption key information (e.g., a key length, key interpretation information, etc.). The analog encryption method selection may be selected by one or more of the first or second computing device, be a default setting set by one or more of the first or second computing device, or may be predetermined based on the type and/or needs of the communication. For example, when the STS connection is electric field coupling, the analog encryption method may be predetermined to preserve the analog signal's frequency in order to preserve the frequency for capacitive sense measurement.

The analog encryption method information includes information on how to set up a transmit and/or receive encrypt module of a drive sense module of an STS communication unit of a computing device for the analog encryption method that is selected. Setting up a transmit and/or receive encrypt module of a drive sense module of an STS communication unit of a computing device for the analog encryption method that is selected will be discussed in greater detail with reference to FIGS. 50-52.

The second computing device sends the requested encryption key encrypted using the public key. The first computing device obtains the encrypted encryption key via the STS connection and is operable to decrypt the encrypted encryption key using the private key of the public/private key pair to produce the encryption key. For example, a processing module of the digital processing of the STS communication unit or of another section of the first computing device decrypts the encrypted encryption key.

The method continues with step 404 where the first computing device generates an encrypted analog transmit signal from an analog reference signal and using the encryption key and in accordance with analog encryption instructions. For example, a transmit encrypt module of the first computing device receives the encryption key and instructions pertaining to analog encryption information. Depending on whether the frequency of the analog transmit signal needs to be preserved, the transmit encryp module generates one or more analog transmit encryption signals using the encryption key and mixes (adds or multiplies) the one or more analog transmit encryption signals with an analog reference signal to produce an encrypted analog transmit signal. The generation of the encrypted analog transmit signal is discussed in more detail with reference to FIGS. 49-52.

The method continues with step 406 where the first computing device drives the encrypted analog transmit signal on a first touch sense element (e.g., one or more electrodes) of the first computing device. The method continues with step 408 where the second computing device obtains the encrypted analog transmit signal on a second touch sense element (e.g., one or more electrodes) of the second computing device and via the STS connection.

The method continues with step 410 where the second computing device decrypts the encrypted analog transmit signal using the encryption key and in accordance with the analog encryption instructions to produce a decrypted analog receive signal. For example, a receive encrypt/decrypt module of the second computing device has the encryption key and instructions pertaining to analog encryption information. Depending on how the analog transmit signal was encrypted (e.g., whether the analog transmit signal frequency was preserved), the receive encrypt/decrypt module generates one or more analog receive encryption signals using the encryption key and mixes (subtract or multiplies) the one or more analog receive encryption signals with the analog inbound data (e.g., the encrypted analog transmit signal) to produce a decrypted analog receive signal. The decryption of an analog transmit signal is discussed in more detail with reference to FIGS. 49-52.

In another embodiment, one or more of the first and second computing devices receives an analog signal that is not encrypted but analog encryption (e.g., for storage) is desired. In that example, the receive encrypt/decrypt module of the first or second computing device has the encryption key and instructions pertaining to analog encryption information. Depending on how the analog receive signal should be encrypted (e.g., whether the analog receive signal frequency should be preserved), the receive analog encryption/decryption module generates one or more analog receive encryption signals using the encryption key and mixes (adds or multiplies) the one or more analog receive encryption signals with the analog inbound data (e.g., a non-encrypted analog transmit signal) to produce an encrypted analog receive signal. The encryption of an analog receive signal is discussed in more detail with reference to FIGS. 49-52.

It is noted that terminologies as may be used herein such as bit stream, stream, signal sequence, etc. (or their equivalents) have been used interchangeably to describe digital information whose content corresponds to any of a number of desired types (e.g., data, video, speech, text, graphics, audio, etc. any of which may generally be referred to as ‘data’).

As may be used herein, the terms “substantially” and “approximately” provides an industry-accepted tolerance for its corresponding term and/or relativity between items. For some industries, an industry-accepted tolerance is less than one percent and, for other industries, the industry-accepted tolerance is 10 percent or more. Other examples of industry-accepted tolerance range from less than one percent to fifty percent. Industry-accepted tolerances correspond to, but are not limited to, component values, integrated circuit process variations, temperature variations, rise and fall times, thermal noise, dimensions, signaling errors, dropped packets, temperatures, pressures, material compositions, and/or performance metrics. Within an industry, tolerance variances of accepted tolerances may be more or less than a percentage level (e.g., dimension tolerance of less than +/−1%). Some relativity between items may range from a difference of less than a percentage level to a few percent. Other relativity between items may range from a difference of a few percent to magnitude of differences.

As may also be used herein, the term(s) “configured to”, “operably coupled to”, “coupled to”, and/or “coupling” includes direct coupling between items and/or indirect coupling between items via an intervening item (e.g., an item includes, but is not limited to, a component, an element, a circuit, and/or a module) where, for an example of indirect coupling, the intervening item does not modify the information of a signal but may adjust its current level, voltage level, and/or power level. As may further be used herein, inferred coupling (i.e., where one element is coupled to another element by inference) includes direct and indirect coupling between two items in the same manner as “coupled to”.

As may even further be used herein, the term “configured to”, “operable to”, “coupled to”, or “operably coupled to” indicates that an item includes one or more of power connections, input(s), output(s), etc., to perform, when activated, one or more its corresponding functions and may further include inferred coupling to one or more other items. As may still further be used herein, the term “associated with”, includes direct and/or indirect coupling of separate items and/or one item being embedded within another item.

As may be used herein, the term “compares favorably”, indicates that a comparison between two or more items, signals, etc., indicates an advantageous relationship that would be evident to one skilled in the art in light of the present disclosure, and based, for example, on the nature of the signals/items that are being compared. As may be used herein, the term “compares unfavorably”, indicates that a comparison between two or more items, signals, etc., fails to provide such an advantageous relationship and/or that provides a disadvantageous relationship. Such an item/signal can correspond to one or more numeric values, one or more measurements, one or more counts and/or proportions, one or more types of data, and/or other information with attributes that can be compared to a threshold, to each other and/or to attributes of other information to determine whether a favorable or unfavorable comparison exists. Examples of such a advantageous relationship can include: one item/signal being greater than (or greater than or equal to) a threshold value, one item/signal being less than (or less than or equal to) a threshold value, one item/signal being greater than (or greater than or equal to) another item/signal, one item/signal being less than (or less than or equal to) another item/signal, one item/signal matching another item/signal, one item/signal substantially matching another item/signal within a predefined or industry accepted tolerance such as 1%, 5%, 10% or some other margin, etc. Furthermore, one skilled in the art will recognize that such a comparison between two items/signals can be performed in different ways. For example, when the advantageous relationship is that signal 1 has a greater magnitude than signal 2, a favorable comparison may be achieved when the magnitude of signal 1 is greater than that of signal 2 or when the magnitude of signal 2 is less than that of signal 1. Similarly, one skilled in the art will recognize that the comparison of the inverse or opposite of items/signals and/or other forms of mathematical or logical equivalence can likewise be used in an equivalent fashion. For example, the comparison to determine if a signal X>5 is equivalent to determining if −X<−5, and the comparison to determine if signal A matches signal B can likewise be performed by determining −A matches −B or not(A) matches not(B). As may be discussed herein, the determination that a particular relationship is present (either favorable or unfavorable) can be utilized to automatically trigger a particular action. Unless expressly stated to the contrary, the absence of that particular condition may be assumed to imply that the particular action will not automatically be triggered. In other examples, the determination that a particular relationship is present (either favorable or unfavorable) can be utilized as a basis or consideration to determine whether to perform one or more actions. Note that such a basis or consideration can be considered alone or in combination with one or more other bases or considerations to determine whether to perform the one or more actions. In one example where multiple bases or considerations are used to determine whether to perform one or more actions, the respective bases or considerations are given equal weight in such determination. In another example where multiple bases or considerations are used to determine whether to perform one or more actions, the respective bases or considerations are given unequal weight in such determination.

As may be used herein, one or more claims may include, in a specific form of this generic form, the phrase “at least one of a, b, and c” or of this generic form “at least one of a, b, or c”, with more or less elements than “a”, “b”, and “c”. In either phrasing, the phrases are to be interpreted identically. In particular, “at least one of a, b, and c” is equivalent to “at least one of a, b, or c” and shall mean a, b, and/or c. As an example, it means: “a” only, “b” only, “c” only, “a” and “b”, “a” and “c”, “b” and “c”, and/or “a”, “b”, and “c”.

As may also be used herein, the terms “processing module”, “processing circuit”, “processor”, “processing circuitry”, and/or “processing unit” may be a single processing device or a plurality of processing devices. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on hard coding of the circuitry and/or operational instructions. The processing module, module, processing circuit, processing circuitry, and/or processing unit may be, or further include, memory and/or an integrated memory element, which may be a single memory device, a plurality of memory devices, and/or embedded circuitry of another processing module, module, processing circuit, processing circuitry, and/or processing unit. Such a memory device may be a read-only memory, random access memory, volatile memory, non-volatile memory, static memory, dynamic memory, flash memory, cache memory, and/or any device that stores digital information. Note that if the processing module, module, processing circuit, processing circuitry, and/or processing unit includes more than one processing device, the processing devices may be centrally located (e.g., directly coupled together via a wired and/or wireless bus structure) or may be distributedly located (e.g., cloud computing via indirect coupling via a local area network and/or a wide area network). Further note that if the processing module, module, processing circuit, processing circuitry and/or processing unit implements one or more of its functions via a state machine, analog circuitry, digital circuitry, and/or logic circuitry, the memory and/or memory element storing the corresponding operational instructions may be embedded within, or external to, the circuitry comprising the state machine, analog circuitry, digital circuitry, and/or logic circuitry. Still further note that, the memory element may store, and the processing module, module, processing circuit, processing circuitry and/or processing unit executes, hard coded and/or operational instructions corresponding to at least some of the steps and/or functions illustrated in one or more of the Figures. Such a memory device or memory element can be included in an article of manufacture.

One or more embodiments have been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claims. Further, the boundaries of these functional building blocks have been arbitrarily defined for convenience of description. Alternate boundaries could be defined as long as the certain significant functions are appropriately performed. Similarly, flow diagram blocks may also have been arbitrarily defined herein to illustrate certain significant functionality.

To the extent used, the flow diagram block boundaries and sequence could have been defined otherwise and still perform the certain significant functionality. Such alternate definitions of both functional building blocks and flow diagram blocks and sequences are thus within the scope and spirit of the claims. One of average skill in the art will also recognize that the functional building blocks, and other illustrative blocks, modules and components herein, can be implemented as illustrated or by discrete components, application specific integrated circuits, processors executing appropriate software and the like or any combination thereof.

In addition, a flow diagram may include a “start” and/or “continue” indication. The “start” and “continue” indications reflect that the steps presented can optionally be incorporated in or otherwise used in conjunction with one or more other routines. In addition, a flow diagram may include an “end” and/or “continue” indication. The “end” and/or “continue” indications reflect that the steps presented can end as described and shown or optionally be incorporated in or otherwise used in conjunction with one or more other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

The one or more embodiments are used herein to illustrate one or more aspects, one or more features, one or more concepts, and/or one or more examples. A physical embodiment of an apparatus, an article of manufacture, a machine, and/or of a process may include one or more of the aspects, features, concepts, examples, etc. described with reference to one or more of the embodiments discussed herein. Further, from figure to figure, the embodiments may incorporate the same or similarly named functions, steps, modules, etc. that may use the same or different reference numbers and, as such, the functions, steps, modules, etc. may be the same or similar functions, steps, modules, etc. or different ones.

While the transistors in the above described figure(s) is/are shown as field effect transistors (FETs), as one of ordinary skill in the art will appreciate, the transistors may be implemented using any type of transistor structure including, but not limited to, bipolar, metal oxide semiconductor field effect transistors (MOSFET), N-well transistors, P-well transistors, enhancement mode, depletion mode, and zero voltage threshold (VT) transistors.

Unless specifically stated to the contra, signals to, from, and/or between elements in a figure of any of the figures presented herein may be analog or digital, continuous time or discrete time, and single-ended or differential. For instance, if a signal path is shown as a single-ended path, it also represents a differential signal path. Similarly, if a signal path is shown as a differential path, it also represents a single-ended signal path. While one or more particular architectures are described herein, other architectures can likewise be implemented that use one or more data buses not expressly shown, direct connectivity between elements, and/or indirect coupling between other elements as recognized by one of average skill in the art.

The term “module” is used in the description of one or more of the embodiments. A module implements one or more functions via a device such as a processor or other processing device or other hardware that may include or operate in association with a memory that stores operational instructions. A module may operate independently and/or in conjunction with software and/or firmware. As also used herein, a module may contain one or more sub-modules, each of which may be one or more modules.

As may further be used herein, a computer readable memory includes one or more memory elements. A memory element may be a separate memory device, multiple memory devices, or a set of memory locations within a memory device. Such a memory device may be a read-only memory, random access memory, volatile memory, non-volatile memory, static memory, dynamic memory, flash memory, cache memory, a quantum register or other quantum memory and/or any other device that stores data in a non-transitory manner. Furthermore, the memory device may be in a form of a solid-state memory, a hard drive memory or other disk storage, cloud memory, thumb drive, server memory, computing device memory, and/or other non-transitory medium for storing data. The storage of data includes temporary storage (i.e., data is lost when power is removed from the memory element) and/or persistent storage (i.e., data is retained when power is removed from the memory element). As used herein, a transitory medium shall mean one or more of: (a) a wired or wireless medium for the transportation of data as a signal from one computing device to another computing device for temporary storage or persistent storage; (b) a wired or wireless medium for the transportation of data as a signal within a computing device from one element of the computing device to another element of the computing device for temporary storage or persistent storage; (c) a wired or wireless medium for the transportation of data as a signal from one computing device to another computing device for processing the data by the other computing device; and (d) a wired or wireless medium for the transportation of data as a signal within a computing device from one element of the computing device to another element of the computing device for processing the data by the other element of the computing device. As may be used herein, a non-transitory computer readable memory is substantially equivalent to a computer readable memory. A non-transitory computer readable memory can also be referred to as a non-transitory computer readable storage medium.

One or more functions associated with the methods and/or processes described herein can be implemented in a system that is operable to electronically receive digital data via a wired or wireless communication network and/or to electronically transmit digital data via a wired or wireless communication network. Such receiving and transmitting cannot practically be performed by the human mind because the human mind is not equipped to electronically transmit or receive digital data, let alone to transmit and receive digital data via a wired or wireless communication network.

One or more functions associated with the methods and/or processes described herein can be implemented in a system that is operable to electronically store digital data in a memory device. Such storage cannot practically be performed by the human mind because the human mind is not equipped to electronically store digital data.

While particular combinations of various functions and features of the one or more embodiments have been expressly described herein, other combinations of these features and functions are likewise possible. The present disclosure is not limited by the particular examples disclosed herein and expressly incorporates these other combinations.

What is claimed is:

1. A method comprises:
generating, by a transmit digital to analog circuit of a low voltage drive circuit (LVDC), analog outbound data, wherein the analog outbound data includes a direct current (DC) component and an oscillating component at a first frequency;
generating, by an analog transmit encryption signal generator of a transmit encrypt module of the LVDC, an analog transmit encryption signal having at least one frequency component;
multiplying, by a mixer of the transmit encrypt module, the analog outbound data with the analog transmit encryption signal to produce encrypted analog outbound data having frequency components that differ from the first frequency;
comparing, by an operational amplifier (op-amp) of a drive-sense circuit of the LVDC, the encrypted analog outbound data with a bus signal to produce analog inbound data, wherein the drive-sense circuit is coupled to the transmit encrypt module and one or more lines of a bus, and wherein the bus signal includes an analog receive signal and an analog transmit signal;
providing, by the op-amp, the analog inbound data to a power source circuit of the drive-sense circuit; and
generating, by the power source circuit, the encrypted analog outbound data as the analog transmit signal of the bus signal based on the analog inbound data such that the bus signal remains substantially constant.

2. The method of claim 1, wherein the generating the analog transmit encryption signal comprises:
generating, by the analog transmit encryption signal generator, an encryption key;
encoding, by the analog transmit encryption signal generator, a portion of the encryption key using an encoding polynomial to produce a plurality of code words;
interpreting, by the analog transmit encryption signal generator, the plurality of code words to determine signal information, modulation information, and encryption key data;
generating, by the analog transmit encryption signal generator, an analog signal based on the signal information; and
modulating, by the analog transmit encryption signal generator, the encryption key data with the analog signal in accordance with the modulation information to produce the analog transmit encryption signal having the at least one frequency component.

3. The method of claim 2, wherein the generating the analog transmit encryption signal comprises:
scrambling, by the analog transmit encryption signal generator, the encryption key to produce a scrambled encryption key.

4. The method of claim 2, wherein the modulation information includes a modulation scheme type, wherein the modulation scheme type includes one or more of:
amplitude shift keying (ASK);
phase shift keying (PSK);
amplitude modulation (AM); and
quadrature amplitude modulation (QAM).

5. The method of claim 1 further comprises:
filtering, by a bandpass filter of the transmit encrypt module, the encrypted analog outbound data to produce filtered encrypted analog outbound data as the encrypted analog outbound data, wherein the filtered encrypted analog outbound data includes a frequency component of the at least one frequency components.

6. The method of claim 5, wherein the bandpass filter includes a bandpass range and a center frequency, wherein the center frequency corresponds to the frequency component.

7. The method of claim 1, wherein the providing the analog inbound data to the power source circuit of the drive-sense circuit comprises:
providing, by the op-amp, the analog inbound data to a feedback circuit of the drive-sense circuit;
generating, by the feedback circuit, a regulation signal based on the analog inbound data; and
providing, by the feedback circuit, the regulation signal to the power source circuit.

8. The method of claim 1, wherein the analog inbound data includes a representation of the analog receive signal.

9. The method of claim 1, wherein the bus signal includes an encrypted analog receive signal as the analog receive signal, wherein encrypted analog inbound data includes a representation of the encrypted analog receive signal, and wherein the LVDC includes a receive decrypt module operable to decrypt the encrypted analog inbound data.

10. A low voltage drive circuit (LVDC) comprises:
a transmit digital to analog circuit operable to generate analog outbound data, wherein the analog outbound data includes a direct current (DC) component and an oscillating component at a first frequency;
a transmit encrypt module coupled to the transmit digital to analog circuit, wherein the transmit encrypt module includes:
an analog transmit encryption signal generator operable to generate an analog transmit encryption signal having at least one frequency component; and
a mixer operable to multiply the analog outbound data with the analog transmit encryption signal to produce an encrypted transmit signal having frequency components that differ from the first frequency; and
a drive-sense circuit coupled to the transmit encrypt module and one or more lines of a bus, wherein the drive-sense circuit includes:
an operational amplifier (op-amp) operable to:
compare the encrypted analog outbound data with a bus signal to produce analog inbound data, wherein the bus signal includes an analog receive signal and an analog transmit signal; and
a power source circuit coupled to the output of the op-amp, wherein the power source circuit is operable to generate the encrypted analog outbound data as the analog transmit signal of the bus signal based on the analog inbound data such that the bus signal remains substantially constant.

11. The LVDC of claim 10, wherein the analog transmit encryption signal generator includes:
an encryption key generator operable to generate an encryption key;
a polynomial encoding module operable to encode a portion of the encryption key using an encoding polynomial to produce a plurality of code words;
a signal information module operable to interpret the plurality of code words to determine signal information;
an analog signal generator operable to generate an analog signal based on the signal information; and
a modulation module operable to:
interpret the plurality of code words to determine modulation information and encryption key data; and
modulate the encryption key data with the analog signal in accordance with the modulation information to produce the analog transmit encryption signal having the at least one frequency component.

12. The LVDC of claim 11, wherein the analog transmit encryption signal generator includes:
a scrambler operable to scramble the encryption key to produce a scrambled encryption key.

13. The LVDC of claim 11, wherein the modulation information includes a modulation scheme type, wherein the modulation scheme type includes one or more of:
amplitude shift keying (ASK);
phase shift keying (PSK);
amplitude modulation (AM); and
quadrature amplitude modulation (QAM).

14. The LVDC of claim 11 further comprises:
a bandpass filter operable to filter the encrypted analog outbound data to produce filtered encrypted analog outbound data as the encrypted analog outbound data, wherein the filtered encrypted analog outbound data includes a frequency component of the at least one frequency components.

15. The LVDC of claim 14, wherein the bandpass filter includes a bandpass range and a center frequency, wherein the center frequency corresponds to the frequency component.

16. The LVDC of claim 10, wherein the drive-sense circuit further includes:
a feedback circuit coupled to the output of the op-amp, wherein the feedback circuit is operable to:
generate a regulation signal based on the analog inbound data; and
provide the regulation signal to the power source circuit.

17. The LVDC of claim 10, wherein the analog inbound data includes a representation of the analog receive signal.

18. The LVDC of claim 10 further comprises:
a receive decrypt module coupled to the output of the drive-sense circuit, wherein the bus signal includes an encrypted analog receive signal as the analog receive signal, wherein the analog inbound data includes a representation of the encrypted analog receive signal, and wherein the receive decrypt module is operable to decrypt the analog inbound data to produce decrypted analog inbound data.

19. The LVDC of claim 10 further comprises:
a receive analog to digital circuit coupled to the output of the drive-sense circuit, wherein the receive analog to digital circuit is operable to convert the analog inbound data into digital inbound data.
